(19) United States
(12) Patent Application Publication
(10) Pub. No.: US 2021/0375569 A1
(43) Pub. Date: Dec. 2, 2021

(54) CONTACT DEVICE, ELECTROMAGNETIC RELAY, AND ELECTRICAL DEVICE

(71) Applicant: Panasonic Intellectual Property Management Co., Ltd., Osaka (JP)

(72) Inventors: Ryosuke OZAKI, Osaka (JP); Shinya KIMOTO, Osaka (JP); Kazuhiro KODAMA, Hokkaido (JP); Yasutaka HIEDA, Osaka (JP); Seiya SAKAGUCHI, Hokkaido (JP)

(73) Assignee: Panasonic Intellectual Property Management Co., Ltd., Osaka (JP)

(21) Appl. No.: 16/766,548

(22) PCT Filed: Nov. 21, 2018
(86) PCT No.: PCT/JP2018/043069

§ 371 Date: May 22, 2020

(30) Foreign Application Priority Data
Nov. 27, 2017 (JP) 2017-227284
Nov. 27, 2017 (JP) 2017-227285
Nov. 27, 2017 (JP) 2017-227286
Nov. 27, 2017 (JP) 2017-227287

(51) Int. Cl. H01H 50/60; H01H 1/54; H01H 50/44

(52) U.S. Cl. CPC H01H 50/60; H01H 1/54; H01H 2050/446; H01H 2001/545; H01H 50/443

(57) ABSTRACT

A bus bar of a contact device includes at least one electric path piece selected from a reverse and a forward electric path piece extending along a direction of current flowing through a moving contactor. The moving contactor is positioned between the reverse electric path piece and a fixed contact in moving directions of the moving contactor with the moving contactor positioned in the closed position. The reverse electric path piece allows current to flow therethrough in an opposite direction from current flowing through the moving contactor. The forward electric path piece is positioned on a same side as the fixed contact relative to the moving contactor in the moving directions of the moving contactor with the moving contactor positioned in the closed position. The forward electric path piece allows current to flow therethrough in a same direction as current flowing through the moving contactor.

### TECHNICAL FIELD

The present disclosure generally relates to a contact device, an electromagnetic relay, and an electrical device, and more particularly relates to a contact device, an electromagnetic relay, and an electrical device, which are configured to selectively bring a moving contact into contact, or out of contact, with a fixed contact.

### BACKGROUND ART

Patent Literature 1 discloses a contact device for selectively passing, or cutting off, an electric current through/at a contact.

Specifically, the contact device disclosed in Patent Literature 1 causes a moving contactor, included in the contact device, to be moved by electromagnetic force generated by energizing an excitation coil (excitation winding) of an electromagnet device, thereby bringing the moving contact of the moving contactor into contact with a fixed contact of a fixed terminal included in the contact device. This allows the moving contactor to be connected to the fixed terminal.

In the contact device described above, when an abnormal electric current such as a short-circuit current flows, for example, Lorenz force (i.e., electromagnetic repulsion) is applied to the moving contactor in such a direction as to bring the moving contact out of contact with the fixed contact, thus possibly decreasing the stability of connection between the moving contact and the fixed contact.

### CITATION LIST

### Patent Literature

Patent Literature 1: JP 2014-232668 A

### SUMMARY OF INVENTION

It is an object of the present invention to propose a contact device, an electromagnetic relay, and an electric device which are capable of stabilizing a connection state between a moving contact and a fixed contact in a case where an abnormal current flows.

A contact device according to one aspect of the present disclosure includes: at least one fixed terminal; a moving contactor; a case, and at least one bus bar. The at least one fixed terminal includes at least one fixed contact. The moving contactor includes at least one moving contact and is movable between a closed position where the at least one moving contact is in contact with the at least one fixed contact and an open position where the at least one moving contact is separate from the at least one fixed contact. The case accommodates at least the at least one fixed contact and the moving contactor. The at least one bus bar is electrically connected to the at least one fixed terminal. The at least one bus bar includes at least one electric path piece selected from a group consisting of at least one reverse electric path piece and at least one forward electric path piece which extend along a direction of a current flowing through the moving contactor. The at least one reverse electric path piece is placed outside the case to allow the moving contactor to be positioned between the at least one reverse electric path piece and the at least one fixed contact in moving directions of the moving contactor with the moving contactor positioned in the closed position. The at least one reverse electric path piece allows the current to flow therethrough in an opposite direction from the current flowing through the moving contactor. The at least one forward electric path piece is placed outside the case to be positioned on a same side as the at least one fixed contact relative to the moving contactor in the moving directions of the moving contactor with the moving contactor positioned in the closed position. The at least one forward electric path piece allows the current to flow therethrough in a same direction as the current flowing through the moving contactor.

An electromagnetic relay according to another aspect of the present disclosure includes: the contact device; and an electromagnet device configured to move the moving contactor. The electromagnet device includes an excitation coil, and a yoke for forming part of a path for a magnetic flux developed at the excitation coil. The at least one reverse electric path piece is positioned between the yoke and the moving contactor in the moving directions of the moving contactor while the moving contactor is in the closed position when the at least one fixed contact is placed in an opposite side from the yoke relative to the moving contactor. The at least one forward electric path piece is positioned between the yoke and the moving contactor in the moving directions of the moving contactor while the moving contactor is in the closed position when the at least one fixed contact is placed in a same side as the yoke relative to the moving contactor.

A contact device according to another aspect of the present disclosure includes: at least one fixed terminal; a moving contactor; and a case. The at least one fixed terminal includes at least one fixed contact. The moving contactor includes at least one moving contact and is movable between a closed position where the at least one moving contact is in contact with the at least one fixed contact and an open position where the at least one moving contact is separate from the at least one fixed contact. The case accommodates at least the at least one fixed contact and the moving contactor. A magnetic field caused by a current flowing through an electrically conductive member placed outside the case while the moving contactor is in the closed position, produces a force acting on the moving contactor and keeping the moving contactor in the closed position in the moving directions of the moving contactor. The electrically conductive member includes at least one of at least one reverse electric path piece and at least one forward electric path piece each of which extends along a direction of a current flowing through the moving contactor. The at least one reverse electric path piece is positioned in an opposite side from the at least one fixed contact relative to the moving contactor in the moving directions of the moving contactor while the moving contactor is in the closed position, to allow the current to flow therethrough in an opposite direction from the current flowing through the moving contactor. The at least one forward electric path piece is positioned in a same side as the at least one fixed contact relative to the moving contactor in the moving directions of the moving contactor while the moving contactor is in the closed position, to allow the current to flow therethrough in a same direction as the current flowing through the moving contactor.

An electromagnetic relay according to another aspect of the present disclosure includes: the contact device; and an electromagnet device configured to move the moving contactor.

An electric device according to another aspect of the present disclosure includes: an internal device constituted by the contact device, or the electromagnetic relay; and a housing holding the internal device.

### BRIEF DESCRIPTION OF DRAWINGS

FIG. 1A is a perspective view of an electromagnetic relay according to a first embodiment;

FIG. 1B is a cross-sectional view of the electromagnetic relay taken along the plane X1-X1;

FIG. 2 is a cross-sectional view of the electromagnetic relay taken along the plane X2-X2;

FIG. 3 illustrates the flow of an electric current in a contact device included in the electromagnetic relay;

FIG. 4A illustrates a positional relationship between bus bars of the contact device and a moving contactor and repulsive forces developed between the bus bars and the moving contactor;

FIG. 4B illustrates how a first yoke and a second yoke of the contact device attract each other;

FIG. 5 illustrates a relative position of the first yoke with respect to the moving contactor;

FIG. 6 illustrates how to stretch the arc generated in the contact device;

FIGS. 7A, 7B illustrate lengths of electric path pieces constituting the bus bars;

FIG. 8 illustrates a Lorentz force produced based on a relation between a magnetic flux caused by a current flowing through a fixed terminal included in the contact device and a current flowing through the moving contactor, and a Lorentz force produced based on a relation between a magnetic flux caused by a current flowing through the electric path piece facing the fixed terminal and the current flowing through the moving contactor;

FIG. 9A is a perspective view of an electrical device according to the first embodiment;

FIG. 9B is an exploded perspective view of the electrical device;

FIG. 10 is a perspective view of primary part of the electrical device;

FIG. 11 is an exploded perspective view of primary part of an electrical device according to a second variation of the first embodiment;

FIG. 12 is a perspective view of primary part of the electrical device;

FIG. 13 illustrates shapes of bus bars according to the second variation of the first embodiment;

FIG. 14 illustrates shapes of bus bars according to a third variation of the first embodiment;

FIG. 15 illustrates shapes of bus bars according to a fourth variation of the first embodiment;

FIGS. 16A, 16B illustrate a first yoke according to a fifth variation of the first embodiment;

FIG. 17 illustrates a contact device according to a sixth variation of the first embodiment;

FIG. 18A is a perspective view of an electromagnetic relay according to a second embodiment;

FIGS. 18B, 18C illustrate bus bars of a contact device included in the electromagnetic relay;

FIG. 19 illustrates a positional relationship between bus bars and a moving contactor included in the contact device and attractive forces developed between the bus bars and the moving contactor;

FIG. 20 illustrates shapes of bus bars according to a variation of the second embodiment;

FIG. 21 is a cross-sectional view of an electromagnetic relay according to a third embodiment;

FIG. 22 relates a contact device included in the electromagnetic relay and illustrates an upward force acting on a moving contactor;

FIG. 23A is a plan view of an electromagnetic relay according to a fourth embodiment;

FIG. 23B is a cross-sectional view of the electromagnetic relay taken along the plane X3-X3;

FIG. 24A is a perspective view of an electromagnetic relay according to a first variation of the fourth embodiment;

FIG. 24B is a cross-sectional view of the electromagnetic relay taken along the plane X4-X4;

FIG. 25 is a perspective view of an electromagnetic relay according to a second variation of the fourth embodiment;

FIG. 26A is a perspective view of an electromagnetic relay according to a fifth embodiment;

FIGS. 26B, 26C illustrate bus bars of the electromagnetic relay;

FIG. 27A is a perspective view of an electromagnetic relay according to a sixth embodiment;

FIGS. 27B, 27C illustrate bus bars of the electromagnetic relay;

FIG. 28A is a perspective view of an electromagnetic relay according to a seventh embodiment;

FIGS. 28B, 28C illustrate bus bars of the electromagnetic relay; and

FIG. 29 illustrates a variation of the electromagnetic relay.

### DESCRIPTION OF EMBODIMENTS

Note that embodiments and their variations to be described below are only examples of the present disclosure and should not be construed as limiting. Rather, those embodiments and variations may be readily modified in various manners depending on a design choice or any other factor without departing from a true spirit and scope of the present disclosure. It should also be noted that the drawings to be referred to in the following description of embodiments and their variations are all schematic representations. That is to say, the ratio of the dimensions (including thicknesses) of respective constituent elements illustrated on the drawings does not always reflect their actual dimensional ratio.

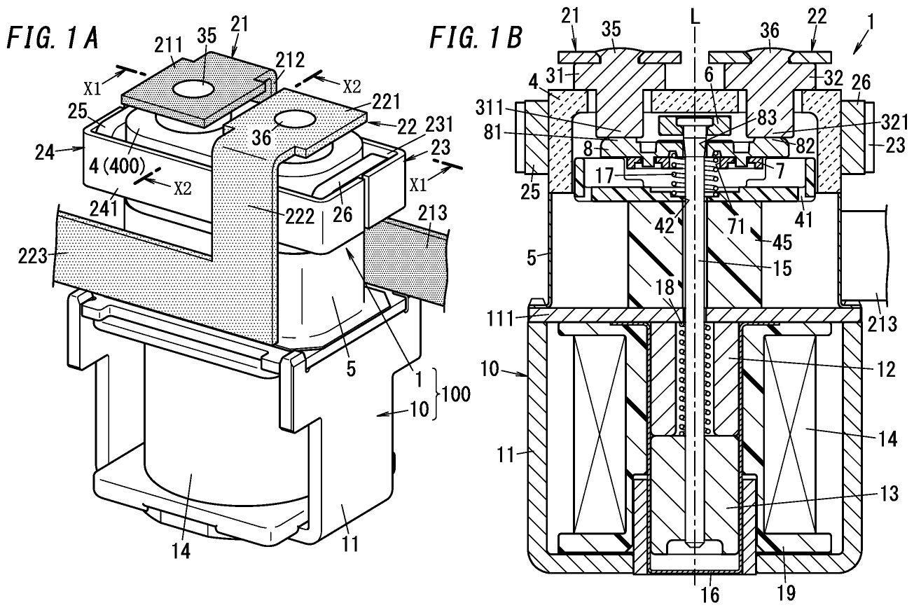

A contact device 1, an electromagnetic relay 100, an electric device M1, and an electric device case M10 according to the present embodiment will be described with reference to FIGS. 1A to 10.

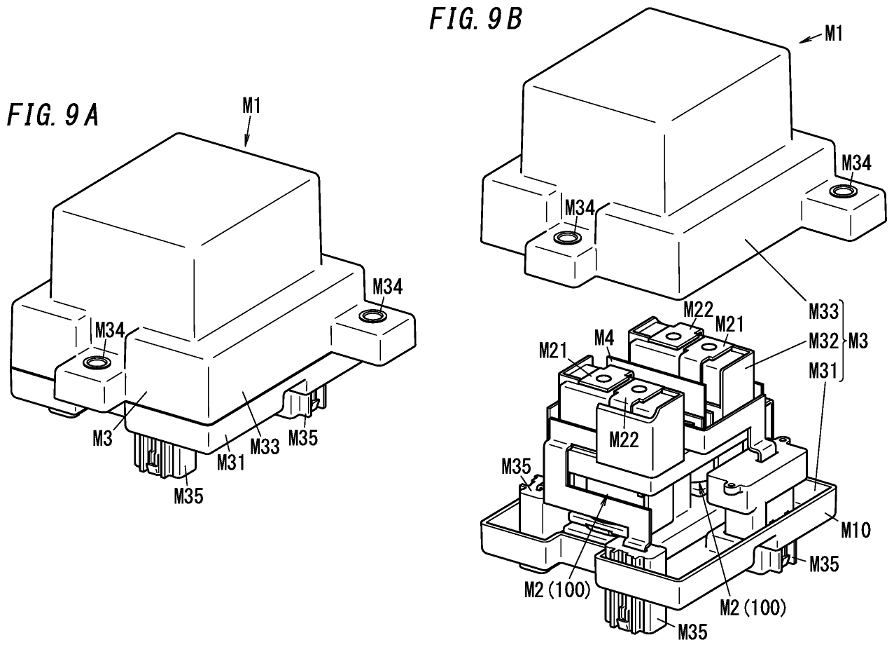

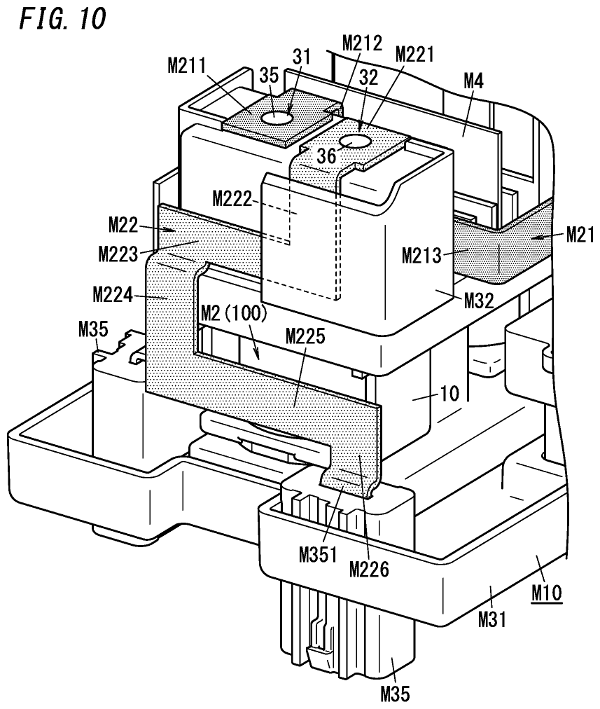

The electric device M1 according to the present embodiment, as shown in FIGS. 9A and 9B, includes: an internal device M2 constituted by the contact device 1 or the electromagnetic relay 100; and a housing M3 for holding the internal device M2. The present embodiment will be described based on an example where the internal device M2 is the electromagnetic relay 100.

The electric device M1 further includes electrically conductive bars M21, M22. The electrically conductive bars M21, M22 are held by the housing M3. The electrically conductive bars M21, M22 correspond to electrically conductive members. The “electrically conductive member” referred to in the present disclosure means a member which is placed outside a case 4 (see FIG. 1A) in the contact device 1 and is used for making an electromagnetic force act on a moving contactor 8 (see FIG. 1B). Although described in detail later, a current flowing through the electrically conductive member causes a force (electromagnetic force) acting on the moving contactor 8 of the contact device 1 to keep the moving contactor 8 in its closed position.

The housing M3, together with the electrically conductive bars M21 and M22, constitutes the electric device case M10. In other words, the electric device case M10 includes the housing M3; and the electrically conductive bars M21, M22 held by the housing M3.

Further, in the present embodiment, two internal devices M2 each constituted by the electromagnetic relay 100 is held by a single housing M3. In other words, the electric device M1 includes: the two internal devices M2 respectively constituted by the electromagnetic relays 100; and the housing for holding these two internal devices M2.

In the following, first of all, a basic configuration, operation, and advantages of the contact device 1 and the electromagnetic relay 100 used in the electric device M1 according to the present embodiment will be described with reference to FIGS. 1A to 8. Here, instead of the electrically conductive bars M21 and M22, bus bars 21 and 22 which are electrically connected to the contact device 1 will be described as specific examples of the electrically conductive members.

(1) Configuration

(1.1) Electromagnetic Relay

An electromagnetic relay 100 according to this embodiment includes a contact device 1 and an electromagnet device 10. The contact device 1 includes a pair of fixed terminals 31, 32 and a moving contactor 8 (see FIG. 1B). Each of the fixed terminals 31, 32 holds a fixed contact 311, 321 thereon. The moving contactor 8 holds a pair of moving contacts 81, 82 thereon.

The electromagnet device 10 includes a mover 13 and an excitation coil 14 (see FIG. 1B). The electromagnet device 10 is configured to have the mover 13 attracted by a magnetic field generated by the excitation coil 14 when the excitation coil 14 is energized. Attracting the mover 13 causes the moving contactor 8 to move from an open position to a closed position. As used herein, the “open position” refers to the position of the moving contactor 8 when the moving contacts 81, 82 go out of contact with the fixed contacts 311, 312, respectively. Also, as used herein, the “closed position” refers to the position of the moving contactor 8 when the moving contacts 81, 82 come into contact with the fixed contacts 311, 312, respectively.

Also, in this embodiment, the mover 13 is arranged along a line L and configured to reciprocate straight along the line L. The excitation coil 14 is configured as a conductive wire (electric wire) wound around the line L. That is to say, the line L corresponds to the center axis of the excitation coil 14.

In the embodiment to be described below, the contact device 1 is supposed to form, along with the electromagnet device 10, the electromagnetic relay 100 as shown in FIG. 1A. However, this is only an example and should not be construed as limiting. The contact device 1 does not have to be applied to the electromagnetic relay 100 but may also be used in a breaker (circuit breaker), a switch, or any other type of electrical equipment. Also, in the embodiment to be described below, the electromagnetic relay 100 is supposed to be used as a part of onboard equipment for an electric vehicle. In that case, the contact device 1 (fixed terminals 31, 32) is electrically connected on a path along which DC power is supplied from a traveling battery to a load (such as an inverter).

(1.2) Contact Device

Next, a configuration for the contact devices 1 will be described.

As shown in FIGS. 1A and 1B, each contact device 1 includes the pair of fixed terminals 31, 32, the moving contactor 8, a case 4, a flange 5, and two bus bars 21, 22. The contact device 1 further includes a first yoke 6, a second yoke 7, two capsule yokes 23, 24, two arc extinction magnets (permanent magnets) 25, 26, an insulation plate 41, and a spacer 45. The fixed terminal 31 holds the fixed contact 311 thereon, and the fixed terminal 32 holds the fixed contact 321 thereon. The moving contactor 8 is a plate member made of a metallic material with electrical conductivity. The moving contactor 8 holds a pair of moving contacts 81, 82, which are arranged to face the pair of fixed contacts 311, 321, respectively.

In the following description, the direction in which the fixed contacts 311, 321 and the moving contacts 81, 82 face each other is defined herein to be an upward/downward direction, and the fixed contacts 311, 321 are located on an upper side when viewed from the moving contacts 81, 82, just for the sake of convenience. In addition, the direction in which the pair of fixed terminals 31, 32 (i.e., the pair of fixed contact 311, 321) are arranged side by side is defined herein to be a rightward/leftward direction, and the fixed terminal 32 is supposed to be located on the right when viewed from the fixed terminal 31. That is to say, in the following description, the upward, downward, rightward, and leftward directions are supposed to be defined on the basis of the directions shown in FIG. 1B. Furthermore, in the following description, the direction perpendicular to both the upward/downward direction and the rightward/leftward direction (i.e., the direction coming out of the paper on which FIG. 1B is depicted) is defined herein to be a forward/backward direction. Note that these directions should not be construed as limiting a mode of using the contact device 1 or the electromagnetic relay 100.

One (first) fixed contact 311 is held at the bottom (one end) of one (first) fixed terminal 31, while the other (second) fixed contact 321 is held at the bottom (one end) of the other (second) fixed terminal 32.

The pair of fixed terminals 31, 32 are arranged side by side in the rightward/leftward direction (see FIG. 1B). Each of the pair of fixed terminals 31, 32 is made of an electrically conductive metallic material. The pair of fixed terminals 31, 32 serves as terminals for connecting an external circuit (including a battery and a load) to the pair of fixed contacts 311, 321. In this embodiment, the fixed terminals 31, 32 are supposed to be made of copper (Cu), for example. However, this is only an example and should not be construed as limiting. Alternatively, the fixed terminals 31, 32 may also be made of any electrically conductive material other than copper.

Each of the pair of fixed terminals 31, 32 is formed in the shape of a cylinder, of which a cross section, taken along a plane intersecting with the upward/downward direction at right angles, is circular. In this embodiment, each of the pair of fixed terminals 31, 32 is formed in a T-shape in a front view such that its diameter at the upper end (at the other end) is larger than its diameter at the lower end (at the one end). The pair of fixed terminals 31, 32 are each held by the case 4 such that part of the fixed terminal 31, 32 protrudes (at the other end) from the upper surface of the case 4. Specifically, each of the pair of fixed terminals 31, 32 is fixed onto the case 4 so as to run through an opening cut through the upper wall of the case 4.

The moving contactor 8 is formed in the shape of a plate having thickness in the upward/downward direction and having a greater dimension in the rightward/leftward direction than in the forward/backward direction. The moving contactor 8 is arranged under the pair of fixed terminals 31, 32 such that both longitudinal ends thereof (i.e., both ends thereof in the rightward/leftward direction) face the pair of fixed contacts 311, 321, respectively (see FIG. 1B). Portions, respectively facing the pair of fixed contacts 311, 321, of the moving contactor 8 are provided with the pair of moving contacts 81, 82, respectively (see FIG. 1B).

The moving contactor 8 is housed in the case 4. The moving contactor 8 is moved up and down (i.e., in the upward/downward direction) by the electromagnet device 10 arranged under the case 4, thus allowing the moving contactor 8 to move from the closed position to the open position, and vice versa. FIG. 1B illustrates a state where the moving contactor 8 is currently located at the closed position. In this state, the pair of moving contacts 81, 82 held by the moving contactor 8 are in contact with their associated fixed contacts 311, 321, respectively. On the other hand, in a state where the moving contactor 8 is currently located at the open position, the pair of moving contacts 81, 82 held by the moving contactor 8 are out of contact with their associated fixed contacts 311, 321, respectively.

Therefore, when the moving contactor 8 is currently located at the closed position, the pair of fixed terminals 31, 32 are short-circuited together via the moving contactor 8. That is to say, when the moving contactor 8 is currently located at the closed position, the moving contacts 81, 82 come into contact with the fixed contacts 311, 321, respectively, and therefore, the fixed terminal 31 is electrically connected to the fixed terminal 32 via the fixed contact 311, the moving contact 81, the moving contactor 8, the moving contact 82, and the fixed contact 321. Thus, if the fixed terminal 31 is electrically connected to one member selected from the group consisting of the battery and the load and the fixed terminal 32 is electrically connected to the other member, the contact device 1 forms a path along which DC power is supplied from the battery to the load while the moving contactor 8 is located at the closed position.

In this embodiment, the moving contacts 81, 82 only need to be held by the moving contactor 8. Therefore, the moving contacts 81, 82 may be formed by hammering out portions of the moving contactor 8, for example, so as to form integral parts of the moving contactor 8. Alternatively, the moving contacts 81, 82 may be members provided separately from the moving contactor 8 and may be secured, by welding, for example, onto the moving contactor 8. Likewise, the fixed contacts 311, 321 only need to be held by the fixed terminals 31, 32, respectively. Therefore, the fixed contacts 311, 321 may form integral parts of the fixed terminals 31, 32, respectively. Alternatively, the fixed contacts 311, 321 may be members provided separately from the fixed terminals 31, 32 and may be secured, by welding, for example, onto the fixed terminals 31, 32, respectively.

The moving contactor 8 has a through hole 83 at a middle portion thereof. In this embodiment, the through hole 83 is provided at a halfway point between the pair of moving contacts 81, 82 of the moving contactor 8. The through hole 83 runs through the moving contactor 8 along the thickness thereof (i.e., in the upward/downward direction). The through hole 83 is provided to pass a shaft 15 (to be described later) therethrough.

The first yoke 6 is configured as a ferromagnetic body and may be made of a metallic material such as iron. The first yoke 6 is secured to the tip (upper end) of the shaft 15. The shaft 15 runs through the moving contactor 8 through the through hole 83 thereof and the tip (upper end) of the shaft 15 protrudes upward from the upper surface of the moving contactor 8. Thus, the first yoke 6 is located over the moving contactor 8 (see FIG. 1B). Specifically, in the direction in which the moving contactor 8 moves, the first yoke 6 is located on the same side as the fixed contacts 311, 321 with respect to the moving contactor 8.

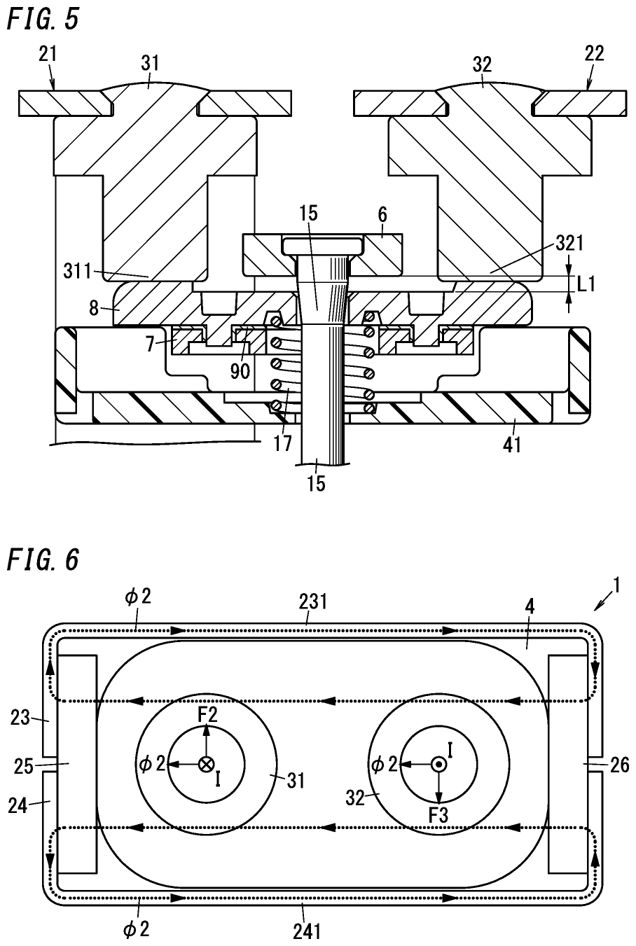

When the moving contactor 8 is currently located at the closed position, a predetermined gap L1 is left between the moving contactor 8 and the first yoke 6 (see FIG. 5). That is to say, when the moving contactor 8 is located at the closed position, the first yoke 6 is spaced from the moving contactor 8 by the gap L1 in the upward/downward direction. For example, if the moving contactor 8, the shaft 15, and the first yoke 6 are electrically insulated from each other at least partially, then electrical insulation is ensured between the moving contactor 8 and the first yoke 6.

The second yoke 7 is a ferromagnetic body and may be made of a metallic material such as iron. The second yoke 7 is fixed on the lower surface of the moving contactor 8 (see FIG. 1B). Thus, as the moving contactor 8 moves up and down (in the upward/downward direction), the second yoke 7 also moves up and down (in the upward/downward direction). Optionally, an insulating layer 90 with electrical insulation properties may be provided on the upper surface (particularly, a portion to come in contact with the moving contactor 8) of the second yoke 7 (see FIG. 5). This ensures electrical insulation between the moving contactor 8 and the second yoke 7. Note that in FIGS. 1B, 2, 23B, 24B, and other drawings, illustration of the insulating layer 90 is omitted as appropriate.

The second yoke 7 also has a through hole 71 at a middle portion thereof. In this embodiment, the through hole 71 is aligned with the through hole 83 of the moving contactor 8. The through hole 71 runs through the second yoke 7 along the thickness thereof (i.e., in the upward/downward direction). The through hole 71 is provided to pass the shaft 15 and a contact pressure spring 17 (to be described later) therethrough.

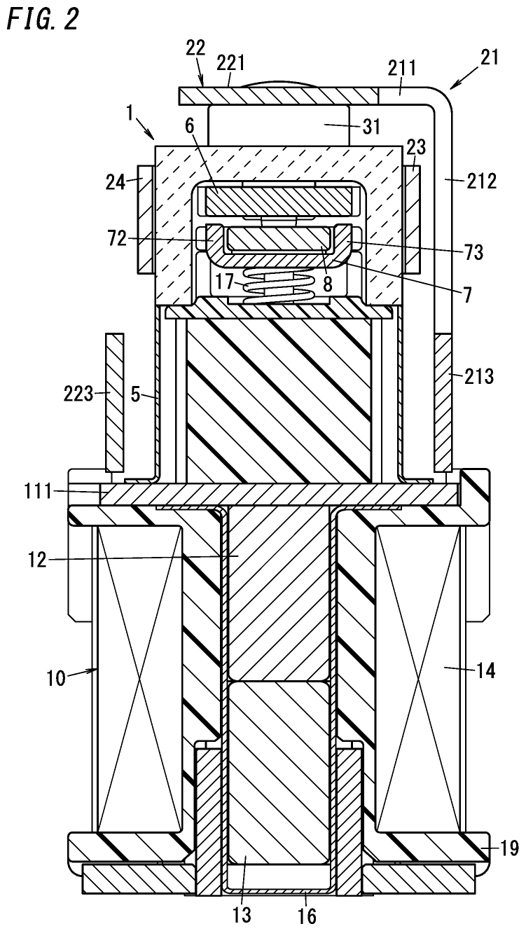

The second yoke 7 has, at both ends in the forward/backward direction, a pair of protrusions 72, 73 protruding upward (see FIG. 2). In other words, at both ends in the forward/backward direction of the upper surface of the second yoke 7, provided are protrusions 72, 73 protruding in the direction in which the moving contactor 8 moves from the open position toward the closed position (i.e., upward in this embodiment). That is to say, at least part of the second yoke 7 is located opposite from the fixed contacts 311, 321 with respect to the moving contactor 8 in the direction in which the moving contactor 8 moves.

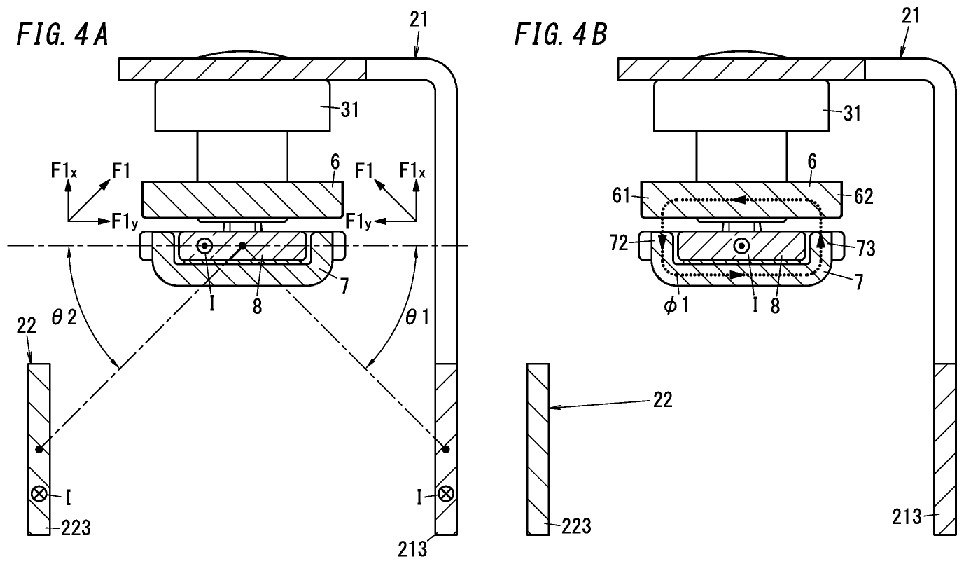

When the second yoke 7 has such a shape, the tip surface (i.e., upper end face) of the front protrusion 72, out of the pair of protrusions 72, 73, is abutted on a frontend portion 61 of the first yoke 6, while the tip surface (i.e., upper end face) of the rear protrusion 73, out of the pair of protrusions 72, 73, is abutted on a rear end portion 62 of the first yoke 6 as shown in FIG. 4B. Thus, when an electric current I flows through the moving contactor 8 in the direction shown as an example in FIG. 4B, a magnetic flux φ1 is generated to pass through a magnetic path formed by the first yoke 6 and the second yoke 7. At this time, the frontend portion 61 of the first yoke 6 and the tip surface of the protrusion 73 turn into N pole and the rear end portion 62 of the first yoke 6 and the tip surface of the protrusion 72 turn into S pole, thus producing attractive force between the first yoke 6 and the second yoke 7.

The capsule yokes 23, 24 (magnet yokes) are made of a ferromagnetic material, for example, a metal material such as iron. The capsule yokes 23, 24 hold arc extinction magnets 25, 26. The capsule yokes 23, 24 hold the arc extinction magnets 25, 26, thereby magnetically coupled thereto, to form part of the path of the magnetic flux of the arc extinction magnets 25, 26. The capsule yokes 23, 24 are placed on both sides in the forward/backward direction of the case 4 so as to surround the case 4 from the both sides in the forward/backward direction (see FIG. 6). In FIG. 6, the bus bars 21, 22 are not shown.

As described above, the capsule yoke 23 includes the extended portion 231 extending along the direction of the current flowing through the moving contactor 8, and the capsule yoke 24 includes the extended portion 241 extending along the direction of the current flowing through the moving contactor 8. The capsule yokes 23, 24 are placed not to overlap with the electric path pieces 213, 223 when viewed in a direction perpendicular to the moving directions of the moving contactor 8 and the direction of the current flowing through the moving contactor 8 (see FIG. 1A). Specifically, the extended portion 231 of the capsule yoke 23 and the extended portion 241 of the capsule yoke 24 do not overlap with the electric path pieces 213, 223 when viewed in the direction perpendicular to the moving directions of the moving contactor 8 and the direction of the current flowing through the moving contactor 8. Here, the electric path pieces 213, 223 may be placed to allow at least parts thereof to overlap with the extended portions 231, 241 when viewed in the direction perpendicular to the moving directions of the moving contactor 8 and the direction of the current flowing through the moving contactor 8. In short, it is preferable that at least parts of the electric path pieces 213, 223 do not overlap with the extended portions 231, 241 when viewed in the direction perpendicular to the moving directions of the moving contactor 8 and the direction of the current flowing through the moving contactor 8.

The arc extinction magnets 25, 26 are arranged such that their poles facing each other in the rightward/leftward direction have mutually opposite polarities. In other words, the arc extinction magnets 25, 26 are arranged as extensions in the direction in which an electric current I flows through the moving contactor 8. The arc extinction magnets 25, 26 are arranged at both ends in the rightward/leftward direction with respect to the case 4. The arc extinction magnets 25, 26 stretch the arc generated between the moving contacts 81, 82 and the fixed contacts 311, 321 while the moving contactor 8 moves from the closed position toward the open position. The capsule yokes 23, 24 encapsulate the case 4 as well as the arc extinction magnets 25, 26 in their entirety. In other words, the arc extinction magnets 25, 26 are interposed between the right and left end faces of the case 4 and the capsule yokes 23, 24. Specifically, one surface in the rightward/leftward direction (i.e., left end face) of one (left) arc extinction magnet 25 is coupled to one end of the capsule yokes 23, 24 and the other surface in the rightward/leftward direction (i.e., right end face) of the arc extinction magnet 25 is coupled to the case 4. One surface in the rightward/leftward direction (i.e., right end face) of the other (right) arc extinction magnet 26 is coupled to the other end of the capsule yokes 23, 24 and the other surface in the rightward/leftward direction (i.e., left end face) of the arc extinction magnet 26 is coupled to the case 4. In this embodiment, the arc extinction magnets 25, 26 are arranged such that their poles facing each other in the rightward/leftward direction have mutually opposite polarities. However, this is only an example and should not be construed as limiting. Alternatively, the arc extinction magnet 25, 26 may also be arranged such that their poles facing each other in the rightward/leftward direction have the same polarity.

Furthermore, the arc extinction magnets 25, 26 are placed not to overlap with the electric path pieces 213, 223 when viewed in a direction perpendicular to the moving directions of the moving contactor 8 and the direction of the current flowing through the moving contactor 8 (see FIG. 1). In other words, the electric path pieces 213, 223 do not overlap with the arc extinction magnets 25, 26 when viewed in the direction perpendicular to the moving directions of the moving contactor 8 and the direction of the current flowing through the moving contactor 8. Here, the electric path pieces 213, 223 may be placed to allow at least parts thereof to overlap with the arc extinction magnets 25, 26 when viewed in the direction perpendicular to the moving directions of the moving contactor 8 and the direction of the current flowing through the moving contactor 8. In short, it is preferable that at least parts of the electric path pieces 213, 223 do not overlap with the arc extinction magnets 25, 26 when viewed in the direction perpendicular to the moving directions of the moving contactor 8 and the direction of the current flowing through the moving contactor 8.

In this embodiment, while the moving contactor 8 is currently located at the closed position, the respective points of contact between the pair of fixed contacts 311, 321 and the pair of moving contacts 81, 82 are located between the arc extinction magnets 25, 26 (see FIG. 1B). That is to say, the respective points of contact between the pair of fixed contacts 311, 321 and the pair of moving contacts 81, 82 fall within a magnetic field generated between the arc extinction magnets 25, 26.

According to this configuration, the capsule yoke 23 forms part of a magnetic circuit, through which a magnetic flux φ2 generated by the pair of arc extinction magnets 25, 26 passes, as shown in FIG. 6. Likewise, the capsule yoke 24 also forms part of a magnetic circuit, through which a magnetic flux φ2 generated by the pair of arc extinction magnets 25, 26 passes, as shown in FIG. 6. These magnetic fluxes φ2 have magnetic effect on the points of contact between the pair of fixed contacts 311, 321 and the pair of moving contacts 81, 82 in a state where the moving contactor 8 is currently located at the closed position.

In the example illustrated in FIG. 5, in the internal space of the case 4, leftward magnetic fluxes φ2 are supposed to have been generated, a downward electric current I is supposed to flow through the fixed terminal 31, and an upward electric current I is supposed to flow through the fixed terminal 32. When the moving contactor 8 moves from the closed position toward the open position in such a state, an electric discharge current (arc) is generated downward from the fixed contact 311 toward the moving contact 81 between the fixed contact 311 and the moving contact 81. Thus, the magnetic flux φ2 applies backward Lorenz force F2 to the arc (see FIG. 6). As a result, the arc generated between the fixed contact 311 and the moving contact 81 is stretched backward to be extinct. On the other hand, an electric discharge current (arc) is generated upward from the moving contact 82 toward the fixed contact 321 between the fixed contact 321 and the moving contact 82. Thus, the magnetic flux φ2 applies forward Lorenz force F3 to the arc (see FIG. 6). As a result, the arc generated between the fixed contact 321 and the moving contact 82 is stretched forward to be extinct.

The case 4 may be made of a ceramic material such as aluminum oxide (alumina). The case 4 is formed in the shape of a hollow rectangular parallelepiped, of which the dimension is greater in the rightward/leftward direction than in the forward/backward direction (see FIG. 1B). The lower surface of the case 4 is open. The case 4 houses the pair of fixed contacts 311, 321, the moving contactor 8, the first yoke 6, and the second yoke 7. The upper surface of the case 4 has a pair of openings to pass the pair of fixed terminals 31, 32 therethrough. The pair of openings may be formed in a circular shape, for example, and runs through the upper wall of the case 4 along the thickness thereof (i.e., in the upward/downward direction). The fixed terminal 31 is passed through one opening and the fixed terminal 32 is passed through the other opening. The pair of fixed terminals 31, 32 and the case 4 are coupled together by brazing, for example.

The case 4 only needs to be formed in the shape of a box that houses the pair of fixed contacts 311, 321 and the moving contactor 8. Thus, the case 4 does not have to be formed in the shape of a hollow rectangular parallelepiped as in this embodiment but may also be formed in the shape of a hollow elliptic cylinder or a hollow polygonal column, for example. That is to say, as used herein, the “box shape” refers to any shape in general which has a space to house the pair of fixed contacts 311, 321 and the moving contactor 8 inside, and therefore, does not have to be a rectangular parallelepiped shape. Furthermore, the case 4 does not have to be made of a ceramic material but may also be made of an electrical insulating material such as glass or resin or may even be made of a metallic material. In any case, the case 4 is suitably made of a non-magnetic material so as not to be magnetized with magnetism and turn into a magnetic body. In short, the case 4 preferably has a non-magnetic portion made of a non-magnetic material. In this embodiment, the case 4 itself is the non-magnetic portion 400 (see FIG. 1A), for example.

The flange 5 is made of a non-magnetic metallic material, which may be an austenitic stainless steel such as SUS304. The flange 5 may be formed in the shape of a hollow rectangular parallelepiped elongated in the rightward/leftward direction. The upper and lower surfaces of the flange 5 are open. The flange 5 is arranged between the case 4 and the electromagnet device 10 (see FIGS. 1B and 2). The flange 5 is hermetically coupled to the case 4 and a yoke upper plate 111 of the electromagnet device 10 as will be described later. This turns the internal space, surrounded with the case 4, the flange 5, and the yoke upper plate 111, of the contact device 1 into a hermetically sealed space. The flange 5 does not have to be made of a non-magnetic material but may also be made of an alloy, such as 42 alloy, including iron as a main component.

The insulation plate 41 is made of a synthetic resin and has electrical insulation properties. The insulation plate 41 is formed in the shape of a rectangular plate. The insulation plate 41 is located under the moving contactor 8 to electrically insulate the moving contactor 8 from the electromagnet device 10. The insulation plate 41 has a through hole 42 at a middle portion thereof. In this embodiment, the through hole 42 is aligned with the through hole 83 of the moving contactor 8. The through hole 42 runs through the insulation plate 41 along the thickness thereof (i.e., in the upward/downward direction). The through hole 42 is provided to pass the shaft 15 therethrough.

The spacer 45 is formed in the shape of a cylinder. The spacer 45 may be made of a synthetic resin, for example. The spacer 45 is arranged between the electromagnet device 10 and the insulation plate 41. The upper end of the spacer 45 is coupled to the lower surface of the insulation plate 41 and the lower end of the spacer 45 is coupled to the electromagnet device 10. The insulation plate 41 is supported by the spacer 45. The spacer 45 has a hole to pass the shaft 15 therethrough.

The bus bars 21, 22 are made of a metallic material with electrical conductivity. The bus bars 21, 22 may be made of copper or a copper alloy, for example. The bus bars 21, 22 are each formed in the shape of a band. In this embodiment, the bus bars 21, 22 are formed by subjecting a metal plate to folding. One longitudinal end of the bus bar 21 may be electrically connected to the fixed terminal 31 of the contact device 1, for example. The other longitudinal end of the bus bar 21 may be electrically connected to a traveling battery, for example. One longitudinal end of the bus bar 22 may be electrically connected to the fixed terminal 32 of the contact device 1, for example. The other longitudinal end of the bus bar 22 may be electrically connected to the load, for example.

The bus bar 21 includes three electric path pieces 211, 212, 213. The electric path piece 211 is mechanically connected to the fixed terminal 31. Specifically, the electric path piece 211 has a substantially square shape in a plan view and is coupled with the fixed terminal 31 by swaging at a swaged portion 35 of the fixed terminal 31. The electric path piece 212 (extension piece) is connected to the electric path piece 211 and is placed in back of the case 4 to extend downward from a rear end portion of the electric path piece 211. In other words, the electric path piece 212 is placed in back of the case 4 to extend along the moving directions of the moving contactor 8. The electric path piece 213 (first electric path piece) is connected to the electric path piece 212 and is placed in back of the case 4 to extend rightward (in a direction from the fixed terminal 31 toward the fixed terminal 32) from a lower end portion of the electric path piece 212. The electric path piece 213 has its thickness direction (forward/backward direction) perpendicular to the moving directions of the moving contactor 8 (upward/downward direction) (see FIGS. 1A and 2).

The bus bar 22 includes three electric path pieces 221, 222, 223. The electric path piece 221 is mechanically connected to the fixed terminal 32. Specifically, the electric path piece 221 has a substantially square shape in a plan view and is coupled with the fixed terminal 32 by swaging at a swaged portion 36 of the fixed terminal 32. The electric path piece 222 (extension piece) is connected to the electric path piece 221 and is placed in front of the case 4 to extend downward from a rear end portion of the electric path piece 221. In other words, the electric path piece 222 is placed in front of the case 4 to extend along the moving directions of the moving contactor 8. The electric path piece 223 (second electric path piece) is connected to the electric path piece 222 and is placed in front of the case 4 to extend leftward (in a direction from the fixed terminal 32 toward the fixed terminal 31) from a lower end portion of the electric path piece 222. Further, the electric path piece 223 has its thickness direction (forward/rearward direction) perpendicular to the moving directions of the moving contactor 8 (upward/downward direction).

Here, the bus bars 21, 22 have rigidity. Therefore, by mechanically connecting one longitudinal ends of the bus bars 21, 22 (the electric path pieces 211, 221) to the fixed terminals 31, 32, the entire bus bars 21, 22 are held by the fixed terminals 31, 32. Thus, the other longitudinal ends of the bus bars 21, 22 (the electric path pieces 213, 223) are free-standing. Therefore, the bus bars 21, 22 are integrated with the fixed terminals 31, 32.

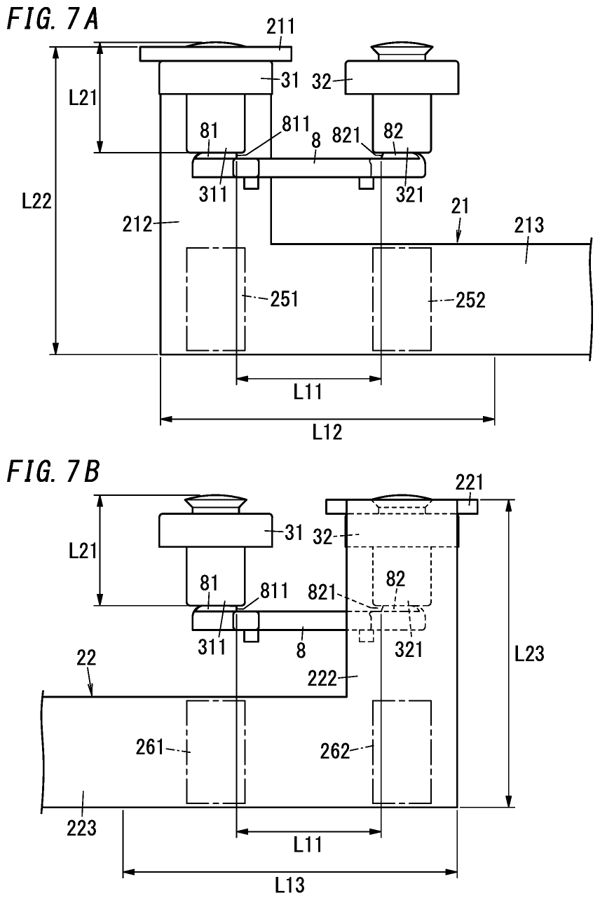

Further, a length L22 of the electric path piece 212 and a length L23 of the electric path piece 222 are equal to or greater than lengths L21 in the upward/downward direction of the fixed terminals 31, 32 (see FIGS. 7A and 7B). In FIGS. 7A and 7B, the length L21 means a dimension from an upper end edge of the fixed terminal 31 (or 32) to a lower end edge of the fixed terminal 31 (or 32) (including the fixed contact 311 (or 321)). However, the length L21 which should satisfy the above-mentioned dimensional relationship with the lengths L22, L23 is equal to or larger than a length from a part of the fixed terminal 31 (32) connected to the bus bar 21 (22) to a part of the fixed terminal 31 (32) holding the fixed contact 311 (321).

Here, the moving contactor 8 is positioned between the electric path pieces 213, 223 and the fixed contacts 311, 321 when viewed in one direction along the forward/backward direction while the moving contactor 8 is in the closed position. To satisfy the above positional relationship, the electric path pieces 213, 223 are placed outside the case 4 to be almost parallel to the moving contactor 8 (see FIGS. 1B and 2). In other words, the electric path pieces 213, 223 allow the moving contactor 8 to be positioned between the electric path pieces 213, 223 and the fixed contacts 311, 321 in the moving directions of the moving contactor 8 (the upward/downward direction) while the moving contactor 8 is in the closed position.

In the present embodiment, as shown in FIG. 4A, in a cross section perpendicular to the rightward/leftward direction, an angle θ1 between a straight line connecting a center point of the electric path piece 213 and a center point of the moving contactor 8 and a straight line along the forward/backward direction is 45 degrees. Similarly, in a cross section perpendicular to the rightward/leftward direction, an angle θ2 between a straight line connecting a center point of the electric path piece 223 and the center point of the moving contactor 8 and a straight line along the forward/backward direction is equal to the angle θ1 (45 degrees here). Here, “equal” may mean “having a completely same value” and also mean “having a value falling within an allowable range of errors of a few degrees. The above numerical value (45 degrees) is a mere example, and there is no intent to limit the scope to this numerical value. In FIG. 4A, to avoid an overlap between a center point of a cross section of the moving contactor 8 and an indication of the current I, the indication of the current I is put in a position displaced from the center point of the cross section of the moving contactor 8. However, there is no intent to specify an actual position where the current I flows, by the indication. The same applies to the indications of the current I flowing through the electric path pieces 213, 223.

Further, the electric path pieces 213, 223 are placed between a yoke upper plate 111 of the yoke 11 which will be described later and the moving contactor 8 in the closed position.

Furthermore, a length L12 of the electric path piece 213 and a length L13 of the electric path piece 223 each are equal to or larger than a distance L11 between the moving contact 81 and the moving contact 82 (see FIGS. 7A, 7B). Here, the distance L11 between the moving contact 81 and the moving contact 82 is defined as the shortest distance between the moving contact 81 and the moving contact 82.

In other words, the electric path piece 213 includes a first portion 251 overlapping with the fixed contact 311 and a second portion 252 connected to the first portion 251 and overlapping with the fixed contact 321 in a direction perpendicular to a direction in which the fixed contact 311 and the fixed contact 321 are arranged when viewed in one of the moving directions of the moving contactor 8 (see FIG. 7A). Similarly, the electric path piece 223 includes a first portion 261 overlapping with the fixed contact 311 and a second portion 262 connected to the first portion 261 and overlapping with the fixed contact 321 in a direction perpendicular to the direction in which the fixed contact 311 and the fixed contact 321 are arranged when viewed in one of the moving directions of the moving contactor 8 (see FIG. 7B).

Further, in other words, the electric path piece 213 includes the first portion 251 in a position facing the fixed contact 311 in the moving directions of the moving contactor 8 when viewed in one of directions perpendicular to the moving directions of the moving contactor 8 and the direction of the current flowing through the moving contactor 8 (see FIG. 7A). Further, the electric path piece 213 includes the second portion 252 in a position facing the fixed contact 321 in the moving directions of the moving contactor 8 when viewed in one of directions perpendicular to the moving directions of the moving contactor 8 and the direction of the current flowing through the moving contactor 8 (see FIG. 7A). The electric path piece 223 includes the first portion 261 in a position facing the fixed contact 311 in the moving directions of the moving contactor 8 when viewed in one of directions perpendicular to the moving directions of the moving contactor 8 and the direction of the current flowing through the moving contactor 8 (see FIG. 7B). Further, the electric path piece 223 includes the second portion 262 in a position facing the fixed contact 321 in the moving directions of the moving contactor 8 when viewed in one of directions perpendicular to the moving directions of the moving contactor 8 and the direction of the current flowing through the moving contactor 8 (see FIG. 7B).

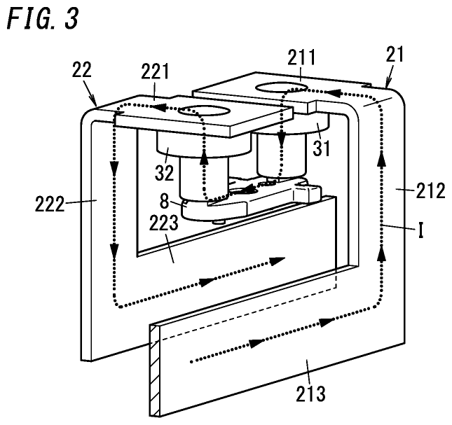

In the present embodiment, the electric path piece 213 extends (protrudes) rightward from the electric path piece 212 and the electric path piece 223 extends (protrudes) leftward from the electric path piece 222. Here, first of all, it is assumed that the current I flows through the moving contactor 8 from fixed terminal 31 toward the fixed terminal 32. At this time, the current I flows through the electric path piece 213, the electric path piece 212, the electric path piece 211, the fixed terminal 31, the moving contactor 8, the fixed terminal 32, the electric path piece 221, the electric path piece 222, and the electric path piece 223, in this order (see FIG. 3). In the electric path pieces 213, 223, the current I flows leftward (in a direction from the fixed terminal 32 toward the fixed terminal 31). On the other hand, in the moving contactor 8, the current I flows rightward (in a direction from the fixed terminal 31 toward the fixed terminal 32). In contrast, when the current I flows through the moving contactor 8 from the fixed terminal 32 toward the fixed terminal 31, the current I flows rightward in the electric path pieces 213, 223 but the current I flows leftward in the moving contactor 8.

In other words, the electric path pieces 213, 223 extend (protrude) from the electric path pieces 212, 222 in opposite directions, and therefore the currents I flow through the electric path pieces 213, 223 in an opposite direction from the current I flowing through the moving contactor 8. In other words, the electric path pieces 213, 223 each serve as a reverse electric path piece being positioned in an opposite side from the fixed contact 311, 321 relative to the moving contactor 8 in the moving directions of the moving contactor 8 while the moving contactor 8 is in the closed position, to allow the current I to flow therethrough in an opposite direction from the current I flowing through the moving contactor 8.

Here, the electric path pieces 213, 223 have a shape extending along the direction of the current I flowing through the moving contactor 8. In the present embodiment, the direction of the current I flowing through the moving contactor 8 is along a direction extending along a straight line connecting the center point of the moving contact 81 and the center point of the moving contact 82 in an upper surface of the moving contactor 8, that is, the rightward/leftward direction. Further, the electric path pieces 212, 222 has a shape extending along the direction of the current I flowing through the fixed terminals 31, 32. In the present embodiment, the directions of the currents I flowing through the fixed terminals 31, 32 are along directions of a central axis of the fixed terminal 31 or the fixed terminal 32, that is the upward/downward direction.

In the present embodiment, the electric path piece 213 serving as one reverse electric path piece is positioned in back of the case 4, and the electric path piece 223 serving as another reverse electric path piece is positioned in front of the case 4. That is, the bus bars 21, 22 serving as electrically conductive members include a pair of reverse electric path pieces (electric path pieces 213, 223) and the moving contactor 8 is positioned between the pair of reverse electric path pieces (electric path pieces 213, 223) when viewed in one of the moving directions of the moving contactor 8.

As used herein, the phrase “extending in the direction in which the electric current flows” refers to an arrangement in which the electrical path piece 213 (or 223) is provided such that the angle defined by the electrical path piece 213 (or 223) extending with respect to the direction in which the electric current flows through the moving contactor 8 of the contact device 1 falls within a predetermined range (e.g., from 0 to 45 degrees). That is to say, the electrical path piece 213 (or 223) is provided such that out of vectors of the electric current flowing through the electrical path piece 213 (or 215), a component parallel to the vector of the electric current flowing through the moving contactor 8 of the contact device 1 becomes greater than a component perpendicular to the vector of the electric current flowing through the moving contactor 8 of the contact device 1. In addition, the angle defined by the electrical path piece 213 (or 223) extending with respect to the direction in which the electric current flows through the moving contactor 8 of the contact device 1 suitably falls within a predetermined range (e.g., from 0 to 25 degrees). In a specific example, the electrical path piece 213 (or 223) of the contact device 1 extends parallel to the direction in which the electric current flows through the moving contactor 8 of the contact device 1.

Further, the current I flows through the electric path piece 212 in an opposite direction from the current I flowing through the fixed terminal 31. Furthermore, the current I flows through the electric path piece 222 in an opposite direction from the current I flowing through the fixed terminal 32. Specifically, it is assumed that the current I flows from the fixed terminal 31 toward the fixed terminal 32. The current I flows upward in the electric path piece 212 and the current I flows downward in the fixed terminal 31. The current I flows downward in the electric path piece 222 and the current I flows upward in the fixed terminal 32.

Further, as shown in FIG. 1A, the electric path pieces 213, 223 and the arc extinction magnets 25, 26 are placed so that the arc extinction magnets 25, 26 and the electric path pieces 213, 223 are arranged in this order from the above in the moving directions of the moving contactor 8 (the upward/downward direction). In other words, in the upward/downward direction, the electric path pieces 213, 223 are positioned below the arc extinction magnets 25, 26.

(1.3) Electromagnet Device

Next, a configuration for the electromagnet device 10 will be described.

The electromagnet device 10 is arranged under the moving contactor 8. As shown in FIGS. 1A and 1B, the electromagnet device 10 includes a stator 12, the mover 13, and the excitation coil 14. When the excitation coil 14 is energized, the electromagnet device 10 has the mover 13 attracted toward the stator 12 by a magnetic field generated by the excitation coil 14, thereby moving the mover 13 upward.

In this embodiment, the electromagnet device 10 includes not only the stator 12, the mover 13, and the excitation coil 14 but also a yoke 11 including the yoke upper plate 111, the shaft 15, a cylindrical body 16, a contact pressure spring 17, a return spring 18, and a coil bobbin 19 as well.

The stator 12 is a fixed iron core formed in the shape of a cylinder protruding downward from a central region of the lower surface of the yoke upper plate 111. The upper end of the stator 12 is secured to the yoke upper plate 111.

The mover 13 is a moving iron core also formed in the shape of a cylinder. The mover 13 is arranged under the stator 12 such that the upper end face of the mover 13 faces the lower end face of the stator 12. The mover 13 is configured to be movable in the upward/downward direction. Specifically, the mover 13 moves from an excitation position where the upper end face thereof is in contact with the lower end face of the stator 12 (see FIGS. 1B and 2) to a non-excitation position where the upper end face thereof is out of contact with the lower end face of the stator 12, and vice versa.

The excitation coil 14 is arranged under the case 4 such that its center axis is aligned with the upward/downward direction. The stator 12 and the mover 13 are arranged inside the excitation coil 14. The excitation coil 14 is electrically insulated from the contact device 1. That is to say, the excitation coil 14 is electrically insulated from the bus bars 21, 22, which serve as electrically conductive members to be electrically connected to the fixed terminals 31, 32 of the contact device 1.

The yoke 11 is arranged to surround the excitation coil 14. The yoke 11 forms, along with the stator 12 and the mover 13, a magnetic circuit through which magnetic fluxes pass when the excitation coil 14 is energized. Thus, the yoke 11, the stator 12, and the mover 13 are all made of a magnetic material (such as a ferromagnetic body). The yoke upper plate 111 forms part of the yoke 11. In other words, at least part of the yoke 11 (i.e., the yoke upper plate 111) is located between the excitation coil 14 and the moving contactor 8.

The contact pressure spring 17 is arranged between the lower surface of the moving contactor 8 and the upper surface of the insulation plate 41. The contact pressure spring 17 is a coil spring that biases the moving contactor 8 upward (see FIG. 1B).

At least part of the return spring 18 is arranged inside the stator 12. The return spring 18 is a coil spring that biases the mover 13 downward (toward the non-excitation position). One end of the return spring 18 is connected to the upper end face of the mover 13 and the other end of the return spring 18 is connected to the yoke upper plate 111 (see FIG. 1B).

The shaft 15 is made of a non-magnetic material. The shaft 15 is formed in the shape of a round rod extending in the upward/downward direction. The shaft 15 transmits the driving force, generated by the electromagnet device 10A, to the contact device 1A provided over the electromagnet device 10A. The shaft 15 passes through the through hole 83, the through hole 71, the inside of the contact pressure spring 17, the through hole 42, the through hole cut through a central region of the yoke upper plate 111, the inside of the stator 12, and the inside of the return spring 18 to have the lower end thereof fixed onto the mover 13. The first yoke 6 is fixed onto the upper end of the shaft 15.

The coil bobbin 19 is made of a synthetic resin. The excitation coil 14 is wound around the coil bobbin 19.

The cylindrical body 16 is formed in the shape of a bottomed cylinder with an open upper surface. The upper end (peripheral portion around the opening) of the cylindrical body 16 is bonded onto the lower surface of the yoke upper plate 111. This allows the cylindrical body 16 to restrict the direction of movement of the mover 13 to the upward/downward direction and also define the non-excitation position of the mover 13. The cylindrical body 16 is hermetically bonded onto the lower surface of the yoke upper plate 111. This allows, even when a through hole is cut through the yoke upper plate 111, the internal space, surrounded with the case 4, the flange 5, and the yoke upper plate 111, of the contact device 1 to be kept sealed hermetically.

This configuration allows the moving contactor 8 to move up and down in the upward/downward direction as the mover 13 moves up and down in the upward/downward direction under the driving force generated by the electromagnet device 10.

(2) Operation

Next, it will be described briefly how an electromagnetic relay 100, including the contact device 1 and electromagnet device 10 with such configurations, operates.

While the excitation coil 14 is supplied with no electric current (i.e., not energized), no magnetic attractive force is generated between the mover 13 and the stator 12. Thus, in such a situation, the mover 13 is located at the non-excitation position under the spring force applied by the return spring 18. At this time, the shaft 15 has been pulled down to restrict the upward movement of the moving contactor 8. This causes the moving contactor 8 to be located at the open position, which is lower end position of its movable range. This brings the pair of moving contacts 81, 82 out of contact with the pair of fixed contacts 311, 321, thus turning the contact device 1 open. In this state, the pair of fixed terminals 31, 32 are not electrically conductive with each other.

On the other hand, when the excitation coil 14 is energized (i.e., supplied with an electric current), magnetic attractive force is generated between the mover 13 and the stator 12, thus causing the mover 13 to be pulled upward by overcoming the spring force applied by the return spring 18 to reach the excitation position. At this time, the shaft 15 is pushed upward, thus canceling the shaft's 15 restriction on the upward movement of the moving contactor 8. Then, the contact pressure spring 17 biases the moving contactor 8 upward, thus causing the moving contactor 8 to move toward the closed position at the upper end of its movable range. This brings the pair of moving contacts 81, 82 into contact with the pair of fixed contacts 311, 321, thus turning the contact device 1 closed. In this state, the contact device 1 is closed, and therefore, the pair of fixed terminals 31, 32 are electrically conductive with each other.

This allows the electromagnet device 10 to control the attractive force to be applied onto the mover 13 by selectively energizing the excitation coil 14 and to generate driving force for changing the state of the contact device 1 from the open state to the closed state, and vice versa, by moving the mover 13 up and down in the upward/downward direction.

(3) Benefits

Here, advantages of including the aforementioned bus bars 21, 22 and advantages of including the first yoke 6 and the second yoke 7 will be described.

When the excitation coil 14 is energized (or supplied with an electric current), the mover 13 moves from the non-excitation position to the excitation position in the electromagnet device 10 as described above. At this time, the driving force generated by the electromagnet device 10 causes the moving contactor 8 to move upward from the open position toward the closed position. This brings the moving contacts 81, 82 into contact with the fixed contacts 311, 321, thus turning the contact device 1 closed. When the contact device 1 is closed, the contact pressure spring 17 presses the moving contacts 81, 82 against the fixed contacts 311, 321, respectively.

In some cases, when the contact device 1 is closed, electromagnetic repulsion that brings the moving contacts 81, 82 out of contact with the fixed contacts 311, 321 may be caused by an electric current flowing through the contact device 1 (between the fixed terminals 31, 32) That is to say, when an electric current flows through the contact device 1, the Lorenz force sometimes causes the electromagnetic repulsion to the moving contactor 8 in such a direction as to move the moving contactor 8 from the closed position toward the open position (i.e., downward). The electromagnetic repulsion is ordinarily less than the spring force applied by the contact pressure spring 17, thus allowing the moving contactor 8 to keep the moving contacts 81, 82 in contact with the fixed contacts 311, 321. Nevertheless, when a significant amount of current (of about 6 kA, for example) such as a short-circuit current flows (as an abnormal current) through the contact device 1, the electromagnetic repulsion applied to the moving contactor 8 could be greater than the spring force applied by the contact pressure spring 17. In this embodiment, an electric current flowing through the bus bar 21 is used as a countermeasure against such electromagnetic repulsion.

That is, in the contact device 1 according to the present embodiment, the bus bars 21, 22 include the electric path pieces 213, 223 allowing the current I to flow therethrough in an opposite direction from the current I flowing through the moving contactor 8. Therefore, when an abnormal current such as a short-circuit current flows through the contact device 1, a repulsive force F1 is developed between the electric path piece 213 and the moving contactor 8 and between the electric path piece 223 and the moving contactor 8 (see FIG. 4A). The “repulsive force F1” referred to in the present disclosure is a force which is one of interactive forces between the moving contactor 8 and the electric path pieces 213, 223 and separates the moving contactor 8 and the electric path pieces 213, 223 from each other. The repulsive force F1 is a force received by the current I flowing through the moving contactor 8 and the electric path pieces 213, 223 by a Lorentz force.

In the present embodiment, while the moving contactor 8 is in the closed position, the moving contactor 8 is positioned between the electric path pieces 213, 223 and the fixed contacts 311, 321 in the moving directions of the moving contactor 8 (the upward/downward direction). The electric path pieces 213, 223 are fixed to the fixed terminals 31, 32 and therefore do not move relative to the case 4. On the other hand, the moving contactor 8 is movable in the upward/downward direction relative to the case 4. Therefore, the repulsive force F1 includes a force component F1x in the upward/rearward direction and a force component F1y in the forward/rearward direction, and the force component F1x acts on the moving contactor 8 (see FIG. 4A). As a result, a force moving the moving contactor 8 upward, that is, a force pressing the moving contacts 81, 82 against the fixed contacts 311, 321 is increased. In other words, while the moving contactor 8 is in the closed position, a magnetic field caused by the current I flowing through the electrically conductive member placed outside the case 4 causes a force on the moving contactor 8 in the moving directions of the moving contactor 8 to keep the moving contactor 8 in the closed position. Here, the force component F1x in the upward/downward direction of the repulsive force F1 corresponds to the force keeping the moving contactor 8 in the closed position.

Therefore, even when an abnormal current such as a short-circuit current flows through the contact device 1, it is possible to stabilize the connection state between the moving contacts 81, 82 and the fixed contacts 311, 321.

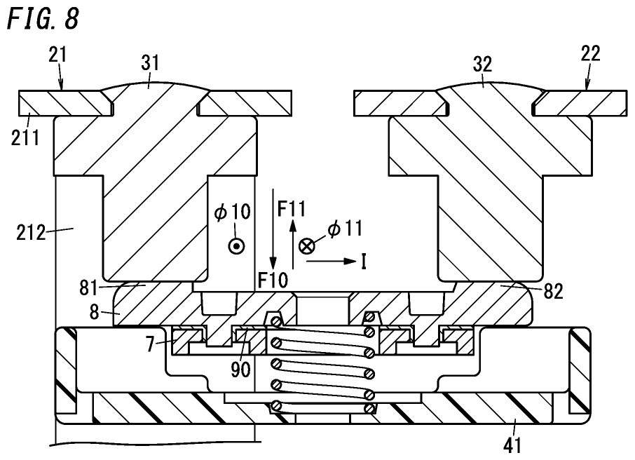

Further, in the contact device 1 according to the present embodiment, the bus bars 21, 22 include the electric path pieces 212, 222 allowing the current I to flow therethrough in an opposite direction from the current I flowing through the fixed terminals, 31, 32. Here, as shown in FIG. 3, it is assumed that the current I flows from the fixed terminal 31 toward the fixed terminal 32. In this case, the current I flows downward in the fixed terminal 31 and therefore a magnetic flux φ10 (see FIG. 8) which is clockwise around the fixed terminal 31 in a top view (when viewed from above) is produced. In contrast, the current I flows upward in the electric path piece 212 and therefore a magnetic flux φ10 (see FIG. 8) which is counter-clockwise around the electric path piece 212 in a top view (when viewed from above) is produced.

At this time, based on a relation between the current I flowing rightward through the moving contactor 8 and the magnetic flux φ10, a downward Lorentz force F10 acts on the moving contactor 8. Further, based on a relation between the current I flowing rightward through the moving contactor 8 and the magnetic flux φ11, an upward Lorentz force F11 acts on the moving contactor 8. In other words, the contact device 1 includes the electric path piece 212 and thus can generate the upward Lorentz force F11. As a result, at least part of the downward Lorentz force F10 is compensated for (canceled) and therefore a force moving the moving contactor 8 downward can be weakened.

Similarly, based on a relation between the magnetic flux generated by the current I flowing through the fixed terminal 32 and the magnetic flux generated by the current I flowing through the electric path piece 222, at least part of the downward Lorentz force acting on the moving contactor 8 is compensated for (canceled) That is, the electric path piece 222 can weaken the force moving the moving contactor 8 downward.

Therefore, even when an abnormal current such as a short-circuit current flows through the contact device 1, it is possible to stabilize the connection state between the moving contacts 81, 82 and the fixed contacts 311, 321.

Further, in the present embodiment, the thickness directions of the electric path pieces 213, 223 (the forward/backward direction) are perpendicular to the moving directions of the moving contactor 8 (the upward/downward direction). Thus, in a cross section perpendicular to the longitudinal directions of the electric path pieces 213, 223, it is possible to relatively shorten a distance between the center point of the electric path piece 213 (or 223) and the center point of the moving contactor 8 (see FIG. 4A). In a comparative example where the thickness direction of the electric path piece is parallel to the moving directions of the moving contactor 8, the distance between the center point of the electric path piece and the center point of the moving contactor 8 in a cross section perpendicular to the longitudinal direction of the electric path piece is longer than the corresponding distance of the present embodiment. Therefore, the contact device 1 according to the present embodiment can produce between the electric path pieces 213, 223 and the moving contactor 8 the repulsive forces F1 greater than a repulsive force produced between the electric path piece and the moving contactor 8 of the comparative example.

As a result, even as compared with the comparative example, it is possible to further stabilize the connection state between the moving contacts 81, 82 and the fixed contacts 311, 321 when an abnormal current such as a short-circuit current flows through the contact device 1.

Further, in the present embodiment, the first yoke 6 and the second yoke 7 are also countermeasures against the electromagnetic repulsion force.

That is, as shown in FIG. 4B, when the current I flows through the moving contactor 8 rightward (in a direction from the fixed terminal 31 toward the fixed terminal 32), a magnetic flux φ1 which is counter-clockwise around the moving contactor viewed from the right is produced. At this time, as described above, the frontend portion 61 of the first yoke 6 and the tip surface of the protrusion 73 turn into N pole and the rear end portion 62 of the first yoke 6 and the tip surface of the protrusion 72 turn into S pole and thus an attractive force is developed between the first yoke 6 and the second yoke 7.

The first yoke 6 is secured to the tip (upper end) of the shaft 15. When the mover 13 is in the excitation position, the aforementioned attractive force attracts the second yoke 7 upward. Due to attracting the second yoke 7 upward, the moving contactor 8 receives an upward force from the second yoke 7. As a result, the force of pushing the moving contactor 8 upward, that is, the force of pressing the moving contacts 81, 82 against the fixed contacts 311, 321 is increased.

Therefore, the contact device 1 according to the present embodiment includes the first yoke 6 and the second yoke 7 and therefore it is possible to stabilize the connection state between the moving contacts 81, 82 and the fixed contacts 311, 321 even when an abnormal current such as a short-circuit current flows through the contact device 1.

(4) Electric Device

Next, the configuration of the electric device M1 will be described with reference to FIGS. 9A to 10.

The electric device M1 according to the present embodiment includes two internal devices M2 and the housing M3. The internal device M2 is the electromagnetic relay 100 having the configuration described above (the contact device 1 and the electromagnet device 10). Further, the electric device M1 includes electrically conductive bars M21, M22 as the “electrically conductive members” instead of the bus bars 21, 22 described above. Specifically, the contact device 1 includes the electrically conductive bars M21, M22. In short, the electric device case M10 includes the housing M3 and the electrically conductive bars M21, M22.

The housing M3 is made of a synthetic resin having electrically insulating properties. In the present embodiment, the housing M3 includes a base M31, an inner cover M32, and an outer cover M33.

A lower surface of the outer cover M33 is open. The base M31 is mechanically coupled to the outer cover M33 so as to close the lower surface of the outer cover M33, and thereby, together with the outer cover M33, forms a box-like outer shell that accommodates the internal device M2 (here, the electromagnetic relay 100). Mechanical coupling between the base M31 and the outer cover M33 is realized by, for example, welding or bonding.

The inner cover M32 is attached to the internal device M2 so as to cover at least part of the internal device M2 between the base M31 and the outer cover M33. A lower surface of the inner cover M32 is open. The inner cover M32 is attached to the internal device M2 from above so as to cover part of the internal device M2 which corresponds to the contact device 1. The upper surface of the inner cover M32 is provided with opening holes allow the fixed terminals 31, 32 of the internal device M2 to pass therethrough. The opening holes are formed in circular shapes, and penetrate an upper wall of the inner cover M32 in a thickness direction (the upward/downward direction). In the present embodiment, one inner cover M32 is mounted to cover the two internal devices M2 (the electromagnetic relays 100). Thus, the two internal devices M2 constituted by the electromagnetic relays 100 are held by one housing M3.

The housing M3 further includes a plurality of fixed portions M34 and a plurality of connectors M35. The electric device M1 is attached to an attachment target by the plurality of fixed portions M34. The electric device M1 is electrically connected to a connection target by the plurality of connectors M35. In the present embodiment, the electromagnetic relay 100 is assumed to be mounted on an electric vehicle. The electric device M1 is fixed to a chassis (frame or the like) of the electric vehicle as the attachment target by the plurality of fixed portions M34. In addition, the electric device M1 is electrically connected to a driving battery and a load (e.g., an inverter) as the connection target by the plurality of connectors M35. Here, the plurality of fixed portions M34 are integrally formed with the outer cover M33 so as to protrude laterally from the outer cover M33. The plurality of connectors M35 are formed integrally with the base M31 so as to penetrate the base M31 in the upward/downward direction. Further, although the connectors M35 are integral with the housing M3 but may not limited to this configuration. The connectors M35 may be separate from the housing M3 and held by the housing M3.

In the electric device M1, as shown in FIG. 10, the electrically conductive bars M21, M22 serving as the electrically conductive members are held by the housing M3. The electrically conductive bars M21, M22 correspond to the aforementioned bus bars 21, 22, respectively. That is, the electrically conductive bar M21 includes electric path pieces M211, M212, M213 respectively corresponding to the electric path pieces 211, 212, 213 of the bus bar 21. Further, the electrically conductive bar M22 includes electric path pieces M221, M222, M223 respectively corresponding to the electric path pieces 221, 222, 223 of the bus bar 22.

Here, the electric path pieces M21, M22 are partially press-fitted into the housing M3 and thus the electrically conductive bars M21, M22 are held by the housing M3. Specifically, the electrically conductive bars M21,M22 are held by the inner cover M32 by press-fitting lower end portions of the electric path pieces M212, M222 into the inner cover M32. However, how to hold the electrically conductive bars M21, M22 by the housing M3 is not limited to press-fitting. For example, the housing M3 may be formed by insert molding with the electrically conductive bars M21, M22 as inserts. Thereby the electrically conductive bars M21, M22 may be held by the housing M3. The electrically conductive bars M21, M22 may be held by the housing M3 by fixing the electrically conductive bars M21, M22 to the housing M3 by screwing, swaging, or bonding, for example.

The electrically conductive bar M22 further includes electric path pieces M224, M225, M226. The electric path piece M224 is connected to the electric path piece M223, and is placed in front of the internal device M2 so as to extend downward from a left end portion of the electric path piece M223. The electric path piece M225 is connected to the electric path piece M224, and is placed in front of the internal device M2 so as to extend rightward (in a direction from the fixed terminal 31 to the fixed terminal 32) from a lower end portion of the electric path piece M224. The electric path piece M226 is connected to the electric path piece M225, and is placed in front of the internal device M2 so as to extend downward from a right end portion of the electric path piece M225. A frontend portion (lower end portion) of the electric path piece M226 is mechanically connected (coupled) to a contact M351 of the connector M35. Here, the contact M351 is formed integrally with the electric path piece M226. Thus, in a state in which the connector M35 is electrically connected to the load as the connection target, the electrically conductive bar M22 is electrically connected to the load via the connector M35. Further, thickness directions of the electric path pieces M224, M225, M226 (the forward/backward direction) each are perpendicular to the moving directions of the moving contactor 8 (the upward/downward direction).

FIG. 10 shows a concrete shape regarding only the electrically conductive bar M22 out of the electrically conductive bars M21, M22. However, the electrically conductive bar M21 also includes an electric path piece interconnecting the electric path piece M213 and the connector M35 similarly to the electrically conductive bar M22.

Therefore, in the electric device M1, when an abnormal current such as a short-circuit current flows through the contact device 1 of the internal device M2, repulsive forces are generated between the moving contactor 8 and the electric path piece M213 of the electrically conductive bar M21, and between the moving contactor 8 and the electric path piece M223 of the electrically conductive bar M22.

Here, the electrically conductive bars M21, M22 have rigidity similarly to the bus bars 21, 22. Therefore, by mechanically connecting one longitudinal ends of the electrically conductive bars M21, M22 (the electric path pieces M211, M221) to the fixed terminals 31, 32, the entire electrically conductive bars M21, M22 are held by the fixed terminals 31, 32. Other longitudinal ends of the electrically conductive bars M21, M22 are mechanically connected to the connector M35. Therefore, the electrically conductive bars M21, M22 are held by the housing M3 directly or indirectly through the internal device M2 (the electromagnetic relay 100) so as to extend between the fixed terminals 31, 32 and the connector M35.

Furthermore, the electric device M1 further includes a shield M4. The shield M4 is made of a magnetic material (ferromagnetic material) and functions to shield the two internal devices M2 (electromagnetic relays 100) against a magnetic flux therebetween. In the electric device M1 according to the present embodiment, the two internal devices M2 are arranged back to back in the direction (the forward/backward direction perpendicular to the direction (rightward/leftward direction) in which the pair of fixed terminals 31, 32 are arranged when viewed from above. That is, the two internal devices M2 are positioned in the housing M3 so that a rear surface of one of the internal devices M2 faces a rear surface of the other of the internal devices M2. The shield M4 has a rectangular plate shape and is placed between the rear surfaces of the two internal devices M2. The shield M4 is held by the inner cover M32. Thus, it is possible to reduce effects, caused by a current flowing through the electrically conductive bar M21 electrically connected to one internal device M2, on the other internal device M2.

Further, the electric device M1 may include, in addition to the electromagnetic relay 100 as the internal device M2, various one or more sensors. The sensors may include sensors for measuring currents flowing through the internal devices M2 or the electrically conductive bars M21, M22, or temperatures of internal spaces of the internal devices M2 or the housings M3, for example.

(5) Variations

Hereinafter, possible variations of the first embodiment will be described. Hereinafter, the same components as those of the first embodiment are denoted by the same reference signs, and descriptions thereof are omitted as appropriate.

(5.1) First Variation

The configurations of the electric device M1 according to the first embodiment, in particular the configurations of the housing M3 and the electrically conductive bars M21, M22 are only examples, and may be modified appropriately.

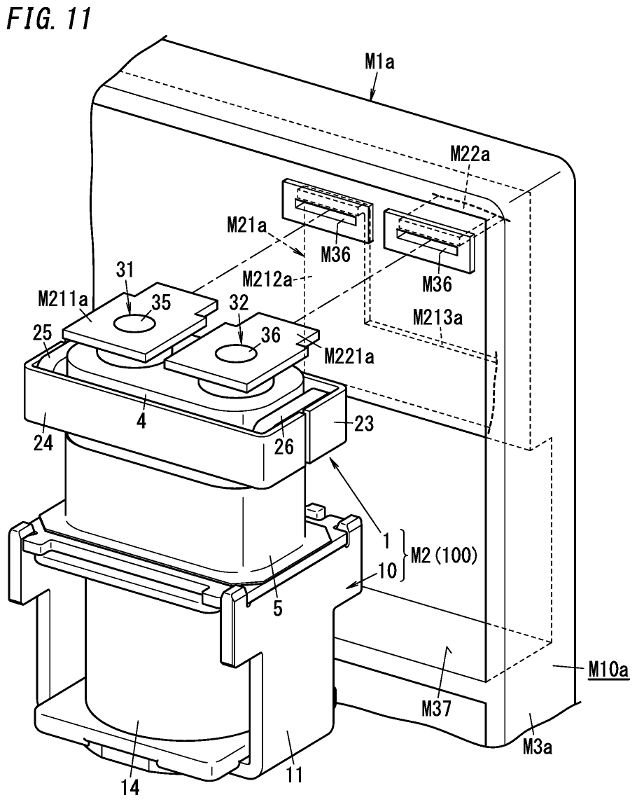

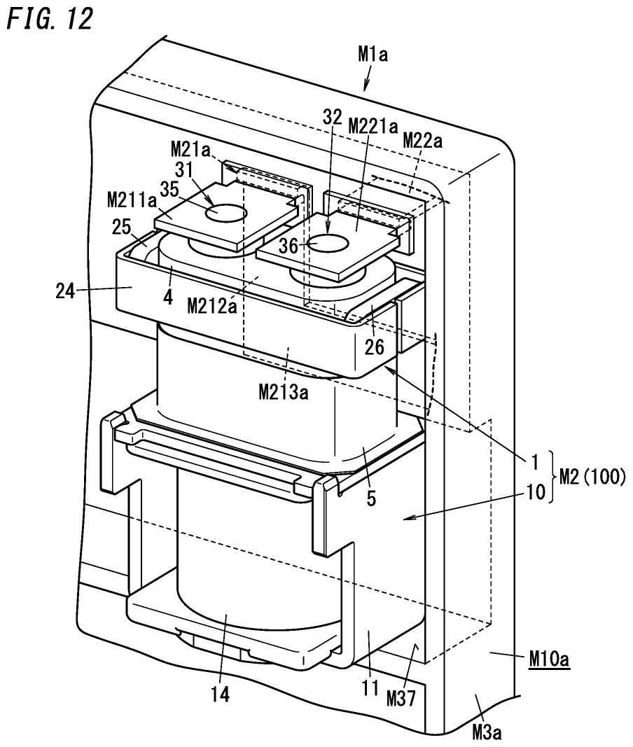

As shown in FIGS. 11 and 12, an electric device M1a according to the first variation of the first embodiment differs from the electric device M1 according to the first embodiment mainly in a configuration of a housing M3a. In addition, in accordance with the configuration of the housing M3a, the electric device M1a according to the first variation also differ from the electric device M1 according to the first embodiment in configurations of electrically conductive bars M21, M22. The electric device case M10a according to the present variation includes housing M3a and electrically conductive bars M21a, M22a.

In the present variation, the housing M3a is formed in a rectangular parallelepiped shape which is flat in the forward/backward direction. The housing M3 includes a pair of terminal ports M36 and a recess M37 in its front surface. The pair of terminal ports M36 are formed at positions facing the swaged portions 35, 36 in the forward/backward direction. The recess M37 is formed at a position facing the electromagnet device 10 in the forward/backward direction. As shown in FIG. 12, the recess M37 forms a space for avoiding interference between the housing M3a and the electromagnet device 10 by accommodating part of the electromagnet device 10 in a state in which the internal device M2 is held by the housing M3a.

The electrically conductive bar M21a includes electric path pieces M211a, M212a, M213a respectively corresponding to the electric path pieces 221, 222, 223 of the bus bar 22. The electrically conductive bar M22a includes an electric path piece M221a corresponding to the electric path piece 221 of the bus bar 22. FIGS. 11 and 12 do not depict the electric path pieces which are included in the electrically conductive bar M22a and correspond to the electric path pieces 222, 223 of the bus bar 22. Here, the electrically conductive bars M21a, M22a are physically separated into the electric path pieces M211a, M221a mechanically connected to the fixed terminals 31, 32 and other electric path pieces. In more detail, in the electrically conductive bar M21a, the electric path piece M211a is separated from the electric path pieces M212a, M213a. The electric path pieces (e.g., the electric path pieces M212a, M213a) other than the electric path pieces M211a, M221, of the electrically conductive bars M21a, M22a are embedded in the housing M3a, and are held by the housing M3a by coupling structures such as swaging.

In the present variation, as shown in FIG. 12, the internal device M2 is held by the housing M3a while the electric path pieces M211a, M221a are partially inserted into the pair of terminal ports M36. As a result, the electric path pieces M211a, M221a are in contact with the electric path pieces (e.g., the electric path pieces M212a, M213a) other than the electric path pieces M211a, M221a of the electrically conductive bars M21a, M22a by way of the terminal ports M36. Therefore, in the electrically conductive bar M21a, the electric path piece M211a is electrically connected to the electric path pieces M212a, M213a. In other words, in the present variation, electrical connection between the internal device M2 and the electrically conductive bars M21a, M22a held by the housing M3a is made by only inserting parts of the electric path pieces M211a, M221a into the pair of terminal ports M36. Here, portions of the electrically conductive bars M21a, M22a located in the pair of terminal ports M36 correspond to the contacts of the connectors. In other words, the electric device M1a further includes the connectors provided in the housing M3a. While the internal device M2 is held by the housing M3a, the fixed terminals 31, 32 are electrically connected to the electrically conductive bars M21a, M22a through the connectors.

In the state shown in FIG. 12, the positional relationship between the electric path piece M213a and the contact device 1 is identical to the positional relationship between the electric path piece 213 of the bus bar 21 and the contact device 1. Therefore, in the electric device M1a, when an abnormal current such as a short-circuit current flows through the contact device 1 of the internal device M2, a repulsive force is generated at least between the electric path piece M213a of the electrically conductive bar M21a and the moving contactor 8.

(5.2) Second Variation

shapes of bus bars are not limited to the shapes of the bus bars 21, 22 shown in the first embodiment.

Bus bars 21a, 22a shown in FIG. 13 may be applied to the contact device 1 instead of the bus bars 21, 22 described above.

The bus bar 21a of the present variation includes three electric path pieces 211a, 212a, 213a. The location of the electric path piece 212a is different from that of the electric path piece 212 in the first embodiment. The bus bar 22a of the present variation includes three electric path pieces 221a, 222a, 223a. The location of the electric path piece 222a is different from that of the electric path piece 222 in the first embodiment. That is, in the present variation, the electric path pieces 212a, 222a are arranged on both sides of the pair of fixed terminals 31, 32 in the rightward/leftward direction. In short, the electric path piece 212a (extension piece) is connected to the electric path piece 211a and is placed to extend downward from a left end portion of the electric path piece 211a. The electric path piece 212a is placed on a straight line connecting the fixed terminal 31 and the fixed terminal 32.

Even in the contact device 1 according to the present variation, the electric path piece 212a allows the current I to flow therethrough in an opposite direction from the current I flowing through the fixed terminal 31. Similarly, the electric path piece 222a allows the current I to flow therethrough in an opposite direction from the current I flowing through the fixed terminal 32.

(5.3) Third Variation

The first embodiment employs the configuration where the two bus bars 21, 22 increase a force applied by the moving contactor 8 to press up the fixed contacts 311, 321. However, the present disclosure may not be limited to this configuration.

In the contact device 1, one bus bar selected from the bus bars 21, 22 may be applied. That is, in the contact device 1, at least one bus bar selected from the bus bars 21, 22 may be applied.

When one bus bar selected from the bus bars 21, 22 is applied, the bus bar may have the shape described above or may have another shape.

In the present variation, a bus bar 22b having a shape different from the shapes of the bus bars 21, 22 is applied.

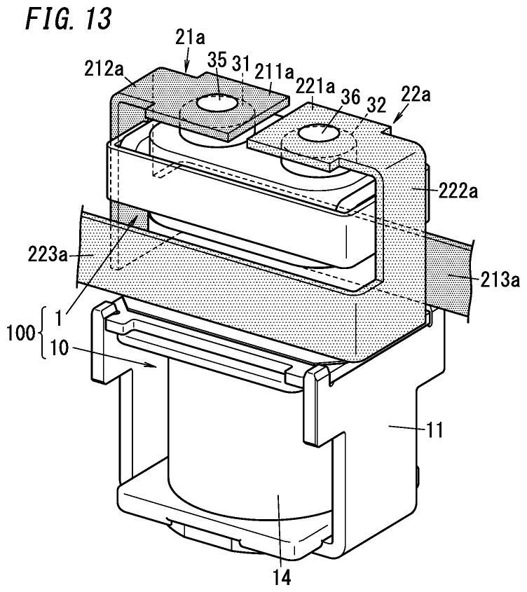

The bus bar 22b, as shown in FIG. 14, includes four electric path pieces 221b, 222b, 223b, 224b. The bus bar 22b is different from the bus bar 22 in the first embodiment mainly in that the bus bar 22b further includes the electric path piece 224b. The electric path piece 222b is the same as the electric path piece 222a of the second variation and therefore description thereof is omitted here. The electric path piece 224b is connected to the electric path piece 222b and is placed in back of the case 4 to extend leftward (in a direction from the fixed terminal 32 to the fixed terminal 31) from a lower end portion of the electric path piece 222b. Further, the thickness direction of the electric path piece 224b (the forward/backward direction) is perpendicular to the moving directions of the moving contactor 8 (the upward/downward direction).

In the present variation, while the moving contactor 8 is positioned in the closed position, the moving contactor 8 is positioned between the electric path piece 224b and the fixed contacts 311, 321 when viewed in one direction along the forward/backward direction. To satisfy this positional relationship, the electric path piece 224b is placed outside the case 4 to be substantially in parallel with the moving contactor 8. An opposite end portion of the electric path piece 224b from the electric path piece 223b is electrically connected to a load, for example, together with the electric path 223b.

In a cross section perpendicular to the rightward/leftward direction of the contact device 1 of the present variation, an angle between a straight line connecting a center point of the electric path piece 224b and a center point of the moving contactor 8 and a straight line along the forward/backward direction is 45 degrees. That is, the electric path piece 224b is placed at a position corresponding to the electric path piece 213 in the first embodiment (see FIG. 4A). This numerical value (45 degrees) is a mere example, and there is no intent to limit the angle to this numerical value.

Further, the length of the electric path piece 224b is equal to or larger than the distance L11 between the moving contact 81 and the moving contact 82 (see FIGS. 7A, 7B).

In other words, the electric path piece 224b includes a first portion overlapping with the fixed contact 311 and a second portion connected to the first portion and overlapping with the fixed contact 321 in the direction perpendicular to the direction in which the fixed contact 311 and the fixed contact 321 are arranged when viewed in one of the moving directions of the moving contactor 8.

Further, in other words, the electric path piece 224b includes the first portion in a position facing the fixed contact 311 in the moving directions of the moving contactor 8 when viewed in one of directions perpendicular to the moving directions of the moving contactor 8 and the direction of the current flowing through the moving contactor 8. Further, the electric path piece 224b includes the second portion in a position facing the fixed contact 321 in the moving directions of the moving contactor 8 when viewed in one of directions perpendicular to the moving directions of the moving contactor 8 and the direction of the current flowing through the moving contactor 8.

Like the electric path piece 223, the electric path piece 223b includes the first portion 261 and the second portion 262.

In the present variation, for example, a current flowing through the moving contactor 8 from the fixed terminal 31 toward the fixed terminal 32 flows into the electric path pieces 223, 224b via the electric path piece 222b and therefore is branched into the electric path pieces 223b, 224b. Therefore, the electric path piece 224b allows the current I to flow therethrough in an opposite direction from the current I flowing through the moving contactor 8, similarly to the electric path piece 223b.

The present variation may be combined with at least one of the first variation and the second variation described above.

(5.4) Fourth Variation

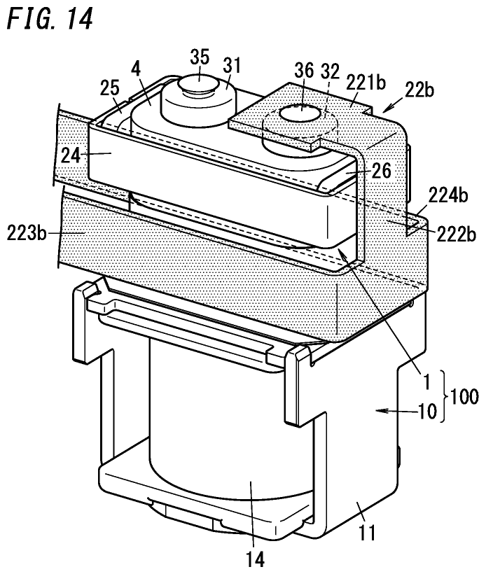

Bus bars 21c, 22c shown in FIG. 15 may be applied to the contact device 1 instead of the bus bars 21, 22 of the first embodiment.

The bus bar 21c of the present variation includes electric path pieces 215, 216 instead of the electric path piece 213 of the first embodiment. The bus bar 22c of the present variation includes electric path pieces 225, 226 instead of the electric path piece 223 of the first embodiment. Opposite end portions of the electric path pieces 215, 216 from the electric path piece 212 are electrically connected to driving batteries, for example. Opposite end portions of the electric path pieces 225, 226 from the electric path piece 222 are electrically connected to loads, for example.

That is, the bus bar 21c according to the present variation includes four electric path pieces 211, 212, 215, 216. The electric path pieces 211, 212 have already been described and therefore descriptions thereof are omitted here. The electric path pieces 215, 216 are connected to the electric path piece 212 and are placed in back of the case 4 to extend rightward (in a direction from the fixed terminal 31 toward the fixed terminal 32) from a lower end portion of the electric path piece 212. The thickness directions of the electric path pieces 215, 216 (the forward/backward direction) are perpendicular to the moving directions of the moving contactor 8 (the upward/downward direction). The electric path pieces 215, 216 allow the moving contactor 8 to be positioned between the electric path pieces 215, 216 and the fixed contacts 311, 321 when viewed in one direction along the forward/backward direction while the moving contactor 8 is positioned in the closed position, similarly to the electric path piece 213 in the first embodiment. To satisfy this positional relationship, the electric path pieces 215, 216 are placed outside the case 4 to be substantially in parallel with the moving contactor 8. Further, the electric path piece 215 is placed between the electric path piece 216 and the fixed contacts 311, 321 in the upward/downward direction.

The bus bar 22c of the present variation includes four electric path pieces 221, 222, 225, 226. The electric path pieces 221, 222 have already been described and therefore descriptions thereof are omitted here. The electric path pieces 225, 226 are connected to the electric path piece 222 and are placed in front of the case 4 to extend leftward (in a direction from the fixed terminal 32 toward the fixed terminal 31) from a lower end portion of the electric path piece 222. The thickness directions of the electric path pieces 225, 226 (the forward/backward direction) are perpendicular to the moving directions of the moving contactor 8 (the upward/downward direction). The electric path pieces 225, 226 allow the moving contactor 8 to be positioned between the electric path pieces 225, 226 and the fixed contacts 311, 321 when viewed in one direction along the forward/backward direction while the moving contactor 8 is positioned in the closed position, similarly to the electric path piece 223 in the first embodiment. To satisfy this positional relationship, the electric path pieces 225, 226 are placed outside the case 4 to be substantially in parallel with the moving contactor 8. Further, the electric path piece 225 is placed between the electric path piece 226 and the fixed contacts 311, 321 in the upward/downward direction.

In a cross section perpendicular to the rightward/leftward direction of the contact device 1 of the present variation, an angle between a straight line connecting a center point of the electric path piece 216 and a center point of the moving contactor 8 and a straight line along the forward/backward direction is 45 degrees. Similarly, in a cross section perpendicular to the rightward/leftward direction of the contact device 1 according to the present variation, an angle between a straight line connecting a center point of the electric path piece 226 and a center point of the moving contactor 8 and a straight line along the forward/backward direction is 45 degrees. That is, the electric path piece 216 is placed at a position corresponding to the electric path piece 213 in the first embodiment (see FIG. 4A). The electric path piece 226 is placed at a position corresponding to the electric path piece 223 in the first embodiment. This numerical value (45 degrees) is a mere example, and there is no intent to limit the angle to this numerical value.

Further, the respective lengths of the electric path pieces 215, 216 and the electric path pieces 225, 226 are equal to or larger than the distance L11 between the moving contact 81 and the moving contact 82 (see FIGS. 7A, 7B).

In other words, each of the electric path pieces 215, 216 includes a first portion overlapping with the fixed contact 311 and a second portion connected to the first portion and overlapping with the fixed contact 321 in a direction perpendicular to a direction in which the fixed contact 311 and the fixed contact 321 are arranged when viewed in one of the moving directions of the moving contactor 8. Similarly, each of the electric path pieces 225, 226 includes a first portion overlapping with the fixed contact 311 and a second portion connected to the first portion and overlapping with the fixed contact 321 in a direction perpendicular to a direction in which the fixed contact 311 and the fixed contact 321 are arranged when viewed in one of the moving directions of the moving contactor 8.

Further, in other words, each of the electric path pieces 215, 216 includes the first portion in a position facing the fixed contact 311 in the moving directions of the moving contactor 8 when viewed in one of directions perpendicular to the moving directions of the moving contactor 8 and the direction of the current flowing through the moving contactor 8. Further, each of the electric path pieces 215, 216 includes the second portion in a position facing the fixed contact 321 in the moving directions of the moving contactor 8 when viewed in one of directions perpendicular to the moving directions of the moving contactor 8 and the direction of the current flowing through the moving contactor 8. Each of the electric path pieces 225, 226 includes the first portion in a position facing the fixed contact 311 in the moving directions of the moving contactor 8 when viewed in one of directions perpendicular to the moving directions of the moving contactor 8 and the direction of the current flowing through the moving contactor 8. Further, each of the electric path pieces 225, 226 includes the second portion in a position facing the fixed contact 321 in the moving directions of the moving contactor 8 when viewed in one of directions perpendicular to the moving directions of the moving contactor 8 and the direction of the current flowing through the moving contactor 8.

Therefore, the electric path pieces 215, 216, 225, 226 of the present variation each allow the current I to flow therethrough in an opposite direction from the current I flowing through the moving contactor 8.

The present variation may be combined with at least one variation selected from the above-mentioned first to third variations.

(5.5) Fifth Variation

The first embodiment includes the configuration where the first yoke 6 is secured to the tip (upper end) of the shaft 15, that is the configuration where the first yoke 6 is movable in directions same as the moving directions of the moving contactor 8, but may not be limited to such configurations.

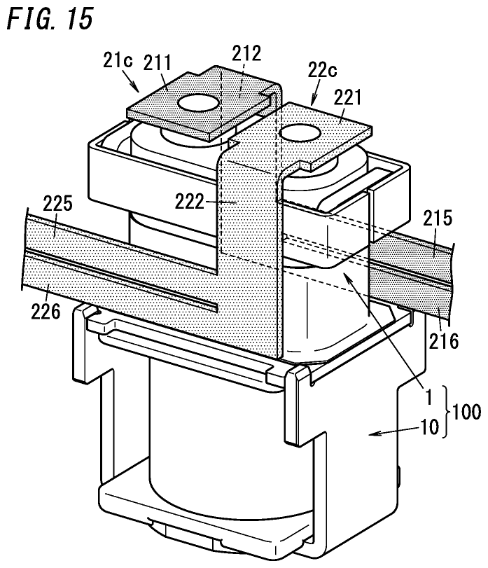

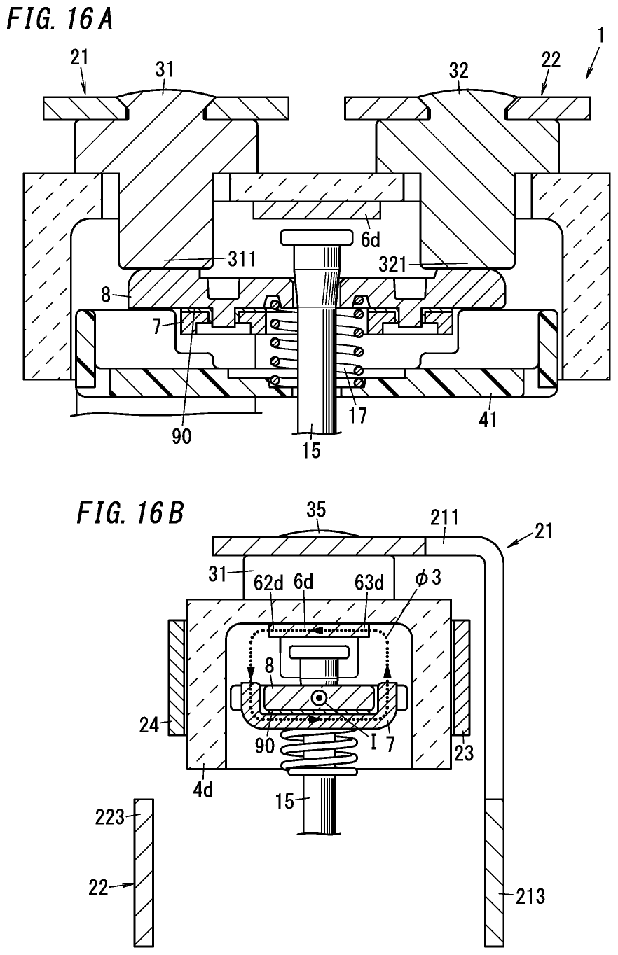

The first yoke 6 is provided to be in a position fixed relative to the case 4. For example, the contact device 1 may include a first yoke 6d shown in FIGS. 16A, 16B instead of the first yoke 6.

The first yoke 6d is fixed to part of an inner peripheral surface of the case 4. Here, the first yoke 6d is fixed to a position which is above the moving contactor 8 and faces the moving contactor 8. As shown in FIG. 16B, when the current I flows through the moving contactor 8 rightward (in a direction from the fixed terminal 31 toward the fixed terminal 32), a magnetic flux φ3 which is counter-clockwise around the moving contactor 8 when viewed from the right is produced (see FIG. 16B). Similarly to a situation where the first yoke 6 and the second yoke 7 attract each other in the first embodiment, the first yoke 6d and the second yoke 7 attract each other due to production of the magnetic flux φ3.

Alternatively, the first yoke 6d may be fixed to an outer peripheral surface of the case 4. Alternatively, the first yoke 6d may be fixed to the fixed terminals 31, 32 inside the case 4.

The present variation may be combined with at least one variation selected from the above-mentioned first to fourth variations.

(5.6) Sixth Variation

The contact device 1 according to the first embodiment includes the configuration where the capsule yoke 23 (magnet yoke) is positioned between the case 4 and the electric path piece 212 of the bus bar 21 and the capsule yoke 24 (magnet yoke) is positioned between the case 4 and the electric path piece 222 of the bus bar 22, but may not be limited to including this configuration.

As shown in FIG. 17, in the contact device 1 according to the present variation, the electric path piece 212 of the bus bar 21 is positioned between the capsule yoke 23 and the case 4 when viewed from above (when viewed in one of the moving directions of the moving contactor 8). Similarly, when viewed from above, the electric path piece 222 of the bus bar 22 is positioned between the capsule yoke 24 and the case 4. Further, the electric path piece 213 is also positioned between the capsule yoke 23 and the case 4 when viewed from above. The electric path piece 223 is also positioned between the capsule yoke 23 and the case 4 when viewed from above.

The configuration of the present variation can make the electric path pieces 213, 223 close to the moving contactor 8 compared with a case where the electric path piece 212 is positioned outside the capsule yoke 23 and the electric path piece 222 is positioned outside the capsule yoke 24, and therefore the configuration can produce a larger repulsive force. Therefore, according to the contact device 1 according to the sixth variation shown in FIG. 17, a force pushing up the moving contactor 8, that is, a force pressing the moving contacts 81, 82 against the fixed contacts 311, 321 can be increased.

(5.7) Seventh Variation

The contact device 1 according to the first embodiment is described as configuration components thereof include the two bus bars 21, 22. However, the bus bars 21, 22 are not necessarily included in the configuration components of the contact device 1. In the present embodiment, the two bus bars 21, 22 may not be included in the configuration components of the contact device 1.

In the contact device 1 according to the first embodiment, the fixed contacts 311, 321 and the moving contacts 81, 82 are associated with each other respectively. However, this configuration is optional. A plurality of moving contacts may be associated with a single fixed contact. That is, a configuration where a single fixed contact is allowed to be in contact with a plurality of moving contacts may apply.

### Second Embodiment

The contact device 1e according to the present embodiment differs from the first embodiment in that additional electric path pieces are provided above the electric path pieces 213, 223. Hereinafter, a description will be given focusing on differences from the first embodiment. The same components as the first embodiment are denoted by the same reference signs, and descriptions thereof are omitted as appropriate.

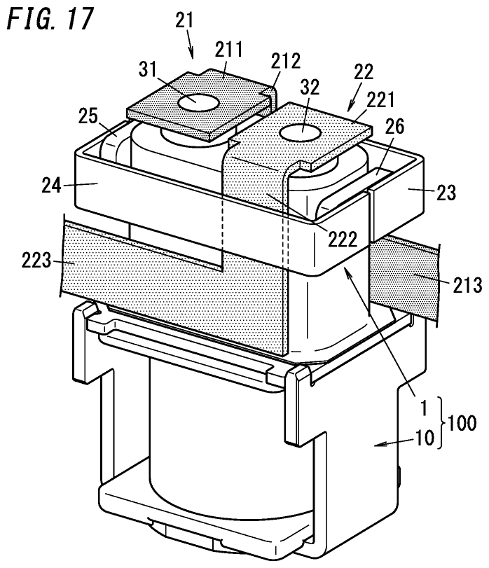

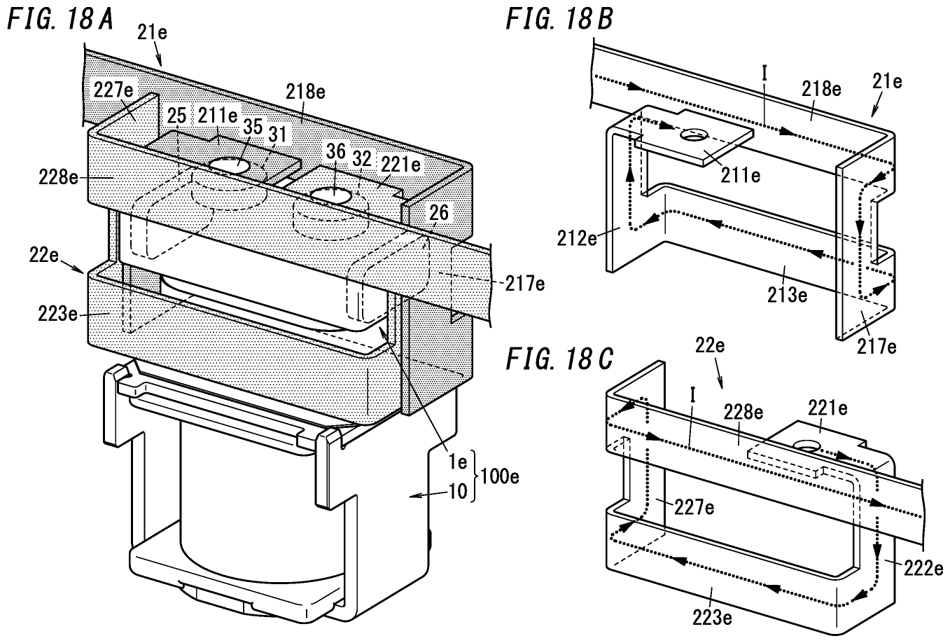

In the contact device 1e according to the present embodiment, two bus bars 21e, 22e are applied (see FIG. 18A). An electromagnetic relay 100e of the present embodiment includes a contact device 1e, and the electromagnet device 10 described in the first embodiment.

The bus bar 21e of the present embodiment includes five electric path pieces 211e, 212e, 213e, 217e, and 218e (see FIG. 18B). The bus bar 21e is different from the bus bar 21 of the first embodiment in further including electric path pieces 217e, 218e. The electric path piece 217e (interconnection piece) is connected to the electric path piece 213e and is placed on a straight line connecting the fixed terminal 31 and the fixed terminal 32 to extend upward from a right end portion of the electric path piece 213e. In other words, the electric path piece 217e is placed outside the case 4 and placed on one side (here, the right side) of the case 4 in a direction in which the fixed contact 311 and the fixed contact 321 are arranged. The electric path piece 218e is connected to the electric path piece 217e and is placed in back of the case 4 to extend leftward from an upper end portion of the electric path piece 217e. Further, the respective thickness directions of the electric path pieces 217e, 218e are perpendicular to the moving directions of the moving contactor 8 (the upward/downward direction) (see FIG. 18A).

The bus bar 22e of the present embodiment includes five electric path pieces 221e, 222e, 223e, 227e, 228e (see FIG. 18C). The bus bar 22e is different from the bus bar 22 of the first embodiment in further including electric path pieces 227e, 228e. The electric path piece 227e (interconnection piece) is connected to the electric path piece 223e and is placed on a straight line connecting the fixed terminal 31 and the fixed terminal 32 to extend upward from a left end portion of the electric path piece 223e. In other words, the electric path piece 227e is placed outside the case 4 and placed on one side (here, the left side) of the case 4 in a direction in which the fixed contact 311 and the fixed contact 321 are arranged. The electric path piece 228e is connected to the electric path piece 227e and is placed in back of the case 4 to extend rightward from an upper end portion of the electric path piece 227e. Further, the respective thickness directions of the electric path pieces 227e, 228e are perpendicular to the moving directions of the moving contactor 8 (the upward/downward direction) (see FIG. 18A).

The electric path pieces 218e, 228e are positioned in a same side as the fixed contacts 311, 321 relative to the moving contactor 8 in one direction along the forward/backward direction while the moving contactor 8 is in the closed position. In other words, the electric path pieces 218e, 228e are positioned in a same side as the fixed contacts 311, 321 relative to the moving contactor 8 in the moving directions (the upward/downward direction). To satisfy this positional relationship, the electric path pieces 218e, 228e are placed outside the case 4 to be substantially in parallel with the moving contactor 8.

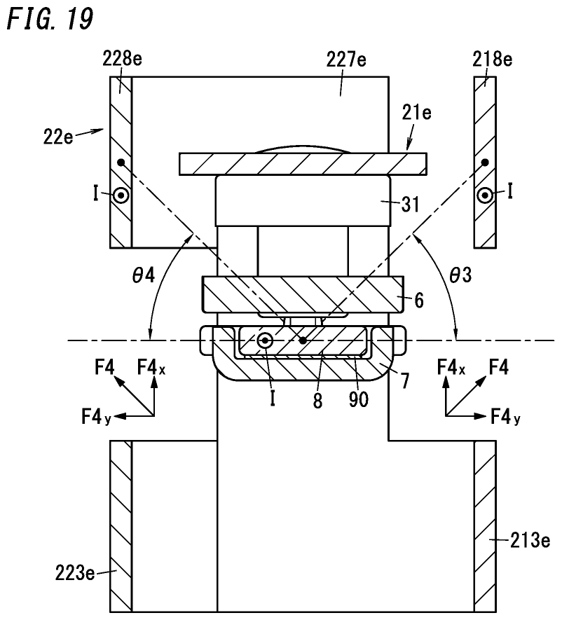

In the present embodiment, as shown in FIG. 19, in a cross section perpendicular to the rightward/leftward direction, an angle θ3 between a straight line connecting a center point of the electric path piece 218e and a center point of the moving contactor 8 and a straight line along the forward/backward direction is 45 degrees. Similarly, in a cross section perpendicular to the rightward/leftward direction, an angle θ4 between a straight line connecting a center point of the electric path piece 228e and the center point of the moving contactor 8 and a straight line along the forward/backward direction is equal to the angle θ3 (45 degrees here). The above numerical value (45 degrees) is a mere example, and there is no intent to limit the scope to this numerical value.

Furthermore, the length of the electric path piece 218e and the length of the electric path piece 228e are equal to or larger than the distance L11 between the moving contact 81 and the moving contact 82 (see FIGS. 7A, 7B).

In other words, the electric path piece 218e includes a first portion overlapping with the fixed contact 311 and a second portion connected to the first portion and overlapping with the fixed contact 321 in the direction perpendicular to the direction in which the fixed contact 311 and the fixed contact 321 are arranged when viewed in one of the moving directions of the moving contactor 8. Similarly, the electric path piece 228e includes a first portion overlapping with the fixed contact 311 and a second portion connected to the first portion and overlapping with the fixed contact 321 in the direction perpendicular to the direction in which the fixed contact 311 and the fixed contact 321 are arranged when viewed in one of the moving directions of the moving contactor 8.

Further, in other words, the electric path piece 218e includes the first portion in a position facing the fixed contact 311 in the moving directions of the moving contactor 8 when viewed in one of directions perpendicular to the moving directions of the moving contactor 8 and the direction of the current flowing through the moving contactor 8. Further, the electric path piece 218e includes the second portion in a position facing the fixed contact 321 in the moving directions of the moving contactor 8 when viewed in one of directions perpendicular to the moving directions of the moving contactor 8 and the direction of the current flowing through the moving contactor 8. The electric path piece 228e includes the first portion in a position facing the fixed contact 311 in the moving directions of the moving contactor 8 when viewed in one of directions perpendicular to the moving directions of the moving contactor 8 and the direction of the current flowing through the moving contactor 8. Further, the electric path piece 228e includes the second portion in a position facing the fixed contact 321 in the moving directions of the moving contactor 8 when viewed in one of directions perpendicular to the moving directions of the moving contactor 8 and the direction of the current flowing through the moving contactor 8.

Like the electric path piece 213, the electric path piece 213e includes the first portion 251 and the second portion 252. Like the electric path piece 223, the electric path piece 223e includes the first portion 261 and the second portion 262.

In the present embodiment, the electric path piece 218e extends (protrudes) leftward from the electric path piece 217e2 and the electric path piece 228e extends (protrudes) rightward from the electric path piece 227e. Here, similarly to the first embodiment, it is assumed that the current I flows through the moving contactor 8 from the fixed terminal 31 toward the fixed terminal 32. In this case, the current I flows through the electric path piece 218e, the electric path piece 217e, the electric path piece 213e, the electric path piece 212e, the electric path piece 211e, the fixed terminal 31, the moving contactor 8, the fixed terminal 32, the electric path piece 221e, the electric path piece 222e, the electric path piece 223e, the electric path piece 227e and the electric path piece 228e in this order (see FIGS. 18A to 18C). As to the electric path pieces 218e, 228e, the current I flows rightward (in a direction from the fixed terminal 31 to the fixed terminal 32). On the other hand, as to the moving contactor 8, the current I flows rightward. In contrast, while the current I flows through the moving contactor 8 from the fixed terminal 32 toward the fixed terminal 31, the current I flows through the electric path pieces 218e, 228e leftward and through the moving contactor 8 leftward, too.

In other words, the electric path pieces 218e, 228e extend (protrude) from the electric path pieces 217e, 227e in opposite directions, and therefore the currents I flow through the electric path pieces 218e, 228e in the same direction as the current I flowing through the moving contactor 8. Therefore, the electric path pieces 218e, 228e each serve as a forward electric path piece positioned in a same side as the fixed contacts 31, 32 relative to the moving contactor 8 in the moving directions of the moving contactor 8 while the moving contactor 8 is in the closed position, to allow the current I to flow therethrough in a same direction as the current I flowing through the moving contactor 8.

In the present embodiment, the electric path piece 218e serving as one forward electric path piece is positioned in back of the case 4 and the electric path piece 228e serving as another forward electric path piece is positioned in front of the case 4. That is, the bus bars 21e, 22e serving as electrically conductive members include a pair of forward electric path pieces (electric path pieces 218e, 228e) and the moving contactor 8 is positioned between the pair of forward electric path pieces (electric path pieces 218e, 228e) when viewed in one of the moving directions of the moving contactor 8.

In the present embodiment, the bus bars 21e, 22e include the electric path pieces 213e, 228e corresponding to the electric path pieces 213, 223 of the first embodiment, respectively. Therefore, repulsive forces F1 developed between the electric path piece 213e and the moving contactor 8 and between the electric path piece 223e and the moving contactor 8 (see FIG. 4A) cause increase in a force pushing up the fixed contacts 311, 321 by the moving contactor 8.

Further in the present embodiment, the bus bars 21e, 22e include the electric path pieces 212e, 222e corresponding to the electric path pieces 212, 222 of the first embodiment, respectively. Therefore, it is possible to reduce a force moving the moving contactor 8 downward.

Furthermore, in the contact device 1e according to the present embodiment, the bus bars 21e, 22e include the electric path pieces 218e, 228e allowing the current I to flow therethrough in the same direction as the current I flowing through the moving contactor 8. Therefore, for example, while an abnormal current such as a short-circuit current flows through the contact device 1e, attractive forces F4 may be developed between the electric path piece 218e and the moving contactor 8, and between the electric path piece 228e and the moving contactor 8 (see FIG. 19). The “attractive force F4” referred to in the present disclosure is a force which is one of interactive forces between the moving contactor 8 and the electric path pieces 218e, 228e and makes the moving contactor 8 and the electric path pieces 213, 223 attract each other. The attractive force F4 is a force received by the current I flowing through the moving contactor 8 and the electric path pieces 218e, 228e by a Lorentz force. In FIG. 19, to avoid an overlap between a center point of a cross section of the moving contactor 8 and an indication of the current I, the indication of the current I is put in a position displaced from the center point of the cross section of the moving contactor 8. However, there is no intent to specify an actual position where the current I flows, by the indication. The same applies to the indications of the current I flowing through the electric path pieces 218e, 228e.

In the present embodiment, while the moving contactor 8 is in the closed position, the moving contactor 8 is positioned below the electric path pieces 218e, 228e in the moving directions of the moving contactor 8 (the upward/downward direction) (see FIG. 19). The electric path pieces 218e, 228e are fixed to the fixed terminals 31, 32 and therefore do not move relative to the case 4. On the other hand, the moving contactor 8 is movable in the upward/downward direction relative to the case 4. Therefore, the attractive force F4 includes a force component F4x in the upward/rearward direction and a force component F4y in the forward/rearward direction, and the force component F4x acts on the moving contactor 8 (see FIG. 19). As a result, a force moving the moving contactor 8 upward, that is, a force pressing the moving contacts 81, 82 against the fixed contacts 311, 321 is increased. In other words, while the moving contactor 8 is in the closed position, a magnetic field caused by the current I flowing through the electrically conductive member placed outside the case 4 causes a force on the moving contactor 8 in the moving directions of the moving contactor 8 to keep the moving contactor 8 in the closed position. Here, the force component F4x in the upward/downward direction of the attractive force F4 corresponds to the force keeping the moving contactor 8 in the closed position.

Therefore, even when an abnormal current such as a short-circuit current flows through the contact device 1e, it is possible to stabilize the connection state between the moving contacts 81, 82 and the fixed contacts 311, 321.

Further, in the present embodiment, the thickness directions of the electric path pieces 213e, 223e, 218e, 228e (the forward/backward direction) are perpendicular to the moving directions of the moving contactor 8 (the upward/downward direction). Thus, in a cross section perpendicular to the longitudinal directions of the electric path pieces 213e, 223e, 218e, 228e, it is possible to relatively shorten a distance between the center point of the electric path piece 213e (or 223e, 218e, 228e) and the center point of the moving contactor 8. Therefore, the contact device 1e according to the present embodiment can generate a larger repulsive force F1 (see FIG. 4A) and a larger attractive force F4 between the electric path pieces 213e, 223e, 218e, 228e and the moving contactor 8.

As a result, it is possible to further stabilize the connection state between the moving contacts 81, 82 and the fixed contacts 311, 321 when an abnormal current such as a short-circuit current flows through the contact device 1e.

Hereinafter, variations of the second embodiment will be described. Each of the variations described below may be appropriately combined with the first embodiment and the first to fifth variations of the first embodiment.

In the second embodiment, the contact device 1e includes the configuration including the electric path pieces 213e, 223e allowing the current I to flow therethrough in an opposite direction from the current I flowing through the moving contactor 8 and the electric path pieces 218e, 228e allowing the current I to flow therethrough in the same direction as the current I flowing through the moving contactor 8. However, the contact device 1e may not include this configuration. The contact device 1e may include a configuration including the electric path pieces 218e, 228e but not including the electric path pieces 213e, 223e. In this case, not the repulsive force F1 but the attractive force F4 is developed between the bus bars 21e, 22e and the moving contactor 8. That is, the bus bars 21e, 22e serving as electrically conductive members may include at least one of the electric path pieces 213e, 223e serving as the reverse electric path pieces and the electric path pieces 218e, 228e serving as the forward electric path pieces including the both may be optional.

In the second embodiment, the electric circuit piece 218e is provided to the bus bar 21e which is mechanically connected to the fixed terminal 31 and the electric circuit piece 228e is provided to the bus bar 22e which is mechanically connected to the fixed terminal 32. However, the second embodiment is not limited to this configuration. The electric path pieces 218e, 228e may be provided to a bus bar which is mechanically connected to a device other than the contact device 1, for example.

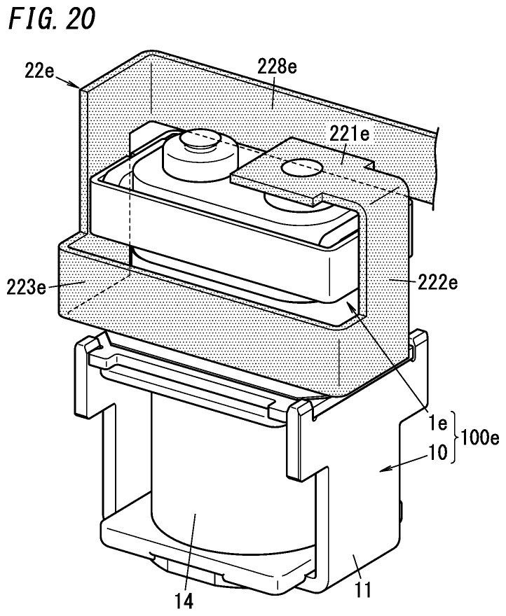

In the contact device 1e, one bus bar selected from the bus bars 21e, 22e may be applied. That is, in the contact device 1e, at least one bus bar selecting from the bus bars 21e, 22e may be applied. When one bus bar selected from the bus bars 21e, 22e is applied, the bus bar may have the shape described above or may have another shape. For example, as shown in FIG. 20, the bus bar 22e may have a shape wound along the outer peripheral surface of the contact device 1e to surround the contact device 1e when viewed in one of the moving directions of the moving contactor 8 (the upward/downward direction). In the example of FIG. 20, the moving contactor 8 is positioned between the electric path piece 223e and the electric path piece 228e when viewed in one of the moving directions of the moving contactor 8 (the upward/downward direction).

In other words, the bus bar 22e serving as one electrically conductive member includes both the electric path piece 228e serving as one reverse electric path piece and the electric path piece serving as one forward electric path piece. Then, the moving contactor 8 is positioned between the reverse electric path piece (electric path piece 223e) and the forward electric path piece (electric path piece 228e) when viewed in one of the moving directions of the moving contactor 8. In this case, an attractive force is produced between the electric path piece 228e and the moving contactor 8 and therefore it is possible to stabilize the connection state between the moving contacts 81, 82 and the fixed contacts 311, 321 when an abnormal current flows through the contact device 1e.

### Third Embodiment

The present embodiment differs from the first embodiment in that the contact device does not include both the first yoke 6 and the second yoke 7 of the first embodiment but includes a yoke corresponding to the first yoke 6. Hereinafter, a description will be given focusing on differences from the first embodiment. The same components as the first embodiment are denoted by the same reference signs, and descriptions thereof are omitted as appropriate.

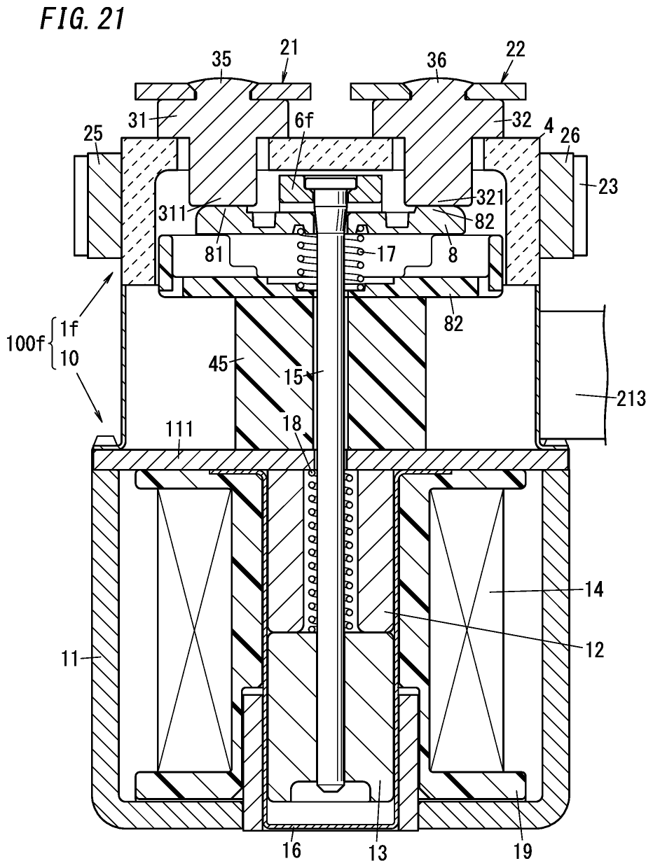

The contact device if according to the present embodiment includes a yoke 6f corresponding to the first yoke 6 in the first embodiment (see FIG. 21). That is, in this contact device 1f, the second yoke 7 of the first embodiment are omitted. An electromagnetic relay 100f according to the present embodiment includes the contact device if and the electromagnet device 10 described in the first embodiment.

The yoke 6f is made of a ferromagnetic material, for example, a metal material such as iron. The yoke 6f is secured to the tip (upper end) of the shaft 15 and thus is positioned above the moving contactor 8 (see FIG. 21).

When the moving contactor 8 is currently located at the closed position, a predetermined gap is left between the moving contactor 8 and the yoke 6f. This ensures electrical insulation between the moving contactor 8 and the yoke 6f.

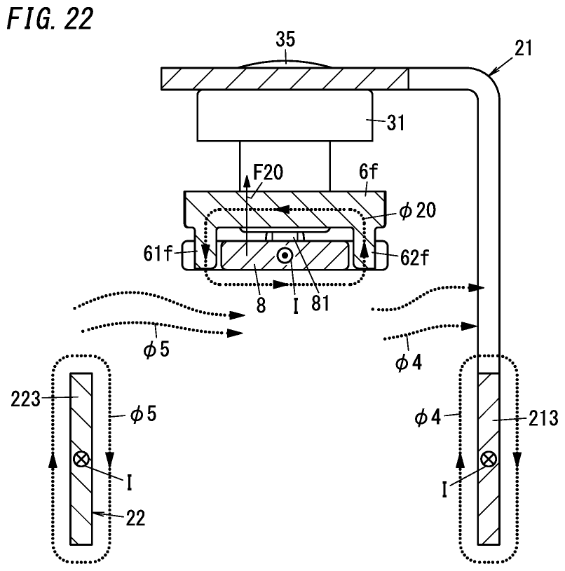

The yoke 6f has, at both ends in the forward/backward direction, a pair of protrusions 61f, 62f protruding downward (see FIG. 22). In other words, at both ends in the forward/backward direction of the lower surface of the yoke 6f, provided are the protrusions 61f, 62f protruding in the direction in which the moving contactor 8 moves from the closed position toward the open position (i.e., the downward direction in this embodiment).

When the current I flows through the moving contactor 8 rightward (in a direction from the fixed terminal 31 toward the fixed terminal 32), a magnetic flux φ20 which is counter-clockwise around the moving contactor 8 when viewed from the right is produced (see FIG. 22). At this time, the protrusion 61f of the yoke 6f turns into N pole and the protrusion 62f of the yoke 6f turns into S pole and the magnetic flux φ20 passes through the moving contactor 8 rightward (in a direction from the protrusion 61f toward the protrusion 620. Based on a relation between the current I flowing rightward through the moving contactor 8 and the magnetic flux φ20 passing through the moving contactor 8, an upward Lorentz force F20 acts on the moving contactor 8.

Furthermore, part of the magnetic flux φ4 caused by the current I flowing through the electric path piece 213, and part of the magnetic flux φ5 caused by the current I flowing through the electric path piece 223 constitute a magnetic flux passing through the yoke 6f rightward. Therefore, the magnetic flux passing through the moving contactor 8 rightward is increased and therefore the upward Lorentz force F20 acting on the moving contactor 8 is increased. Therefore, it is possible to stabilize the connection state between the moving contacts 81, 82 and the fixed contacts 311, 321 when an abnormal current flows.

In the present embodiment, the yoke 6f includes the protrusions 61f, 62f, but the yoke 6f is not necessarily required to include the protrusions 61f, 62f. The yoke 6f may have the same shape as the first yoke 6 described in the first embodiment. That is to say, at least part of the yoke 6f is located on the same side as the fixed contacts 311, 321 with respect to the moving contactor 8 in the direction in which the moving contactor 8 moves.

### Fourth Embodiment

The present embodiment is different from the first embodiment in arrangement of the pair of arc extinction magnets. Hereinafter, a description will be given focusing on differences from the first embodiment. The same components as the first embodiment are denoted by the same reference signs, and descriptions thereof are omitted as appropriate.

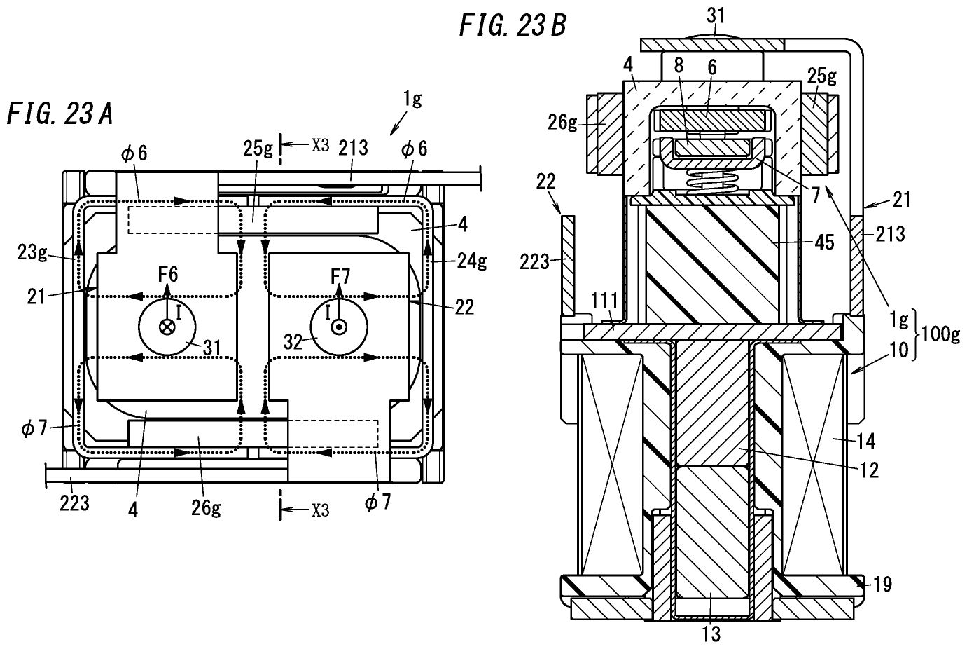

The contact device 1g according to the present embodiment includes two capsule yokes 23g, 24g and two arc extinction magnets 25g, 26g instead of the two capsule yokes 23, 24 and the two arc extinction magnets 25, 26 described in the first embodiment (see FIGS. 23A, 23B). An electromagnetic relay 100g according to the present embodiment includes the contact device 1g and the electromagnet device 10 described in the first embodiment.

The capsule yokes 23g, 24g are arranged on both sides in the rightward/leftward direction of the case 4 to surround the case 4 from both sides in the right/left direction (see FIG. 23A).

The arc extinction magnets 25g, 26g are arranged so that the same poles (e.g., N poles) thereof face each other in the forward/backward direction. The arc extinction magnets 25g, 26g are arranged on both sides in the forward/backward direction of the case 4. The capsule yokes 23g, 24g surround the case 4 together with the arc extinction magnets 25g, 26g. The arc extinction magnets 25g, 26g are placed to make directions from the arc extinction magnets 25g, 26g to the fixed contacts 311, 321 different from the direction of the current flowing through the moving contactor 8 when viewed in one of the moving directions of the moving contactor 8.

According to the configuration described above, as shown in FIG. 23A, the capsule yoke 23g forms part of the magnetic circuit allowing the magnetic flux φ6 generated by the arc extinction magnet 25g to pass therethrough, and part of the magnetic circuit allowing the magnetic flux φ7 generated by the arc extinction magnet 26g to pass therethrough. Similarly, the capsule yoke 24g forms part of the magnetic circuit allowing the magnetic flux φ6 generated by the arc extinction magnet 25g to pass therethrough, and part of the magnetic circuit allowing the magnetic flux φ7 generated by the arc extinction magnet 26g to pass therethrough. These magnetic fluxes φ6, φ7 act on points of the pair of fixed contacts 311, 321 in contact with the pair of the moving contacts 81, 82 while the moving contactor 8 is in the closed position.

In the example of FIG. 23A, the magnetic fluxes φ6, φ7 pass through the fixed terminal 31 leftward and the magnetic fluxes φ6, φ7 pass through the fixed terminal 32 rightward. Thus, the current I flows through the fixed terminal 31 downward and the current I flows through the fixed terminal 32 upward. When the moving contactor 8 moves from the closed position toward the open position in such a state, an electric discharge current (arc) is generated downward from the fixed contact 311 toward the moving contact 81 between the fixed contact 311 and the moving contact 81. Therefore, a backward Lorentz force F6 acts on the arc by the magnetic fluxes φ6, φ7 (see FIG. 23A). As a result, the arc generated between the fixed contact 311 and the moving contact 81 is stretched backward to be extinct. On the other hand, an electric discharge current (arc) is generated upward from the moving contact 82 toward the fixed contact 321 between the fixed contact 321 and the moving contact 82. Therefore, a backward Lorentz force F7 acts on the arc by the magnetic fluxes φ 6, φ 7 (see FIG. 23A). As a result, the arc generated between the fixed contact 321 and the moving contact 82 is stretched backward to be extinct.

Hereinafter, variations of the fourth embodiment will be described. Each of the variations described below may be appropriately combined with other embodiments and other variations.

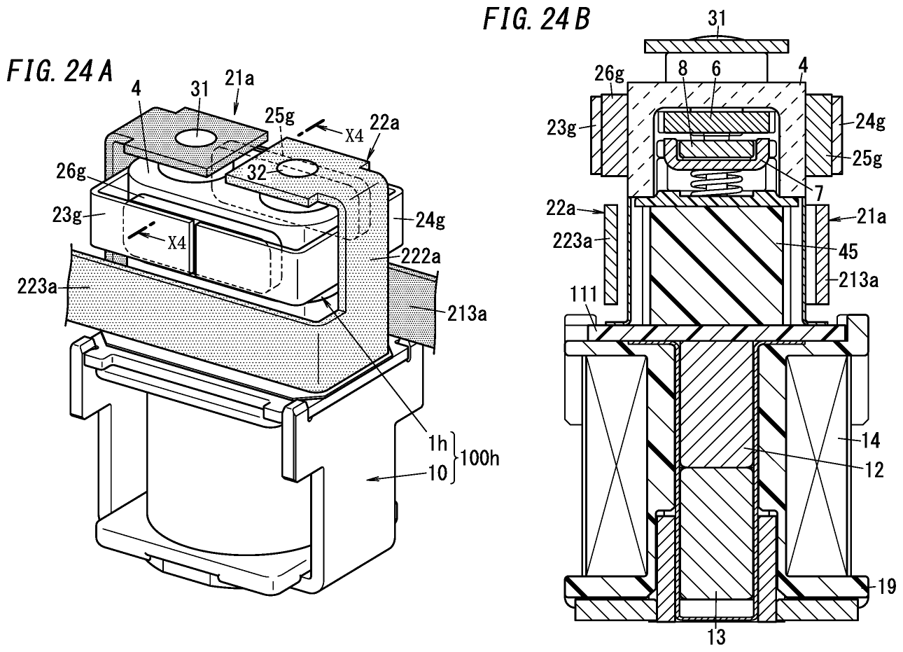

First, as shown in FIGS. 24A, 24B, a contact device 1h according to a first variation of the fourth embodiment differs from the contact device 1g according to the fourth embodiment in the configuration of the bus bars 21a and 22a. In this contact device 1h, the bus bars 21a, 22a described in the first variation of the first embodiment are applied. In this case, the electric path pieces 212a, 222a are located on both sides in the rightward/leftward direction of the case 4 (see FIG. 24A). Therefore, as shown in FIG. 24B, a distance between the electric path piece 213a connected to the electric path piece 212a and the electric path piece 223a connected to the electric path piece 222a can be made shorter than a distance between the electric path piece 213 and the electric path piece 223 of the contact device 1g (FIG. 23B). Thus, it is possible to increase the repulsive forces between the electric path piece 213a, 223a and the moving contactor 8. Therefore, it is possible to increase the force of pushing up the moving contactor 8 upward relative to the contact device 1g.

In addition, not only the bus bars 21a, 22a described in the second variation of the first embodiment but also bus bars with various configurations such as the bus bars of the second variation or the third variation of the first embodiment, for example, can be applied to the contact device 1g according to the fourth embodiment.

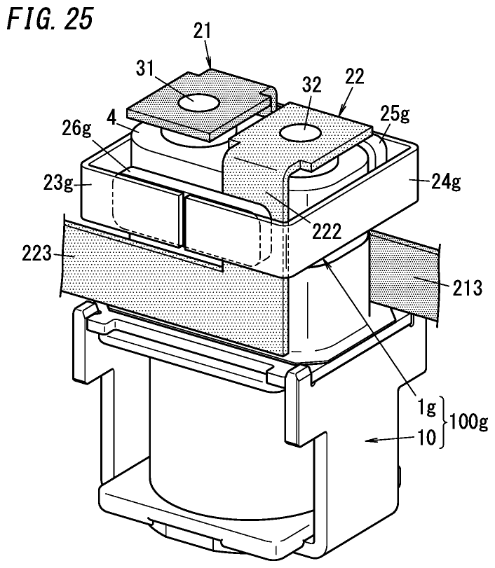

Next, a second variation of the fourth embodiment will be described. In a contact device 1g according to the second variation, the electric path piece 212 of the bus bar 21 is positioned between the arc extinction magnet 25g and the case 4 and the electric path piece 222 of the bus bar 22 is positioned between the arc extinction magnet 26g and the case 4 (see FIG. 25). In this case, as shown in FIG. 25, the electric path piece 213 is located between the arc extinction magnet 25g and the moving contactor 8 when viewed in one of the moving directions of the moving contactor 8. Similarly, as shown in FIG. 25, the electric path piece 223 is located between the arc extinction magnet 26g and the moving contactor 8 when viewed in one of the moving directions of the moving contactor 8. In the second variation, the arc extinction magnets 25g, 26g are not coupled to the case 4 but the capsule yokes 23g, 24g are coupled to the case 4. Specifically, one surface (left end surface) of the case 4 in the rightward/leftward direction is coupled to the capsule yoke 23g and the other surface (right end surface) of the case 4 in the rightward/leftward direction is coupled to the capsule yoke 24g. According to the second variation, it is possible to make the electric path pieces 213, 223 close to the moving contactor 8 and therefore it is possible to generate larger repulsive forces between the electric path pieces 213, 223 and the moving contactor 8. Therefore, according to the contact device 1g according to the second variation, a force pushing up the moving contactor 8 can be increased.

### Fifth Embodiment

A contact device 1i according to the present embodiment is different from the first embodiment in the shapes of the two bus bars. Hereinafter, a description will be given focusing on differences from the first embodiment. The same components as the first embodiment are denoted by the same reference signs, and descriptions thereof are omitted as appropriate.

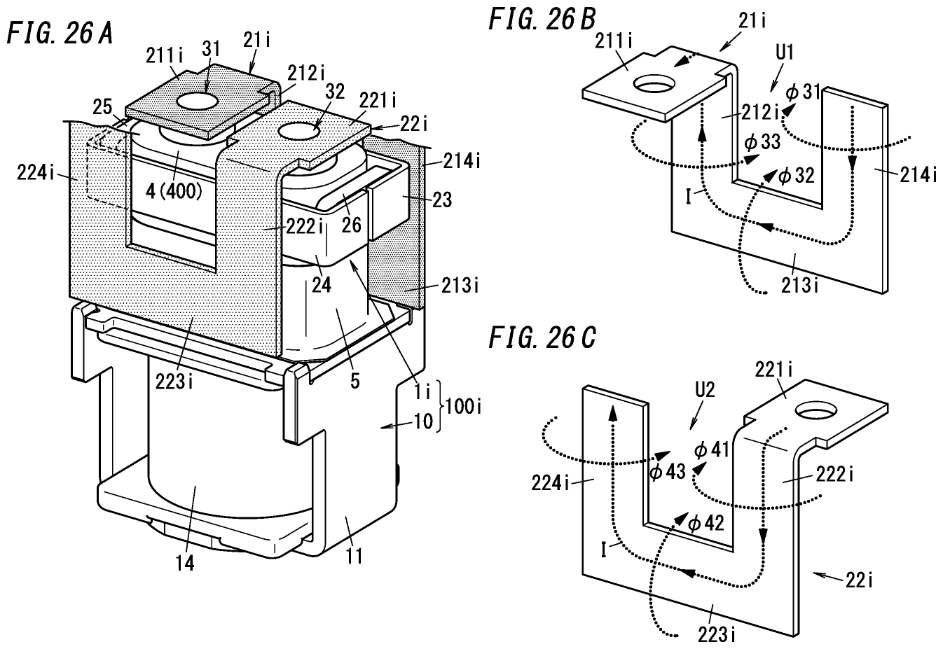

In the contact device 1i according to the present embodiment, two bus bars 21i, 22i are applied (see FIG. 26A). An electromagnetic relay 100i of the present embodiment includes the contact device 1i and the electromagnet device 10 described in the first embodiment.

The bus bar 21i of the present embodiment includes four electric path pieces 211i, 212i, 213i, 214i (see FIGS. 26A and 26B). The electric path piece 211i is mechanically connected to the fixed terminal 31. Specifically, the electric path piece 211 is swaged to the fixed terminal 31. The electric path piece 212i (first extension piece) is connected to the electric path piece 211i and is placed in back of the case 4 to extend downward from a rear end portion of the electric path piece 211i. In other words, the electric path piece 212i is placed in back of the case 4 to extend along the moving directions of the moving contactor 8. The electric path piece 213i is connected to the electric path piece 212i and is placed in back of the case 4 to extend rightward (in a direction from the fixed terminal 31 toward the fixed terminal 32) from a lower end portion of the electric path piece 212i. The electric path piece 214i (second extension piece) is connected to the electric path piece 213i and is placed in back of the case 4 to extend upward from a right end portion of the electric path piece 213i. In other words, the electric path pieces 212i, 214i are positioned on a same side as the electric path piece 213i relative to the moving contactor 8 when viewed in one of the moving directions of the moving contactor 8. Furthermore, the electric path piece 214i is placed to overlap with the fixed terminal 32 when viewed in one direction along the forward/backward direction.

Similarly to the electric path piece 213 of the first embodiment, the electric path piece 213i is placed between the yoke upper plate 111 of the yoke 11 and the moving contactor 8 in the closed position. Therefore, the electric path piece 212i overlaps with the left end portion of the moving contactor 8 when viewed in one direction along the forward/backward direction. Similarly, the electric path piece 214i overlaps with the right end portion of the moving contactor 8 when viewed in one direction along the forward/backward direction. Essentially, the electric path pieces 212i, 214i extend along the moving directions of the moving contactor 8 to intersect part of the moving contactor 8. Further, the direction of the current flowing through the electric path piece 212i and the direction of the current flowing through the electric path piece 214i are opposite directions. Furthermore, the direction of the current flowing through the electric path piece 212i and the direction of the current flowing through the fixed terminal 31 are opposite directions. Also, the direction of the current flowing through the electric path piece 214i and the direction of the current flowing through the fixed terminal 32 are opposite directions.

The bus bar 22i of the present embodiment includes four electric path pieces 221i, 222i, 223i, 224i (see FIGS. 26A and 26C). The electric path piece 221i is mechanically connected to the fixed terminal 32. Specifically, the electric path piece 221 is swaged to the fixed terminal 32. The electric path piece 222i (first extension piece) is connected to the electric path piece 221i and is placed in front of the case 4 to extend downward from a rear end portion of the electric path piece 221i. In other words, the electric path piece 222i is placed in front of the case 4 to extend along the moving directions of the moving contactor 8. The electric path piece 223i is connected to the electric path piece 222i and is placed in front of the case 4 to extend leftward (in a direction from the fixed terminal 32 toward the fixed terminal 31) from a lower end portion of the electric path piece 222i. The electric path piece 224i (second extension piece) is connected to the electric path piece 223i and is placed in front of the case 4 to extend upward from a left end portion of the electric path piece 223i. In other words, the electric path pieces 222i, 224i are positioned on a same side as the electric path piece 223i relative to the moving contactor 8 when viewed in one of the moving directions of the moving contactor 8. Furthermore, the electric circuit piece 224i is placed to overlap with the fixed terminal 31 when viewed in one direction along the forward/backward direction.

Similarly to the electric path piece 223 of the first embodiment, the electric path piece 223i is placed between the yoke upper plate 111 of the yoke 11 and the moving contactor 8 in the closed position. Therefore, the electric path piece 222i overlaps with the right end portion of the moving contactor 8 when viewed in one direction along the forward/backward direction. Similarly, the electric path piece 224i overlaps with the left end portion of the moving contactor 8 when viewed in one direction along the forward/backward direction. Essentially, the electric path pieces 222i, 224i extend along the moving directions of the moving contactor 8 to intersect part of the moving contactor 8. Further, the direction of the current flowing through the electric path piece 222i and the direction of the current flowing through the electric path piece 224i are opposite directions. Furthermore, the direction of the current flowing through the electric path piece 212i and the direction of the current flowing through the fixed terminal 31 are opposite directions. Also, the direction of the current flowing through the electric path piece 214i and the direction of the current flowing through the fixed terminal 32 are opposite directions.

Furthermore, the length of the electric path piece 213i and the length of the electric path piece 223i are equal to or larger than the distance L11 between the moving contact 81 and the moving contact 82 (see FIGS. 7A, 7B). That is, like the electric path piece 213, the electric path piece 213i includes the first portion 251 and the second portion 252. Like the electric path piece 223, the electric path piece 223i includes the first portion 261 and the second portion 262.

Here, it is assumed that the current I flows from the fixed terminal 31 toward the fixed terminal 32. In this case, in the bus bar 21i, the current I flows through the electric path piece 214i, the electric path piece 213i, the electric path piece 212i, and the electric path piece 211i in this order. In the bus bar 22i, the current I flows through the electric path piece 221i, the electric path piece 222i, the electric path piece 223i, and the electric path piece 224i in this order.

A flow of the current I through the electric path piece 214i causes a magnetic flux φ31 which is clockwise when viewed from above (see FIG. 26B). A flow of the current I through the electric path piece 213i causes a magnetic flux φ32 which is clockwise when viewed from the right (see FIG. 26B). Further a flow of the current I through the electric path piece 212i causes a magnetic flux φ33 which is counterclockwise when viewed from above (see FIG. 26B). Therefore, a magnetic flux tends to gather at the internal space U1 given by the U-shape formed by the electric path pieces 212i to 214i. As a result, it is possible to stabilize the connection state between the moving contacts 81, 82 and the fixed contacts 311, 321.

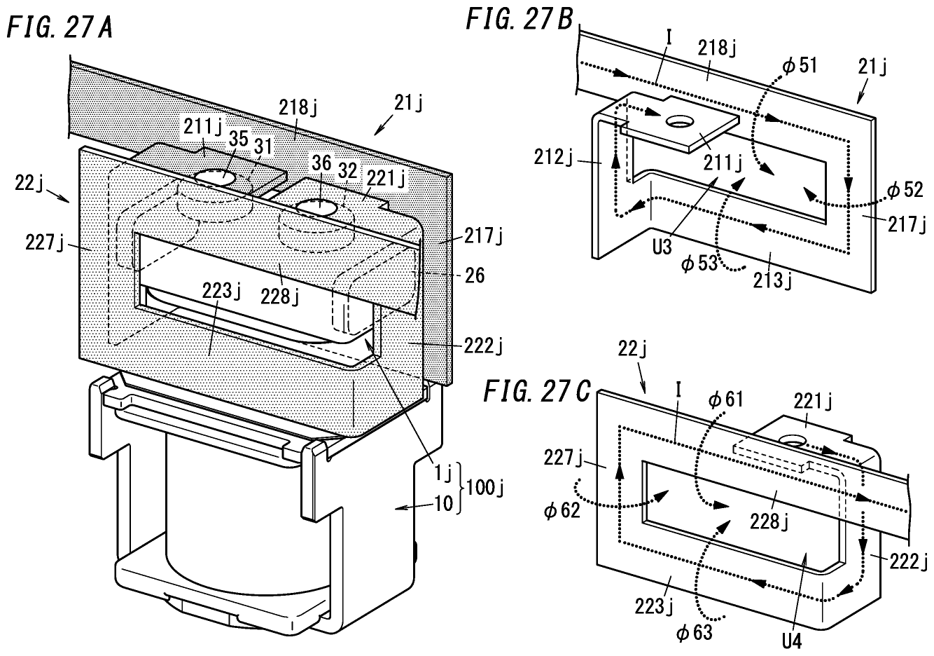

A flow of the current I through the electric path piece 222i causes a magnetic flux φ41 which is clockwise when viewed from above (see FIG. 27B). A flow of the current I through the electric path piece 223i causes a magnetic flux φ42 which is clockwise when viewed from the right (see FIG. 27B). Further a flow of the current I through the electric path piece 224j causes a magnetic flux φ43 which is counterclockwise when viewed from above (see FIG. 27B). Therefore, a magnetic flux tends to gather at the internal space U2 given by the U-shape formed by the electric path pieces 222i to 224i. As a result, it is possible to stabilize the connection state between the moving contacts 81, 82 and the fixed contacts 311, 321.

Further, in the contact device 1i according to the present embodiment, the bus bars 21i, 22i include the electric path pieces 212i, 214i, 222i, 224i allowing the current I to flow therethrough in an opposite direction from the current I flowing through the fixed terminals, 31, 32. Therefore, similarly to the first embodiment, the force for moving the moving contactor 8 downward can be further reduced.

Hereinafter, variations of the fifth embodiment will be described. The variations described below may be appropriately combined with other embodiments and other variations.

The fifth embodiment includes the configuration where both the electric path piece 212i and the electric path piece 214i are positioned in the same side as the electric path piece 213i relative to the moving contactor 8 when viewed in one of the moving directions of the moving contactor 8, but may not be limited to including this configuration. One of the electric path piece 212i and the electric path piece 214i may be positioned in the same side as the electric path piece 213i (reverse electric path piece) relative to the moving contactor 8 when viewed in one of the moving directions of the moving contactor 8. That is, at least one of the electric path piece 212i and the electric path piece 214i may be positioned in the same side as the electric path piece 213i (reverse electric path piece) relative to the moving contactor 8 when viewed in one of the moving directions of the moving contactor 8.

The fifth embodiment includes the configuration where both the electric path piece 222i and the electric path piece 224i are positioned in the same side as the electric path piece 223i relative to the moving contactor 8 when viewed in one of the moving directions of the moving contactor 8, but may not be limited to including this configuration. One of the electric path piece 222i and the electric path piece 224i may be positioned in the same side as the electric path piece 223i (reverse electric path piece) relative to the moving contactor 8 when viewed in one of the moving directions of the moving contactor 8. That is, at least one of the electric path piece 222i and the electric path piece 224i may be positioned in the same side as the electric path piece 213i (reverse electric path piece) relative to the moving contactor 8 when viewed in one of the moving directions of the moving contactor 8.

### Sixth Embodiment

A contact device 1j according to the present embodiment is different from the first embodiment in the shapes of the two bus bars. Hereinafter, a description will be given focusing on differences from the second embodiment. The same components as the second embodiment are denoted by the same reference signs, and descriptions thereof are omitted as appropriate.

In the contact device 1j according to the present embodiment, two bus bars 21j, 22j are applied (see FIG. 27A). An electromagnetic relay 100j of the present embodiment includes the contact device 1j, and the electromagnet device 10 described in the first embodiment.

The bus bar 21j of the present embodiment includes five electric path pieces 211j, 212j, 213j, 217j, 218j (see FIG. 27B). The present embodiment is different from the second embodiment in arrangement of the electric path piece 217j. The electric path piece 217j (interconnection piece) is connected to the electric path piece 213j and is placed in back of the case 4 to extend upward from a right end portion of the electric path piece 213j. In other words, the electric path piece 217j is placed in back of the case 4 to extend along the moving directions of the moving contactor 8. The electric path piece 218j is connected to the electric path piece 217j and is placed in back of the case 4 to extend leftward from an upper end portion of the electric path piece 217j. Further, the respective thickness directions of the electric path pieces 217j, 218j are perpendicular to the moving directions of the moving contactor 8 (the upward/downward direction) (see FIG. 27A). In other words, the electric path piece 217j is positioned on the same side as the electric path piece 213j relative to the moving contactor 8 when viewed in one of the moving directions of the moving contactor 8.

The bus bar 22j of the present embodiment includes five electric path pieces 221j, 222j, 223j, 227j, 228j (see FIG. 27C). The present embodiment is different from the second embodiment in arrangement of the electric path piece 227j. The electric path piece 227j (interconnection piece) is connected to the electric path piece 223j and is placed in front of the case 4 to extend upward from a left end portion of the electric path piece 223j. In other words, the electric path piece 227j is placed in front of the case 4 to extend along the moving directions of the moving contactor 8. The electric path piece 228j is connected to the electric path piece 227j and is placed in front of the case 4 to extend rightward from an upper end portion of the electric path piece 227e. Further, the respective thickness directions of the electric path pieces 227j, 228j are perpendicular to the moving directions of the moving contactor 8 (the upward/downward direction) (see FIG. 27A). In other words, the electric path piece 227j is positioned on the same side as the electric path piece 223i relative to the moving contactor 8 when viewed in one of the moving directions of the moving contactor 8.

The electric path pieces 218j, 228j are positioned in the same side as the fixed contacts 311, 321 relative to the moving contactor 8 in one direction along the forward/backward direction while the moving contactor 8 is in the closed position. In other words, the electric path pieces 218j, 228j are positioned in the same side as the fixed contacts 311, 321 relative to the moving contactor 8 in the moving directions (the upward/downward direction). To satisfy this positional relationship, the electric path pieces 218j, 228j are placed outside the case 4 to be substantially in parallel with the moving contactor 8.

In the present embodiment, as in the second embodiment, in a cross section perpendicular to the rightward/leftward direction, a first angle between a straight line connecting a center point of the electric path piece 218j and the center point of the moving contactor 8 and a straight line along the forward/backward direction is 45 degrees. Furthermore, in a cross section perpendicular to the rightward/leftward direction, a second angle between a straight line connecting a center point of the electric path piece 228j and the center point of the moving contactor 8 and a straight line along the forward/backward direction is the same as the first angle (45 degrees here). The above numerical value (45 degrees) is a mere example, and there is no intent to limit the scope to this numerical value.

Furthermore, the length of the electric path piece 218j and the length of the electric path piece 228j are equal to or larger than the distance L11 between the moving contact 81 and the moving contact 82 (see FIGS. 7A, 7B).

In other words, the electric path piece 218j includes a first portion overlapping with the fixed contact 311 and a second portion connected to the first portion and overlapping with the fixed contact 321 in the direction perpendicular to the direction in which the fixed contact 311 and the fixed contact 321 are arranged when viewed in one of the moving directions of the moving contactor 8. Similarly, the electric path piece 228j includes a first portion overlapping with the fixed contact 321 and a second portion connected to the first portion and overlapping with the fixed contact 311 in the direction perpendicular to the direction in which the fixed contact 311 and the fixed contact 321 are arranged when viewed in one of the moving directions of the moving contactor 8.

Further, in other words, the electric path piece 218j includes the first portion in a position facing the fixed contact 311 in the moving directions of the moving contactor 8 when viewed in one of directions perpendicular to the moving directions of the moving contactor 8 and the direction of the current flowing through the moving contactor 8. Further, the electric path piece 218j includes the second portion in a position facing the fixed contact 321 in the moving directions of the moving contactor 8 when viewed in one of directions perpendicular to the moving directions of the moving contactor 8 and the direction of the current flowing through the moving contactor 8. The electric path piece 228j includes the first portion in a position facing the fixed contact 311 in the moving directions of the moving contactor 8 when viewed in one of directions perpendicular to the moving directions of the moving contactor 8 and the direction of the current flowing through the moving contactor 8. Further, the electric path piece 228j includes the second portion in a position facing the fixed contact 321 in the moving directions of the moving contactor 8 when viewed in one of directions perpendicular to the moving directions of the moving contactor 8 and the direction of the current flowing through the moving contactor 8.

Note that, like the electric path piece 213, the electric path piece 213j includes the first portion 251 and the second portion 252. Like the electric path piece 223, the electric path piece 223j includes the first portion 261 and the second portion 262.

Here, it is assumed that the current I flows from the fixed terminal 31 toward the fixed terminal 32. In this case, the current I flows through the electric path piece 218j, the electric path piece 217j, the electric path piece 213j, the electric path piece 212j, the electric path piece 211j, the fixed terminal 31, the moving contactor 8, the fixed terminal 32, the electric path piece 221j, the electric path piece 222j, the electric path piece 223j, the electric path piece 227j and the electric path piece 228j in this order (see FIGS. 27A to 27C). As to the electric path pieces 218j, 228j, the current I flows rightward (in a direction from the fixed terminal 31 to the fixed terminal 32). On the other hand, as to the moving contactor 8, the current I flows rightward. In contrast, while the current I flows through the moving contactor 8 from the fixed terminal 32 toward the fixed terminal 31, the current I flows through the electric path pieces 218j, 228j leftward and through the moving contactor 8 leftward, too.

That is, the directions of the currents I flowing through the electric path piece 218j and the electric path piece 228j are identical to the direction of the current I flowing through the moving contactor 8. Therefore, the electric path pieces 218j, 228j each serve as a forward electric path piece positioned in a same side as the fixed contacts 31, 32 relative to the moving contactor 8 in the moving directions of the moving contactor 8 while the moving contactor 8 is in the closed position, to allow the current I to flow therethrough in a same direction as the current I flowing through the moving contactor 8.

In the present embodiment, the electric path piece 218j serving as one forward electric path piece is positioned in back of the case 4 and the electric path piece 228j serving as another forward electric path piece is positioned in front of the case 4. That is, the bus bars 21j, 22j serving as electrically conductive members include a pair of forward electric path pieces (electric path pieces 218j, 228j) and the moving contactor 8 is positioned between the pair of forward electric path pieces (electric path pieces 218j, 228j) when viewed in one of the moving directions of the moving contactor 8.

In the present embodiment, the bus bars 21j, 22j include the electric path pieces 213j, 228j corresponding to the electric path pieces 213, 223 of the first embodiment, respectively. Therefore, repulsive forces F1 developed between the electric path piece 213j and the moving contactor 8 and between the electric path piece 223j and the moving contactor 8 (see FIG. 4A) cause increase in a force pushing up the fixed contacts 311, 321 by the moving contactor 8.

Furthermore, in the contact device 1j according to the present embodiment, the bus bars 21j, 22j include the electric path pieces 218j, 228j allowing the current I to flow therethrough in the same direction as the current I flowing through the moving contactor 8. Therefore, for example, while an abnormal current such as a short-circuit current flows through the contact device 1j, attractive forces may be developed between the electric path piece 218j and the moving contactor 8, and between the electric path piece 228j and the moving contactor 8. As a result, a force moving the moving contactor 8 upward, that is, a force pressing the moving contacts 81, 82 against the fixed contacts 311, 321 is increased.

Further in the present embodiment, the bus bars 21j, 22j include the electric path pieces 212j, 222j corresponding to the electric path pieces 212, 222 of the first embodiment, respectively. Therefore, it is possible to reduce a force moving the moving contactor 8 downward.

Therefore, even when an abnormal current such as a short-circuit current flows in the contact device 1j, it is possible to stabilize the connection state between the moving contacts 81, 82 and the fixed contacts 311, 321.

A flow of the current I through the electric path piece 218j causes a magnetic flux φ51 which is counterclockwise when viewed from the right (see FIG. 27B). A flow of the current I through the electric path piece 217j causes a magnetic flux φ52 which is clockwise when viewed from above (see FIG. 27B). Further, a flow of the current I through the electric path piece 213j causes a magnetic flux φ53 which is clockwise when viewed from the right (see FIG. 27B). Therefore, a magnetic flux tends to gather at the internal space U3 given by the U-shape formed by the electric path pieces 213j, 217j, 218j. As a result, it is possible to stabilize the connection state between the moving contacts 81, 82 and the fixed contacts 311, 321.

A flow of the current I through the electric path piece 228j causes a magnetic flux φ61 which is counterclockwise when viewed from the right (see FIG. 27C). A flow of the current I through the electric path piece 227j causes a magnetic flux φ62 which is counterclockwise when viewed from above (see FIG. 27C). Further, a flow of the current I through the electric path piece 223j causes a magnetic flux φ63 which is clockwise when viewed from the right (see FIG. 27C). Therefore, a magnetic flux tends to gather at the internal space U4 given by the U-shape formed by the electric path pieces 223j, 227j, 228j. As a result, it is possible to stabilize the connection state between the moving contacts 81, 82 and the fixed contacts 311, 321.

Hereinafter, variations of the sixth embodiment will be described. Each of the variations described below may be appropriately combined with other embodiments and other variations.

In the sixth embodiment, the electric path piece 214j may be placed to overlap with the fixed terminal 32 when viewed in one direction along the forward/backward direction. Similarly, the electric path piece 224j may be placed to overlap with the fixed terminal 31 when viewed in one direction along the forward/backward direction. Therefore, similarly to the fifth embodiment, the force for moving the moving contactor 8 downward can be further reduced.

In the sixth embodiment, the electric path piece 212j, similarly to the electric path piece 217j, when viewed in one of the moving directions of the moving contactor 8 may be positioned on the same side as the electric path piece 213j relative to the moving contactor 8. That is, at least one of the electric path piece 212j and the electric path piece 214j may be positioned in the same side as the electric path piece 213j (reverse electric path piece) relative to the moving contactor 8 when viewed in one of the moving directions of the moving contactor 8.

Similarly, the electric path piece 222j, similarly to the electric path piece 227j, when viewed in one of the moving directions of the moving contactor 8 may be positioned on the same side as the electric path piece 223j relative to the moving contactor 8. That is, at least one of the electric path piece 222j and the electric path piece 227j may be positioned in the same side as the electric path piece 223j (reverse electric path piece) relative to the moving contactor 8 when viewed in one of the moving directions of the moving contactor 8.

In the present embodiment, the electric path piece 212j (first extension piece) and the electric path piece 217j (second extension piece) are interconnected by the electric path piece 213j (reverse electric path piece). However, the present embodiment may not be limited to this configuration. The Electric path pieces 212j, 217j may be interconnected by the electric path piece 218j (forward electric path piece). In this case, the electric path pieces 212j, 217j are located on the same side as the fixed contacts 311, 321 relative to the electric path piece 218j in the moving directions of the moving contactor 8. Similarly, the electric path piece 222j (first extension piece) and the electric path piece 227j (second extension piece) may be interconnected by the electric path piece 228j (forward electric path piece). In this case, the electric path pieces 222j, 227j are located on the same side as the fixed contacts 311, 321 relative to the electric path piece 228j in the moving directions of the moving contactor 8.

### Seventh Embodiment

An electromagnetic relay 100k according to the present embodiment is different from the first embodiment in that the electromagnet device 10 is located on the same side as the fixed terminals 311, 321 relative to the moving contactor 8 in the upward/downward direction.

Hereinafter, the electromagnetic relay 100k according to the present embodiment will be described. The electromagnetic relay 100k of the present embodiment includes a contact device 1k, and the electromagnet device 10 described in the first embodiment. Here, at least part of the yoke 11 of the present embodiment (yoke upper plate 111) is located between the excitation coil 14 and the fixed contacts 311, 321.

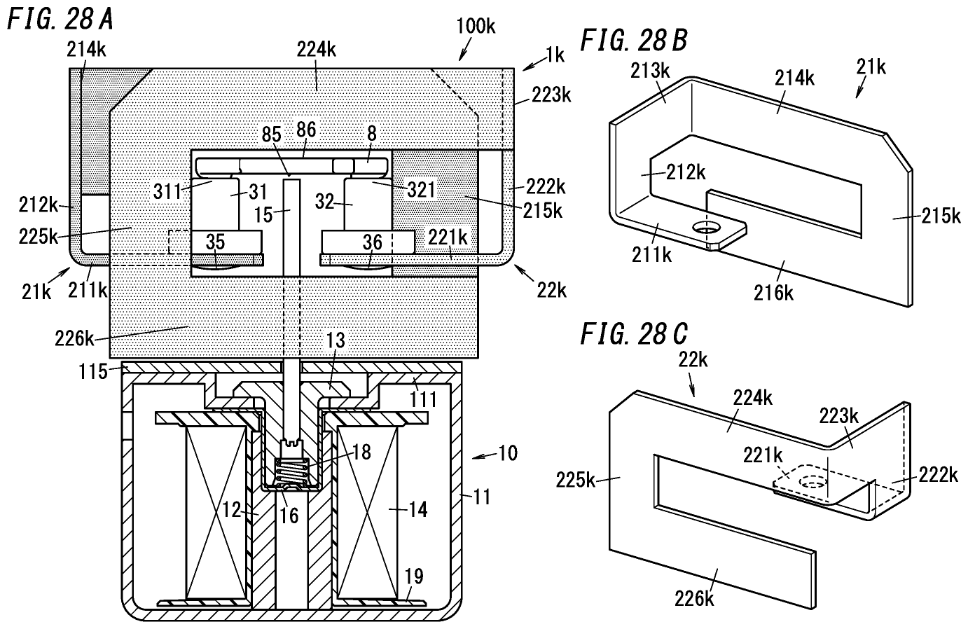

FIG. 28A is a cross-sectional view of the electromagnetic relay 100k. In FIG. 28A, the case 4, the flange 5, the capsule yokes 23, 24, the arc extinction magnets 25, 26, the insulation plate 41, the cover 50, the contact pressure spring 17 and the like, which are already described in the first embodiment, are omitted. In the present embodiment, it is desirable that the first yoke 6 and the second yoke 7 are not provided.

The moving contactor 8 of the present embodiment is placed above the fixed contacts 311, 321 (see FIG. 28A).

In the electromagnetic relay 100k of the present embodiment, the electromagnet device 10 is placed on the same side as the fixed terminals 311, 321 relative to the moving contactor 8 in the upward/downward direction.

The stator 12 included in the electromagnet device 10 of the present embodiment is a fixed iron core formed in the shape of a hollow cylinder. One end portion of the stator 12 is fixed to the cylindrical body 16.

The mover 13 included in the electromagnet device 10 of the present embodiment is a moving core formed in the shape of a combination of two cylinders. Specifically, the moving core includes upper and lower cylinders, the upper cylinder is lager in a diameter than the lower cylinder and thus the entire shape is a cylinder with a T-shape cross section. The mover 13 includes a recess in its bottom. The mover 13 is placed above the stator 12 to face the stator 12. Similarly to the first embodiment, the mover 13 is movable between the excitation position and the non-excitation position.

The return spring 18 of the present embodiment is placed in the recess of the mover 13. The return spring 18 is a coil spring that biases the mover 13 toward the non-excitation position. One end of the return spring 18 is connected within the recess of the mover 13 and the other end of the return spring 18 is connected to the stator 12 (see FIG. 28A).

The shaft 15 of the present embodiment is made of a non-magnetic material. The shaft 15 is formed in the shape of a round rod extending in the upward/downward direction. One end of the shaft 15 is fixed to the mover 13. For example, a tip of the shaft 15 is in contact with the moving contactor 8 while the excitation coil 14 is not energized. The tip of the shaft 15 is not in contact with the moving contactor 8 while the excitation coil 14 is energized. In the present embodiment, when the excitation coil 14 is energized, the shaft 15 is moved downward and is in a position not in contact with the moving contactor 8. At this time, the moving contactor 8 comes into contact with the fixed contacts 311, 321 due to action of the contact pressure spring (not shown in FIG. 28A).

The electromagnet device 10 of the electromagnetic relay 100k includes a restriction plate 115 on an upper surface of the yoke upper plate 111. The restriction plate 115 restricts an upward movement of the mover 13.

With this configuration, a driving force generated by the electromagnet device 10 of the present embodiment causes upward and downward movements of the mover 13 of the electromagnet device 10 of the present embodiment accompanied by upward and downward movements of the moving contactor 8 of the contact device 1 of the present embodiment.

The bus bar 21k of the present embodiment includes six electric path pieces 211k to 217k (see FIGS. 28A, 28B).

The electric path piece 211k is mechanically connected to the fixed terminal 31. The electric path piece 212k (first extension piece) is connected to the electric path piece 211k and is placed in front of the case 4 to extend upward from a left end portion of the electric path piece 211k. The electric path piece 213k is connected to the electric path piece 212k and is placed to extend rearward from an upper end portion of the electric path piece 212k.

The electric path piece 214k (reverse electric path piece) is connected to the electric path piece 213k and is placed to extend rightward (in a direction from the fixed terminal 31 to the fixed terminal 32) from a rear end portion of the electric path piece 213k. The electric path piece 214k is positioned in an opposite side from the fixed contacts 311, 321 relative to the moving contactor 8 when viewed in a direction perpendicular to the moving directions of the moving contactor 8 (e.g., one direction along the forward/backward direction) while the moving contactor 8 is positioned in the closed position. In other words, the moving contactor 8 is positioned between the electric path piece 214k and the fixed contacts 311, 321 when viewed in one direction along the forward/backward direction while the moving contactor 8 is in the closed position.

The electric path piece 215k (second extension piece) is connected to the electric path piece 214k and is placed to extend downward from a right end portion of the electric path piece 214k. The electric path piece 215k and the electric path piece 212k are interconnected by the electric path piece 214k. Further, the electric path piece 215k and the electric path piece 212k are placed in the same side as the fixed contacts 311, 321 relative to the electric path piece 214k in the moving directions of the moving contactor 8.

The electric path piece 216k (forward electric path piece) is connected to the electric path piece 215k and is placed to extend leftward (in a direction from the fixed terminal 32 to the fixed terminal 31) from a lower end portion of the electric path piece 215k.

The bus bar 22k of the present embodiment includes six electric path pieces 221k to 227k (see FIGS. 28A, 28C).

The electric path piece 221k is mechanically connected to the fixed terminal 31. The electric path piece 222k is connected to the electric path piece 221k and is placed to extend upward from a right end portion of the electric path piece 221k. The electric path piece 223k is connected to the electric path piece 222k and is placed to extend forward from an upper end portion of the electric path piece 222k.

The electric path piece 224k (reverse electric path piece) is connected to the electric path piece 223k and is placed to extend leftward (in a direction from the fixed terminal 32 to the fixed terminal 31) from a front end portion of the electric path piece 213k. The electric path piece 224k is positioned in an opposite side from the fixed contacts 311, 321 relative to the moving contactor 8 when viewed in a direction perpendicular to the moving directions of the moving contactor 8 (e.g., one direction along the forward/backward direction) while the moving contactor 8 is positioned in the closed position. In other words, the moving contactor 8 is positioned between the electric path piece 224k and the fixed contacts 311, 321 when viewed in one direction along the forward/backward direction while the moving contactor 8 is in the closed position.

The electric path piece 225k (interconnection electric path piece) is connected to the electric path piece 224k and is placed to extend downward from a left end portion of the electric path piece 224k. The electric path piece 225k and the electric path piece 222k are interconnected by the electric path piece 224k. Further, the electric path piece 225k and the electric path piece 222k are placed in the same side as the fixed contacts 311, 321 relative to the electric path piece 224k in the moving directions of the moving contactor 8.

The electric path piece 226k (forward electric path piece) is connected to the electric path piece 225k and is placed to extend rightward (in a direction from the fixed terminal 31 toward the fixed terminal 32) from a lower end portion of the electric path piece 225k.

In the present embodiment, the electric path pieces 214k to 216k are placed on the same side (here, the rear side) with respect to the moving contactor 8 when viewed in one of the moving directions of the moving contactor 8 (the upward/downward direction). Similarly, the electric path pieces 224k to 226k are placed on the same side (here, the front side) with respect to the moving contactor 8 when viewed in one of the moving directions of the moving contactor 8 (the upward/downward direction).

Further, the electric path pieces 216k and 226k are placed between the yoke upper plate 111 and the fixed contacts 311, 321 when viewed in a direction perpendicular to the moving directions of the moving contactor 8 (e.g., one direction along the forward/backward direction).

In the present embodiment, it is assumed that the current I flows through the moving contactor 8 from the fixed terminal 31 toward the fixed terminal 32. At this time, the current flows through the bus bar 21k, the fixed terminal 31, the moving contactor 8, the fixed terminal 32, and the bus bar 22k in this order. More specifically, the current flows through the electric path piece 216k, the electric path piece 215k, the electric path piece 214k, the electric path piece 213k, the electric path piece 212k, the electric path piece 211k, the fixed terminal 31, the moving contactor 8, the fixed terminal 32, the electric path piece 221k, the electric path piece 222k, the electric path piece 223k, the electric path piece 224k, the electric path piece 225k and the electric path piece 226k in this order.

In the electric path pieces 214k, 224k of the present embodiment, the current flows from the right to the left (in a direction from the fixed terminal 32 toward the fixed terminal 31). In the electric path pieces 216k, 226k, the current flows from the left to the right (in a direction from the fixed terminal 31 toward the fixed terminal 32). Meanwhile, in the moving contactor 8, the current flows from the left to the right. In contrast, when the current flows through the moving contactor 8 toward the fixed terminal 31 from the fixed terminal 32, the electric path pieces 214k, 224k see the current flowing therethrough from the left to the right (in a direction from the fixed terminal 31 toward the fixed terminal 32) and the electric path pieces 216k, 226k see the current flowing therethrough from the right to the left (in a direction from the fixed terminal 32 toward the fixed terminal 31).

That is, in the present embodiment, the direction of the current flowing through the moving contactor 8 is identical to the directions of the currents flowing through the circuit pieces 216k, 226k. In contrast, the direction of the current flowing through the moving contactor 8 is opposite from the directions of the currents flowing through the electric path pieces 214k, 224k.

In the present embodiment, the electric path piece 212k (first extension piece) and the electric path piece 215k (second extension piece) are interconnected by the electric path piece 214k (reverse electric path piece). However, the present embodiment may not be limited to this configuration. The electric path piece 212k (first extension piece) and the electric path piece 215k (second extension piece) may be interconnected by the electric path piece 216k (forward electric path piece). In this case, the electric path pieces 212k, 215k are located on the same side as the fixed contacts 311, 321 relative to the electric path piece 216k in the moving directions of the moving contactor 8. Similarly, the electric path piece 222k (first extension piece) and the electric path piece 225k (second extension piece) may be interconnected by the electric path piece 226k (forward electric path piece). In this case, the electric path pieces 222k, 225k are located on the same side as the fixed contacts 311, 321 relative to the electric path piece 226k in the moving directions of the moving contactor 8.

In the present embodiment, the contact device 1k is configured to include none of the first yoke 6 and the second yoke 7, but may not be limited to this configuration. The contact device 1k may include the first yoke 6, 6d and the second yoke 7. Alternatively, the contact device 1k may include the yoke 6f as described above.

(Other Variations)

Other variations will be enumerated one after another. Any of the variations to be described below may be combined as appropriate with the embodiments described above (including the variations thereof).

In the exemplary embodiments described above, the case 4 is configured to hold the fixed terminals 31, 32 while partially exposing the fixed terminals 31, 32. However, this is only an example and should not be construed as limiting. Alternatively, the case 4 may house the fixed terminals 31, 32 entirely inside itself. That is to say, the case 4 only needs to be configured to house the fixed contacts 311, 321 and the moving contactor 8 to say the least.

Also, in the exemplary embodiments described above, the contact device may include no capsule yokes. When provided, the capsule yokes could weaken the repulsive forces between the electrical path pieces 213, 223 and the moving contactor 8. Thus, removing the capsule yokes curbs such a decrease in repulsive forces due to the presence of the capsule yokes, thus eventually increasing the force with which the moving contactor 8 is pushed upward.

Furthermore, in the exemplary embodiment described above, each electromagnetic relay is supposed to be a so-called “normally OFF” electromagnetic relay, of which the moving contactor 8 is located at the open position while the excitation coil 14 is not energized. However, this is only an example and should not be construed as limiting. Alternatively, each electromagnetic relay may also be a normally ON electromagnetic relay.

Furthermore, in the exemplary embodiments described above, the number of moving contacts held by the moving contactor 8 is two. However, this is only an example and should not be construed as limiting. The number of the moving contacts held by the moving contactor 8 may also be one or even three or more. Likewise, the number of the fixed terminals (and fixed contacts) does not have to be two but may also be one or even three or more.

The electromagnetic relay according to the exemplary embodiments is implemented as an electromagnetic relay with no holders. However, this is only an example and should not be construed as limiting. Alternatively, the electromagnetic relay may also be implemented as an electromagnetic relay with a holder. In that case, the holder may have the shape of a rectangular cylinder with the right and left end faces open and may be combined with the moving contactor 8 such that the moving contactor 8 runs through the holder in the rightward/leftward direction. The contact pressure spring 17 is arranged between the lower wall of the holder and the moving contactor 8. That is to say, the moving contactor 8 is held by the holder at a central region thereof in the rightward/leftward direction. The upper end of the shaft 15 is secured to the holder. When the excitation coil 14 is energized, the shaft 15 is pushed upward, and therefore, the holder moves upward. This movement causes the moving contactor 8 to move upward, thereby bringing the pair of moving contacts 81, 82 to the closed position where the pair of moving contacts 81, 82 are in contact with the pair of fixed contacts 311, 321.

Furthermore, in the exemplary embodiments described above, the contact device is implemented as a plunger type contact device. Alternatively, the contact device may also be implemented as a hinged contact device.

Furthermore, in the exemplary embodiments described above, the bus bar is caulked to, and thereby mechanically connected to, the fixed terminals 31, 32. However, this is only an example and should not be construed as limiting. Alternatively, the bus bar may also be mechanically connected with screws onto the fixed terminals 31, 32. Still alternatively, the bus bar may also be coupled to the fixed terminals 31, 32 by welding, brazing, or any other suitable method.

Furthermore, in the exemplary embodiments described above, the arc extinction magnets are arranged outside the case 4 (i.e., between the capsule yokes and the case 4). However, this is only an example and should not be construed as limiting. Alternatively, the arc extinction magnets may also be arranged inside the case 4.

In a contact device of each embodiment, each bus bar is configured to include at least one reverse electric path piece, or both at least one reverse electric path piece and at least one forward electric path piece, but may not be limited to this configuration. A bus bar fixed to a contact device may be configured to include at least one forward electric path piece. In summary, a bus bar may be configured to include at least one electric path piece selected from a group consisting of at least one reverse electric path piece and at least one forward electric path piece.

Further, in a contact device of each embodiment, the case 4 itself is configured to serve as the non-magnetic portion 400. However, the non-magnetic portion 400 need not be provided as the case 4 itself. At least part of the case 4 which faces at least one forward electric path piece or at least one reverse electric path piece may serve as the non-magnetic portion 40 made of a non-magnetic material.

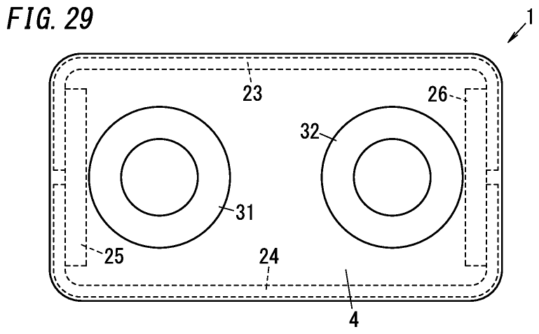

In addition, the capsule yokes 23, 24 and the arc extinction magnets 25, 26 may be provided inside the case 4 (see FIG. 29). At this time, the arc extinction magnet 25 is shielded from the fixed terminal 31, in particular the fixed contact 311. The arc extinction magnet 26 is shielded from the fixed terminal 32, in particular the fixed contact 321.

Furthermore, at least one of the yokes, arc extinction magnets, or capsule yokes is an unessential constituent element for the contact device according to any of the exemplary embodiments.

(Conclusion)

As described above, a contact device (1; 1e; 1f; 1g; 1h; 1i; 1j; 1k) according to a first aspect includes at least one fixed terminal (31; 32), a moving contactor (8), a case (4), and a bus bar (21; 22; 21a; 22a; 22b; 21c; 22c; 21e; 22e; 21i; 22i; 21j; 22j; 21k; 22k). The at least one fixed terminal (31; 32) includes at least one fixed contact (311; 321). The moving contactor (8) includes at least one moving contact (81; 82) and is movable between a closed position where the at least one moving contact (81; 82) is in contact with the at least one fixed contact (311; 321) and an open position where the at least one moving contact (81; 82) is separate from the at least one fixed contact (311; 321). The case (4) accommodates at least the at least one fixed contact (311; 321) and the moving contactor (8). The at least one bus bar (21; 22; 21a; 22a; 22b; 21c; 22c; 21e; 22e; 21i; 22i; 21j; 22j; 21k; 22k) is electrically connected to the at least one fixed terminal (31; 32). The at least one bus bar (21; 22; 21a; 22a; 22b; 21c; 22c; 21e; 22e; 21i; 22i; 21j; 22j; 21k; 22k) includes at least one electric path piece selected from a group consisting of at least one reverse electric path piece (electric path piece 213; 223; 213a; 223a; 223b; 213e; 223e; 213i; 223i; 213j; 223j; 224b; 215; 216; 225; 226; 214k; 224k) and at least one forward electric path piece (electric path piece 218e; 228e; 218j; 228j; 216k; 226k) which extend along a direction of a current (I) flowing through the moving contactor (8). The at least one reverse electric path piece is placed outside the case (4) to allow the moving contactor (8) to be positioned between the at least one reverse electric path piece and the at least one fixed contact (311; 321) in moving directions of the moving contactor (8) with the moving contactor (8) positioned in the closed position. The at least one reverse electric path piece allows the current (I) to flow therethrough in an opposite direction from the current (I) flowing through the moving contactor (8). The at least one forward electric path piece is placed outside the case (4) to be positioned on a same side as the at least one fixed contact (311; 321) relative to the moving contactor (8) in the moving directions of the moving contactor (8) with the moving contactor (8) positioned in the closed position. The at least one forward electric path piece allows the current (I) to flow therethrough in a same direction as the current (I) flowing through the moving contactor (8).

According to this configuration, presence of the at least one reverse electric path piece can produce a repulsive force between the at least one reverse electric path piece and the moving contactor (8). Therefore, a force component of the produced repulsive force directed to the fixed terminal (31; 32) causes an increase in a force pressing the fixed contact (311; 321) by the moving contactor (8). Therefore, it is possible to stabilize a connection state between the moving contact (81; 82) and the fixed contact (311; 321) in a case where an abnormal current flows through the contact device (1; 1e; 1f; 1g; 1h; 1i; 1j; 1k). Presence of the at least one forward electric path piece can produce an attractive force between the at least one forward electric path piece and the moving contactor (8). Therefore, a force component of the produced force directed to the fixed terminal (31; 32) causes an increase in a force pressing the fixed contact (311; 321) by the moving contactor (8). Therefore, it is possible to stabilize a connection state between the moving contact (81; 82) and the fixed contact (311; 321) in a case where an abnormal current flows through the contact device (1; 1e; 1f; 1g; 1h; 1i; 1j; 1k).

In a contact device (1e; 1j; 1k) according to a second aspect based on the first aspect, the at least one bus bar (21e; 22e; 21j; 22j; 21k; 22k) includes both of the at least one reverse electric path piece and the at least one forward electric path piece. The at least one reverse electric path piece and the at least one forward electric path piece are connected to each other.

According to this configuration, it is possible to produce a repulsive force and an attractive force by use of a current flowing through the bus bar (21e; 22e; 21j; 22j; 21k; 22k).

In a contact device (1e; 1j; 1k) according to a third aspect based on the second aspect, the at least one reverse electric path piece and the at least one forward electric path piece are positioned on a same side relative to the moving contactor (8) when viewed in one of the moving directions of the moving contactor (8).

According to this configuration, a force pressing the fixed contact (311; 321) by the moving contactor (8) can be increased by a repulsive force and an attractive force.

In a fourth aspect (1e; 1j; 1k) based on the second aspect, the moving contactor (8) is positioned between the at least one reverse electric path piece and the at least one forward electric path piece when viewed in one of the moving directions of the moving contactor (8).

According to this configuration, it is possible to press the moving contactor (8) against the fixed contact (311; 321) from opposite sides of the moving contactor (8) by a repulsive force and an attractive force.

In a contact device (1; 1e; 1f; 1g; 1h; 1i; 1j; 1k) according to a fifth aspect based on any one of the first to fourth aspects, the at least one fixed contact (311; 321) is provided to a first end of the at least one fixed terminal (31; 32) and the at least one bus bar (21; 22; 21a; 22a; 22b; 21c; 22c; 21e; 22e; 21i; 22i; 21j; 22j; 21k; 22k) is fixed to a second end of the at least one fixed terminal (31; 32).

According to this configuration, it is possible to produce a repulsive force by use of a current flowing through the device itself.

In a contact device (1; 1e; 1f; 1g; 1h; 1i; 1j; 1k) according to a sixth aspect based on any one of the first to fifth aspects, the at least one fixed terminal (31; 32) includes a first fixed terminal (31) and a second fixed terminal (32). The at least one fixed contact (311; 321) includes a first fixed contact (311) provided to the first fixed terminal (31) and a second fixed contact (321) provided to the second fixed terminal (32). The at least one moving contact (81; 82) includes a first moving contact (moving contact 81) and a second moving contact (moving contact 82) which are in contact with the first fixed contact (311) and the second fixed contact (321) respectively while the moving contactor (8) is in the closed position. The at least one bus bar (21; 22; 21a; 22a; 22b; 21c; 22c; 21e; 22e; 21i; 22i; 21j; 22j; 21k; 22k) is electrically connected to at least one fixed terminal selected from a group consisting of the first fixed terminal (31) and the second fixed terminal (32).

According to this configuration, it is possible to press, against a fixed contact (311, 321) of a fixed terminal (31, 32) electrically connected to the bus bar (21; 22; 21a; 22a; 22b; 21c; 22c; 21e; 22e; 21i; 22i; 21j; 22j; 21k; 22k), a moving contact (81, 82) corresponding thereto.

In a contact device (1e; 1j; 1k) according to a seventh aspect based on the sixth aspect, the at least one bus bar (21e; 22e; 21j; 22j; 21k; 22k) includes the at least one forward electric path piece, the at least one reverse electric path piece, and an interconnection piece (electric path piece 217e; 227e; 217j; 227j; 215k; 225k) interconnecting the at least one forward electric path piece and the at least one reverse electric path piece. The interconnection piece is placed outside the case (4) and placed on one side of the case (4) in a direction in which the first fixed contact (311) and the second fixed contact (321) are arranged.

According to this configuration, it is possible to press, against a fixed contact (311, 321) of a fixed terminal (31, 32) electrically connected to the bus bar (21e; 22e; 21j; 22j; 21k; 22k), a moving contact (81, 82) corresponding thereto, due to a repulsive force and an attractive force resulting from a flow of a current through the bus bar (21e; 22e; 21j; 22j; 21k; 22k).

In a contact device (1e; 1j; 1k) according to an eighth aspect based on the second or sixth aspect, the at least one bus bar (21e; 22e; 21j; 22j; 21k; 22k) includes the at least one forward electric path piece, the at least one reverse electric path piece, and an interconnection piece (electric path piece 217e; 227e; 217j; 227j; 215k; 225k) interconnecting the at least one forward electric path piece and the at least one reverse electric path piece. The at least one forward electric path piece, the at least one forward electric path piece, and the interconnection piece are placed on a same side relative to the moving contactor (8) when viewed in one of the moving directions of the moving contactor (8).

According to this configuration, the forward electric path piece, the reverse electric path piece, and the interconnection piece show a U-shape. Therefore, a magnetic flux tends to gather at the internal space U2 given by the U-shape. Thus, a magnetic field acting on the moving contactor (8) can be enhanced.

In a contact device (1; 1e; 1f; 1g; 1h; 1i; 1j; 1k) according to a ninth aspect based on the sixth aspect, the at least one bus bar (21; 22; 21a; 22a; 22b; 21c; 22c; 21e; 22e; 21i; 22i; 21j; 22j; 21k; 22k) includes a first bus bar (21; 21a; 21c; 21e; 21i; 21j; 21k) electrically connected to the first fixed terminal (31) and a second bus bar (22; 22a; 22b; 22c; 22e; 22i; 22j; 22k) electrically connected to the second fixed terminal (32). The first bus bar includes at least one first electric path piece serving as at least one corresponding one of the at least one electric path piece. The second bus bar includes at least one second electric path piece serving as at least one corresponding one of the at least one electric path piece.

According to this configuration, a force pressing the fixed contact (311; 321) by the moving contactor (8) can be increased.

In a contact device (1; 1e; 1f; 1g; 1h; 1i; 1j; 1k) according to a tenth aspect based on the ninth aspect, the moving contactor (8) is placed between the at least one first electric path piece and the at least one second electric path piece when viewed in one of the moving directions of the moving contactor (8).

According to this configuration, it is possible to press the moving contactor (8) against the fixed contact (311; 321) from opposite sides of the moving contactor (8).

In a contact device (1; 1e; 1f; 1g; 1h; 1i; 1j; 1k) according to an eleventh aspect based on the ninth aspect, the at least one bus bar (21; 22; 21a; 22a; 22b; 21c; 22c; 21e; 22e; 21i; 22i; 21j; 22j; 21k; 22k) includes a first portion (251; 261) overlapping with the first fixed contact (311) and a second portion (252; 262) connected to the first portion (251; 261) and overlapping with the second fixed contact (321) in a direction perpendicular to a direction in which the first fixed contact (311) and the second fixed contact (312) are arranged when viewed in one of the moving directions of the moving contactor (8).

According to this configuration, the fixed contact (311; 321) can be pressed by a stronger force.

In a contact device (1e; 1j; 1k) according to a twelfth aspect based on the eleventh aspect, the at least one bus bar (21e; 22e; 21j; 22j; 21k; 22k) includes the at least one forward electric path piece.

According to this configuration, a stronger attractive force can be produced and thus pressing of the fixed contact (311; 321) can be done by a stronger force.

In a contact device (1e; 1j; 1k) according to a thirteenth aspect based on the first aspect, the at least one bus bar (21e; 22e; 21i; 22i; 21j; 22j; 21k; 22k) includes: the at least one reverse electric path piece; and a first extension piece (electric path piece 212e; 222e; 212j; 222j; 212k; 222k) and a second extension piece (electric path piece 217e; 227e; 217j; 227j; 215k; 225k) which extend along the moving directions of the moving contactor (8) and placed outside the case (4). The first extension piece and the second extension piece each include a portion in a same side as the at least one fixed contact (311; 321) and a portion in an opposite side from the at least one fixed contact (311; 321), relative to the moving contactor (8) in the moving directions of the moving contactor (8) while the moving contactor (8) is in the closed position. The first extension piece and the second extension piece are interconnected by the at least one reverse electric path piece and placed in a same side as the at least one fixed contact (311; 321) relative to the at least one reverse electric path piece in the moving directions of the moving contactor (8). Or, the first extension piece and the second extension piece are interconnected by the at least one forward electric path piece and placed in a same side as the at least one fixed contact (311; 321) relative to the at least one forward electric path piece in the moving directions of the moving contactor (8).

According to this configuration, the fixed contact (311; 321) can be pressed by a stronger force.

In a contact device (1e; 1j; 1k) according to a fourteenth aspect based on the thirteenth aspect, at least one of the first extension piece and the second extension piece is in a same side as the at least one reverse electric path piece relative to the moving contactor (8) when viewed in one of the moving directions of the moving contactor (8) while the first extension piece and the second extension piece are positioned in a same side as the at least one fixed contact (311; 312) relative to the at least one reverse electric path piece in the moving directions of the moving contactor (8).

According to this configuration, a magnetic field action on the moving contactor (8) can be enhanced.

In a contact device (1) according to a fifteenth aspect based on the first aspect, the at least one bus bar (22b) includes two electric path pieces (223b; 224b) of a plurality of the electric path pieces. The moving contactor (8) is placed between the two electric path pieces (223b; 224b) when viewed in one of the moving directions of the moving contactor (8).

According to this configuration, repulsive forces are produced at opposite sides of the moving contactor (8) and therefore forces of pressing the fixed contact (311; 321) from the opposite sides of the moving contactor (8) can be increased.

In a contact device (1; 1e; 1f; 1g; 1h; 1i; 1j; 1k) according to a sixteenth aspect based on the first aspect, the case (4) includes a non-magnetic portion (400) made of a non-magnetic material. The at least one forward electric path piece or the at least one reverse electric path piece faces the non-magnetic portion (400).

According to this configuration, it is possible to reduce possibilities that the case (4) causes adverse effects on a magnetic flux developed at the forward electric path piece or the reverse electric path piece which faces the case (4).

A contact device (1; 1e; 1f; 1g; 1h; 1i; 1j; 1k) according to a seventeenth aspect based on the first aspect further includes an arc extinction magnet (25; 26; 25g; 26g). The arc extinction magnet (25; 26; 25g; 26g) is for stretching an arc developed between the at least one moving contact (81; 82) and the at least one fixed contact (311; 321) when the moving contactor (8) moves from the closed position to the open position.

According to this configuration, it is possible to extinguish an arc produced between the fixed contact (311; 321) and the moving contact (81; 82).

In a contact device (1; 1e; 1f; 1g; 1h; 1i; 1j; 1k) according to an eighteenth aspect based on the seventeenth aspect, at least part of the at least one electric path piece does not overlap with the arc extinction magnet when viewed in a direction perpendicular to the moving directions of the moving contactor (8) and the direction of the current flowing through the moving contactor (8).

According to this configuration, it is possible to reduce probabilities of occurrence of interaction between a Lorentz force for extinction of an arc and a repulsive force between the electric path piece and the moving contactor (8).

In a contact device (1; 1e; 1f; 1g; 1h; 1i; 1j; 1k) according to a nineteenth aspect based on the seventeenth or eighteenth aspect, the arc extinction magnet (25; 26; 25g; 26g) is placed on a line extending in the direction of the current (I) flowing through the moving contactor (8). Or, the arc extinction magnet (25; 26; 25g; 26g) is placed to make a direction from the arc extinction magnet (25; 26; 25g; 26g) to the at least one fixed contact (311; 321) different from the direction of the current flowing through the moving contactor (8) when viewed in one of the moving directions of the moving contactor (8).

According to this configuration, it is possible to extinguish an arc produced between the fixed contact (311; 321) and the moving contact (81; 82). When the arc extinction magnet (25; 26; 25g; 26g) is placed on a line extending in the direction of the current (I) flowing through the moving contactor (8), a width of the moving contactor (8) can be made shorter and thus downsizing can be realized.

In a contact device (1; 1e; 1f; 1g; 1h; 1i; 1j; 1k) according to a twentieth aspect based on any one of the seventeenth to nineteenth aspects, the at least one bus bar (21; 22; 21a; 22a; 22b; 21c; 22c; 21e; 22e; 21i; 22i; 21j; 22j; 21k; 22k) further includes an extension piece (electric path piece 212; 222; 212a; 222a; 222b; 212e; 222e; 212i; 222i; 214i; 224i; 212j; 222j; 212k; 222k; 215k; 225k) extending along the moving directions of the moving contactor (8). The extension piece is present between the arc extinction magnet (25; 26; 25g; 26g) and the case (4) when viewed in one of the moving directions of the moving contactor (8).

According to this configuration, a force for separating the moving contactor (8) from the fixed contact (311; 321) can be made weaker.

A contact device (1; 1e; 1f; 1g; 1h; 1i; 1j; 1k) according to a twenty-first aspect based on any one of the seventeenth to twentieth aspects further includes a magnet yoke (yoke 23; 24; 25; 26; 23g; 24g; 25g; 26g). The magnet yoke is magnetically coupled with the arc extinction magnet (25; 26; 25g; 26g) to form part of a path for a magnetic flux of the arc extinction magnet (25; 26; 25g; 26g).

According to this configuration, a path for a magnetic flux produced by the arc extinction magnet (25; 26; 25g; 26g) can be made.

In a contact device (1; 1e; 1f; 1g; 1h; 1i; 1j; 1k) according to a twenty-second aspect based on the twenty-first aspect, the at least one electric path piece is positioned between the magnet yoke and the case (4) when viewed in one of the moving directions of the moving contactor (8).

According to this configuration, a repulsive force between the electric path piece and the moving contactor (8) can be made stronger.

In a contact device (1; 1e; 1f; 1g; 1h; 1i; 1j; 1k) according to a twenty-third aspect based on the twenty-first aspect, the magnet yoke includes an extended portion (231; 241) extending along the direction of the current (I) flowing through the moving contactor (8). At least part of the at least one electric path piece does not overlap with the extended portion (231; 241) of the magnet yoke when viewed in a direction perpendicular to the moving directions of the moving contactor (8) and the direction of the current (I) flowing through the moving contactor (8).

According to this configuration, it is possible to reduce possibilities that a path for a magnetic flux produced between the arc extinction magnet (25; 26; 25g; 26g) and the magnet yoke causes adverse effects on a repulsive force between the electric path piece and the moving contactor (8).

In a contact device (1; 1e; 1f; 1g; 1h; 1i; 1j; 1k) according to a twenty-fourth aspect based on the twenty-first aspect, the at least one bus bar (21; 22; 21a; 22a; 22b; 21c; 22c; 21e; 22e; 21i; 22i; 21j; 22j; 21k; 22k) further includes an extension piece (electric path piece 212; 222; 212a; 222a; 222b; 212e; 222e; 212i; 222i; 214i; 224i; 212j; 222j; 212k; 222k; 215k; 225k) extending along the moving directions of the moving contactor (8). The extension piece is present between the magnet yoke and the case (4) when viewed in one of the moving directions of the moving contactor (8).

According to this configuration, a force for separating the moving contactor (8) from the fixed contact (311; 321) can be made weaker.

A contact device (1; 1e; 1f; 1g; 1h; 1i; 1j; 1k) according to a twenty-fifth aspect based on any one of the first to twenty-fourth aspects further includes a yoke (first yoke 6; 6d, yoke 6f) at least part of which is positioned in a same side as the at least one fixed contact (311; 321) relative to the moving contactor (8) in the moving directions of the moving contactor (8). Or, the contact device (1; 1e; 1f; 1g; 1h; 1i; 1j; 1k) based on any one of the first to twenty-fourth aspects further includes a first yoke (6; 6d) serving as the yoke, and a second yoke (7) different from the first yoke (6; 6d). At least part of the second yoke (7) is positioned in an opposite side from the at least one fixed contact (311; 321) relative to the moving contactor (8) in the moving directions of the moving contactor (8).

According to this configuration, provision of the yoke allows an upward Lorentz force to act on the moving contactor (8). Therefore, it is possible to stabilize a connection state between the moving contact (81; 82) and the fixed contact (311; 321) in a case where an abnormal current flows through the contact device (1; 1e; 1f; 1g; 1h; 1i; 1j; 1k). Or, due to a magnetic force produced between the first yoke (6; 6d) and the second yoke (7), it is possible to stabilize a connection state between the moving contact (81; 82) and the fixed contact (311; 321) in a case where an abnormal current flows through the contact device (1; 1e; 1f; 1g; 1h; 1i; 1j; 1k).

An electromagnetic relay (100; 100e; 100f; 100g; 100i; 100j; 100k) according to a twenty-sixth aspect includes the contact device (1; 1e; 1f; 1g; 1h; 1i; 1j; 1k) according to any one of the first to twenty-fifth aspects; and an electromagnet device (10) configured to move the moving contactor (8). The electromagnet device (10) includes an excitation coil (14) and a yoke (11) for forming part of a path for a magnetic flux developed at the excitation coil (14). The at least one reverse electric path piece is positioned between the yoke (11) and the moving contactor (8) in the moving directions of the moving contactor (8) while the moving contactor (8) is in the closed position when the at least one fixed contact (311; 321) is placed in an opposite side from the yoke (11) relative to the moving contactor (8). The at least one forward electric path piece is positioned between the yoke (11) and the moving contactor (8) in the moving directions of the moving contactor (8) while the moving contactor (8) is in the closed position when the at least one fixed contact (311; 321) is placed in a same side as the yoke (11) relative to the moving contactor (8).

According to this configuration, it is possible to stabilize a connection state between the moving contact (81; 82) and the fixed contact (311; 321) in a case where an abnormal current flows, without affected by a magnetic flux developed at the yoke (11).

A contact device (1; 1e; 1f; 1g; 1h; 1i; 1j; 1k) according to a twenty-seventh aspect includes at least one fixed terminal (31, 32), a moving contactor (8), and a case (4). The at least one fixed terminal (31, 32) includes at least one fixed contact (311; 321). The moving contactor (8) includes at least one moving contact (81; 82) and is movable between a closed position where the at least one moving contact (81; 82) is in contact with the at least one fixed contact (311, 321) and an open position where the at least one moving contact (81; 82) is separate from the at least one fixed contact (311; 321). The case (4) accommodates at least the at least one fixed contact (311; 321) and the moving contactor (8). A magnetic field caused by a current flowing through an electrically conductive member placed outside the case (4) while the moving contactor (8) is in the closed position produces a force acting on the moving contactor (8) and keeping the moving contactor (8) in the closed position in the moving directions of the moving contactor (8). The electrically conductive member includes at least one of at least one reverse electric path piece and at least one forward electric path piece each of which extends along a direction of a current flowing through the moving contactor (8). The at least one reverse electric path piece is positioned in an opposite side from the at least one fixed contact (311; 321) relative to the moving contactor (8) in the moving directions of the moving contactor (8) while the moving contactor (8) is in the closed position, to allow the current to flow therethrough in an opposite direction from the current flowing through the moving contactor (8). The at least one forward electric path piece is positioned in a same side as the at least one fixed contact (311; 321) relative to the moving contactor (8) in the moving directions of the moving contactor (8) while the moving contactor (8) is in the closed position, to allow the current to flow therethrough in a same direction as the current flowing through the moving contactor (8).

According to this configuration, a current flowing through the electrically conductive member causes a force (electromagnetic force) acting on the moving contactor (8) and keeping the moving contactor (8) in the closed position. In more detail, a current flowing through the reverse electric path piece causes a repulsive force between the reverse electric path piece and the moving contactor (8) and this leads to a force acting on the moving contactor (8) and keeping the moving contactor (8) in the closed position. A current flowing through the forward electric path piece causes an attractive force between the forward electric path piece and the moving contactor (8) and this leads to a force acting on the moving contactor (8) and keeping the moving contactor (8) in the closed position. Therefore, it is possible to stabilize a connection state between the moving contact (81; 82) and the fixed contact (311; 321) in a case where an abnormal current flows.

In a contact device (1; 1e; 1f; 1g; 1h; 1i; 1j; 1k) according to a twenty-eighth aspect based on the twenty-seventh aspect, the electrically conductive member includes both of the at least one reverse electric path piece and the at least one forward electric path piece. The moving contactor (8) is positioned between the at least one reverse electric path piece and the at least one forward electric path piece when viewed in one of the moving directions of the moving contactor (8).

According to this aspect, a repulsive force and an attractive force both act on the moving contactor (8) and thus it is possible to more stabilize the connection state between the moving contact (81; 82) and the fixed contact (311; 321) in a case where an abnormal current flows.

In a contact device (1; 1e; 1f; 1g; 1h; 1i; 1j; 1k) according to a twenty-ninth aspect based on the twenty-seventh aspect, the electrically conductive member includes both of the at least one reverse electric path piece and the at least one forward electric path piece. The at least one reverse electric path piece and the at least one forward electric path piece are positioned on a same side relative to the moving contactor (8) when viewed in one of the moving directions of the moving contactor (8).

According to this configuration, a magnetic field acting on the moving contactor (8) can be enhanced.

In a contact device (1; 1e; 1f; 1g; 1h; 1i; 1j; 1k) according to a thirtieth aspect based on the twenty-eighth or twenty-ninth aspect, the at least one reverse electric path piece and the at least one forward electric path piece are connected to each other.

According to this configuration, a repulsive force and an attractive force can be produced by use of a current flowing through the electric path piece.

In a contact device (1; 1e; 1f; 1g; 1h; 1i; 1j; 1k) according to a thirty-first aspect based on the twenty-seventh aspect, the electrically conductive member includes a pair of the reverse electric path pieces. The moving contactor (8) is positioned between the pair of reverse electric path pieces when viewed in one of the moving directions of the moving contactor (8). Or, the electrically conductive member includes a pair of the forward electric path pieces. The moving contactor (8) is positioned between the pair of forward electric path pieces when viewed in one of the moving directions of the moving contactor (8).

According to this configuration, repulsive forces are developed between the moving contactor (8) and the pair of reverse electric path pieces and therefore, it is possible to more stabilize the connection state between the moving contact (81; 82) and the fixed contact (311; 321) in a case where an abnormal current flows.

An electromagnetic relay (100; 100e; 100f; 100g; 100i; 100j; 100k) according to a thirty-second aspect includes: the contact device (1; 1e; 1f; 1g; 1h; 1i; 1j; 1k) according to any one of the twenty-seventh to thirty-first aspects; and an electromagnet device (10).

According to this configuration, a current flowing through the electrically conductive member causes a force (electromagnetic force) acting on the moving contactor (8) and keeping the moving contactor (8) in the closed position. In more detail, a current flowing through the reverse electric path piece causes a repulsive force between the reverse electric path piece and the moving contactor (8) and this leads to a force acting on the moving contactor (8) and keeping the moving contactor (8) in the closed position. A current flowing through the forward electric path piece causes an attractive force between the forward electric path piece and the moving contactor (8) and this leads to a force acting on the moving contactor (8) and keeping the moving contactor (8) in the closed position. Therefore, it is possible to stabilize a connection state between the moving contact (81; 82) and the fixed contact (311; 321) in a case where an abnormal current flows.

An electrical device (M1; M1a) according to a thirty-third aspect includes an internal device (M2) and a housing (M3; M3a) holding the internal device (M2). The internal device (M2) is constituted by the contact device (1; 1e; 1f; 1g; 1h; 1i; 1j; 1k) according to any one of the first to twenty-fifth and twenty-sixth to thirty-first aspects, or the electromagnetic relay (100; 100e; 100f; 100g; 100i; 100j; 100k) according to the twenty-sixth or thirty-second aspect.

According to this configuration, a current flowing through the electrically conductive member causes a force (electromagnetic force) acting on the moving contactor (8) and keeping the moving contactor (8) in the closed position. In more detail, a current flowing through the reverse electric path piece causes a repulsive force between the reverse electric path piece and the moving contactor (8) and this leads to a force acting on the moving contactor (8) and keeping the moving contactor (8) in the closed position. A current flowing through the forward electric path piece causes an attractive force between the forward electric path piece and the moving contactor (8) and this leads to a force acting on the moving contactor (8) and keeping the moving contactor (8) in the closed position. Therefore, it is possible to stabilize a connection state between the moving contact (81; 82) and the fixed contact (311; 321) in a case where an abnormal current flows.

An electrical device (M1; M1a) according to the thirty-fourth aspect based on the thirty-third aspect further includes a connector (M35) provided to the housing (M3, M3a). The electrically conductive member according to any one of the twenty-sixth to thirty-second aspects is held by the housing (M3, M3a). The at least one fixed terminal (31; 32) is electrically connected to the electrically conductive member through the connector (M35) while the internal device (M2) is held by the housing (M3; M3a).

According to this aspect, at least one of a repulsive force or an attractive force can be made to act on the moving contactor (8) by use of the electrically conductive bar (M21; M22; M21a; M22a). Further, work for connecting the internal device (M2) to the electrically conductive bar (M21; M22; M21a; M22a) can be simplified.

An electrical device (M1; M1a) according to a thirty-fifth aspect based on the thirty-third aspect further includes an electrically conductive bar (M21; M22; M21a; M22a) held by the housing (M3, M3a). The electrically conductive member is constituted by the electrically conductive bar (M21; M22; M21a; M22a).

According to this aspect, at least one of a repulsive force or an attractive force can be made to act on the moving contactor (8) by use of the electrically conductive bar (M21; M22; M21a; M22a).

An electrical device (M1; M1a) according to the thirty-sixth aspect based on the thirty-third aspect further includes a connector provided to the housing (M3, M3a). The at least one fixed terminal (31; 32) is electrically connected to the electrically conductive bar (M21; M22; M21a; M22a) through the connector while the internal device (M2) is held by the housing (M3; M3a).

According to this aspect, work for connecting the internal device (M2) to the electrically conductive bar (M21; M22; M21a; M22a) can be simplified.

An electrical device (M1; M1a) according to a thirty-seventh aspect includes the housing (M3; M3a) of the electrical device (M1; M1a) according to any one of the thirty-third, thirty-fifth and thirty-sixth aspects, and the electrically conductive bar (M21; M22; M21a; M22a).

According to this configuration, a current flowing through the electrically conductive member causes a force (electromagnetic force) acting on the moving contactor (8) and keeping the moving contactor (8) in the closed position. In more detail, a current flowing through the reverse electric path piece causes a repulsive force between the reverse electric path piece and the moving contactor (8) and this leads to a force acting on the moving contactor (8) and keeping the moving contactor (8) in the closed position. A current flowing through the forward electric path piece causes an attractive force between the forward electric path piece and the moving contactor (8) and this leads to a force acting on the moving contactor (8) and keeping the moving contactor (8) in the closed position. Therefore, it is possible to stabilize a connection state between the moving contact (81; 82) and the fixed contact (311; 321) in a case where an abnormal current flows.

A contact device (1; 1e; 1f; 1g; 1h; 1i; 1j; 1k) according to a thirty-eighth aspect includes at least one fixed terminal (31; 32), a moving contactor (8), a case (4), and at least one bus bar (21; 22; 21a; 22a; 22b; 21c; 22c; 21e; 22e; 21i; 22i; 21j; 22j; 21k; 22k). The at least one fixed terminal (31; 32) holds at least one fixed contact (311; 321). The moving contactor (8) holds at least one moving contact (81; 82) and is movable between a closed position where the at least one moving contact (81; 82) is in contact with the at least one fixed contact (311; 321) and an open position where the at least one moving contact (81; 82) is separate from the at least one fixed contact (311; 321). The case (4) accommodates at least the at least one fixed contact (311; 321) and the moving contactor (8). The at least one bus bar (21; 22; 21a; 22a; 22b; 21c; 22c; 21e; 22e; 21i; 22i; 21j; 22j; 21k; 22k) is electrically connected to the at least one fixed terminal (31; 32). The at least one bus bar (21; 22; 21a; 22a; 22b; 21c; 22c; 21e; 22e; 21i; 22i; 21j; 22j; 21k; 22k) includes at least one electric path piece (213; 223; 213a; 223a; 223b; 213e; 223e; 224b; 215; 216; 225; 226; 213i; 223i; 213j; 223j; 214k; 224k) which extends along a direction of a current (I) flowing through the moving contactor (8). The at least one electric path piece (213; 223; 213a; 223a; 223b; 213e; 223e; 224b; 215; 216; 225; 226; 213i; 223i; 213j; 223j; 214k; 224k) is placed outside the case (4) to allow the moving contactor (8) to be positioned between the at least one electric path piece (213; 223; 213a; 223a; 223b; 213e; 223e; 224b; 215; 216; 225; 226; 213i; 223i; 213j; 223j; 214k; 224k) and the at least one fixed contact (311; 321) in moving directions of the moving contactor (8) with the moving contactor (8) positioned in the closed position. The at least one electric path piece (213; 223; 213a; 223a; 223b; 213e; 223e; 224b; 215; 216; 225; 226; 213i; 223i; 213j; 223j; 214k; 224k) allows the current (I) to flow therethrough in an opposite direction from the current (I) flowing through the moving contactor (8).

According to this configuration, a repulsive force is produced between the at least one electric path piece (213; 223) and the moving contactor (8). Therefore, a force component of the produced repulsive force directed to the fixed terminal (31; 32) causes an increase in a force pressing the fixed contact (311; 321) by the moving contactor (8). Therefore, it is possible to stabilize a connection state between the moving contact (81; 82) and the fixed contact (311; 321) in a case where an abnormal current flows through the contact device (1; 1e; 1f; 1g; 1h).

In a contact device (1; 1e; 1f; 1g; 1h; 1i; 1j; 1k) according to a thirty-ninth aspect based on the thirty-eighth aspect, the at least one bus bar (21; 22; 21a; 22a; 22b; 21c; 22c; 21e; 22e; 21i; 22i; 21j; 22j; 21k; 22k) is mechanically connected to the at least one fixed terminal (31; 32).

According to this configuration, it is possible to produce a repulsive force by use of a current flowing through the device itself.

In a contact device (1) according to a fortieth aspect based on the thirty-eighth or thirty-ninth aspect, the at least one bus bar (22b) includes two electric path pieces (223b; 224b) of a plurality of the electric path pieces. The moving contactor (8) is placed between the two electric path pieces (223b; 224b) when viewed in one of the moving directions of the moving contactor (8).

According to this configuration, repulsive forces are produced at opposite sides of the moving contactor (8) and therefore forces of pressing the fixed contact (311; 321) from the opposite sides of the moving contactor (8) can be increased.

A contact device (1e; 1j; 1k) according to a forty-first aspect based on any one of the thirty-eighth to fortieth aspects includes, in addition to at least one reverse electric path piece serving as the at least one electric path piece (213e; 223e; 213j; 223j; 213k; 223k), at least one forward electric path piece serving as at least one additional electric path piece (218e; 228e; 218j; 228j; 218k; 228k) which is placed outside the case (4) and extends along the direction of the current (I) flowing through the moving contactor (8). The forward electric path piece is positioned on a same side as the at least one fixed contact (311; 321) relative to the moving contactor (8) in the moving directions of the moving contactor (8) with the moving contactor (8) positioned in the closed position. The forward electric path piece allows the current (I) to flow therethrough in a same direction as the current (I) flowing through the moving contactor (8).

According to this configuration, an attractive force is produced between the forward electric path piece and the moving contactor (8). Therefore, a force component of the produced force directed to the fixed terminal (31; 32) causes an increase in a force pressing the fixed contact (311; 321) by the moving contactor (8). Therefore, it is possible to stabilize a connection state between the moving contact (81; 82) and the fixed contact (311; 321) in a case where an abnormal current flows through the contact device (1e; 1j; 1k).

In a contact device (1e; 1j; 1k) according to a forty-second aspect based on the forty-first aspect, the at least one forward electric path piece is included in the at least one bus bar (21e; 22e; 21j; 22j; 21k; 22k) and is connected to the at least one reverse electric path piece.

According to this configuration, it is possible to produce a repulsive force and an attractive force by use of a current flowing through the device itself.

In a contact device (1e; 1j; 1k) according to a forty-third aspect based on the forty-first or forty-second aspect, the at least one reverse electric path piece and the at least one forward electric path piece are positioned on a same side relative to the moving contactor (8) when viewed in one of the moving directions of the moving contactor (8).

According to this configuration, a force pressing the fixed contact (311; 321) by the moving contactor (8) can be increased by a repulsive force and an attractive force.

In a contact device (1e; 1j; 1k) according to a forty-fourth aspect based on the forty-first or forty-second aspect, the moving contactor (8) is positioned between the at least one reverse electric path piece and the at least one forward electric path piece when viewed in one of the moving directions of the moving contactor (8).

According to this configuration, it is possible to press the moving contactor (8) against the fixed contact (311; 321) from opposite sides of the moving contactor (8) by a repulsive force and an attractive force.

In a contact device (1; 1e; 1f; 1g; 1h; 1i; 1j; 1k) according to a forty-fifth aspect based on any one of the thirty-eighth to forty-fourth aspects, the at least one fixed terminal (31; 32) includes a first fixed terminal (31) and a second fixed terminal (32). The at least one fixed contact (311; 321) includes a first fixed contact (311) held by the first fixed terminal (31) and a second fixed contact (321) held by the second fixed terminal (32). The at least one moving contact (81; 82) includes a first moving contact (moving contact 81) and a second moving contact (moving contact 82) which are in contact with the first fixed contact (311) and the second fixed contact (321) respectively while the moving contactor (8) is in the closed position. The at least one bus bar (21; 22; 21a; 22a; 22b; 21c; 22c; 21e; 22e; 21i; 22i; 21j; 22j; 21k; 22k) is electrically connected to at least one fixed terminal selected from a group consisting of the first fixed terminal (31) and the second fixed terminal (32).

According to this configuration, it is possible to press, against a fixed contact (311, 321) of a fixed terminal (31, 32) electrically connected to the bus bar (21; 22; 21a; 22a; 22b; 21c; 22c; 21e; 22e; 21i; 22i; 21j; 22j; 21k; 22k), a moving contact (81, 82) corresponding thereto.

In a contact device (1; 1e; 1f; 1g; 1h; 1i; 1j; 1k) according to a forty-sixth aspect based on the forty-fifth aspect, the at least one bus bar (21; 22; 21a; 22a; 22b; 21c; 22c; 21e; 22e; 21i; 22i; 21j; 22j; 21k; 22k) includes a first bus bar (21; 21a; 21c; 21e; 21i; 21j; 21k) electrically connected to the first fixed terminal (31) and a second bus bar (22; 22a; 22b; 22c; 22e; 22i; 22j; 22k) electrically connected to the second fixed terminal (32). The first bus bar (21; 21a; 21c; 21e21i; 21j; 21k) includes at least one first electric path piece serving as at least one corresponding one of the at least one electric path piece (213; 213a; 213e; 215; 216; 213i; 213j; 214k). The second bus bar (22; 22a; 22b; 22c; 22e; 22i; 22j; 22k) includes at least one second electric path piece serving as at least one corresponding one of the at least one electric path piece (223; 223a; 223e; 225; 226; 223i; 223j; 224k).

According to this configuration, a force pressing the fixed contact (311; 321) by the moving contactor (8) can be increased.

In a contact device (1; 1e; 1f; 1g; 1h; 1i; 1j; 1k) according to a forty-seventh aspect based on the forty-sixth aspect, the moving contactor (8) is placed between the at least one first electric path piece of the first bus bar (21; 21a; 21c; 21e21i; 21j; 21k) and the at least one second electric path piece of the second bus bar (22; 22a; 22b; 22c; 22e; 22i; 22j; 22k) when viewed in one of the moving directions of the moving contactor (8).

According to this configuration, it is possible to press the moving contactor (8) against the fixed contact (311; 321) from opposite sides of the moving contactor (8).

In a contact device (1; 1e; 1f; 1g; 1h; 1i; 1j; 1k) according to a forty-eighth aspect based on any one of the forty-fifth to forty-seventh aspects, a length (L12; L13) of the at least one electric path piece (213; 223; 213a; 223a; 223b; 213e; 223e; 224b; 215; 216; 225; 226; 213i; 223i; 213j; 223j; 213k; 224k) is equal to or larger than a distance (L11) between the first moving contact (moving contact 81) and the second moving contact (moving contact 82) in the direction of the current (I) flowing through the moving contactor (8) when viewed in one of the moving directions of the moving contactor (8).

According to this configuration, a stronger repulsive force can be produced. Therefore, the moving contactor (8) can press the fixed contact (311; 321) with a stronger force.

In a contact device (1; 1e; 1f; 1g; 1h; 1i; 1j; 1k) according to a forty-ninth aspect based on any one of the thirty-eighth to forty-eighth aspects, the at least one bus bar (21; 22; 21a; 22a; 22b; 21c; 22c; 21e; 22e; 21i; 22i; 21j; 22j; 21k; 22k) further includes an extension piece defined as at least one additional electric path piece (212; 222; 212a; 222a; 222b; 212e; 222e; 217e; 227e; 212i; 222i; 214i; 224i; 212j; 222j; 217j; 227j; 212k; 222k; 215k; 225k) extending along a direction of a current (I) flowing through the at least one fixed terminal (31; 32). The extension piece allows the current (I) to flow therethrough in an opposite direction from the current (I) flowing through the at least one fixed terminal (31; 32).

According to this configuration, a force for separating the moving contactor (8) from the fixed contact (311; 321) can be made weaker.

In a contact device (1; 1e; 1f; 1g; 1h; 1i; 1j; 1k) according to a fiftieth aspect based on the forty-ninth aspect, a length (L22; L23) of the extension piece in a direction in which the extension piece extends is equal to or larger than a length (L21) from a part of the at least one fixed terminal (31; 32) connected to the at least one bus bar (21; 22; 21a; 22a; 22b; 21c; 22c; 21e; 22e; 21i; 22i; 21j; 22j; 21k; 22k) to a part of the at least one fixed terminal (31; 32) holding the at least one fixed contact (311; 321).

According to this configuration, a force for separating the moving contactor (8) from the fixed contact (311; 321) can be made weaker.

In a contact device (1; 1e; 1f; 1g; 1h; 1i; 1j; 1k) according to a fifty-first aspect based on the forty-ninth or fiftieth aspect, the at least one electric path piece (213; 223; 213a; 223a; 223b; 213e; 223e; 224b; 215; 216; 225; 226; 213i; 223i; 213j; 223j; 214k; 224k) is electrically connected to the at least one fixed terminal (31; 32) through the extension piece.

According to this configuration, a force pressing the fixed contact (311; 321) by the moving contactor (8) can be made stronger.

In a contact device (1; 1e; 1f; 1g; 1h; 1i; 1j; 1k) according to a fifty-second aspect based on any one of the forty-ninth to fifty-first aspects, the extension piece and the at least one fixed terminal (31; 32) overlap with each other when viewed in one of directions perpendicular to the direction of the current (I) flowing through the moving contactor (8) and the direction of the current (I) flowing through the at least one fixed terminal (31; 32).

According to this configuration, a force for separating the moving contactor (8) from the fixed contact (311; 321) can be made weaker.

In a contact device (1; 1e; 1f; 1g; 1h; 1i; 1j; 1k) according to a fifty-third aspect based on any one of the forty-ninth to fifty-first aspects, the extension piece and the at least one fixed terminal (31; 32) overlap with each other when viewed in one direction of the current (I) flowing through the moving contactor (8).

According to this configuration, a force for separating the moving contactor (8) from the fixed contact (311; 321) can be made weaker. Further, in the contact device (1; 1e; 1f; 1g; 1h; 1i; 1j; 1k), a width of the moving contactor (8) can be made shorter and thus downsizing can be realized.

A contact device (1e; 1j; 1k) according to a fifty-fourth aspect includes at least one fixed terminal (31; 32), a moving contactor (8), a case (4), and at least one bus bar (21e; 22e; 21j; 22j; 21k; 22k). The at least one fixed terminal (31; 32) holds at least one fixed contact (311; 321). The moving contactor (8) holds at least one moving contact (81; 82) and is movable between a closed position where the at least one moving contact (81; 82) is in contact with the at least one fixed contact (311; 321) and an open position where the at least one moving contact (81; 82) is separate from the at least one fixed contact (311; 321). The case (4) accommodates at least the at least one fixed contact (311; 321) and the moving contactor (8). The at least one bus bar 21e; 22e; 21j; 22j; 21k; 22k) is electrically connected to the at least one fixed terminal (31; 32). The at least one bus bar (21e; 22e; 21j; 22j; 21k; 22k) includes at least one electric path piece (218e; 228e; 218j; 228j; 216k; 226k) which extends along a direction of a current (I) flowing through the moving contactor (8). The at least one electric path piece (218e; 228e; 218j; 228j; 216k; 226k) is placed outside the case (4) to be positioned on a same side as the at least one fixed contact (311; 321) relative to the moving contactor (8) in the moving directions of the moving contactor (8) with the moving contactor (8) positioned in the closed position. The at least one electric path piece (213e; 223e; 213j; 223j; 214k; 224k) allows the current (I) to flow therethrough in a same direction as the current (I) flowing through the moving contactor (8).

According to this configuration, an attractive force is produced between the at least one electric path piece (218e; 228e; 218j; 228j; 216k; 226k) and the moving contactor (8). Therefore, a force component of the produced force directed to the fixed terminal (31; 32) causes an increase in a force pressing the fixed contact (311; 321) by the moving contactor (8). Therefore, it is possible to stabilize a connection state between the moving contact (81; 82) and the fixed contact (311; 321) in a case where an abnormal current flows through the contact device (1e).

If the substitution of the electric path piece (218e; 228e; 218j; 228j; 216k; 226k) of the contact device (1e; 1j; 1k) according to the fifty-fifth aspect for the electric path piece (213; 223; 213a; 223a; 223b; 213e; 223e; 224b; 215; 216; 225; 226; 213i; 223i; 213j; 213j; 214k; 224k) in the thirty-eighth to fifty-third aspects is possible without no contradiction, limitations of the thirty-eighth to fifty-third aspects may apply to the electric path piece (218e; 228e; 218j; 228j; 216k; 226k) of the contact device (1e; 1j; 1k) according to the fifty-fifth aspect.

A bus bar (21; 22; 21a; 22a; 22b; 21c; 22c; 21e; 22e; 21i; 22i; 21j; 22j; 21k; 22k) according to a fifty-fifth aspect is included in the contact device (1; 1e; 1f; 1g; 1h; 1i; 1j; 1k) according to any one of the thirty-eighth to fifty-fifth aspects.

According to this configuration, it is possible to stabilize a connection state between the moving contact (81; 82) and the fixed contact (311; 321) in a case where an abnormal current flows through the contact device (1; 1e; 1f; 1g; 1h; 1i; 1j; 1k).

An electromagnetic relay (100; 100e; 100f; 100g; 100i; 100j; 100k) according to a fifty-sixth aspect includes: the contact device (1; 1e; 1f; 1g; 1h; 1i; 1j; 1k) according to any one of the thirty-eighth to fifty-fourth aspects; and an electromagnet device (10) configured to move the moving contactor (8).

According to this configuration, it is possible to stabilize a connection state between the moving contact (81; 82) and the fixed contact (311; 321) in a case where an abnormal current flows through the contact device (1; 1e; 1f; 1g; 1h; 1i; 1j; 1k).

An electromagnetic relay (100; 100e; 100f; 100g; 100i; 100j; 100k) according to a fifty-seventh aspect includes the contact device (1; 1e; 1f; 1g; 1h; 1i; 1j) according to any one of the thirty-eighth to fifty-third aspects; and an electromagnet device (10) configured to move the moving contactor (8). The electromagnet device (10) includes an excitation coil (14) and a yoke (11) for forming part of a path for a magnetic flux developed at the excitation coil (14). The at least one electric path piece (213; 223; 213a; 223a; 223b; 213e; 223e; 224b; 215; 216; 225; 226; 213i; 223i; 213j; 223j) is positioned between the yoke (11) and the moving contactor (8) in the moving directions of the moving contactor (8) while the moving contactor (8) is in the closed position.

According to this configuration, it is possible to stabilize a connection state between the moving contact (81; 82) and the fixed contact (311; 321) in a case where an abnormal current flows, without affected by a magnetic flux developed at the yoke (11).

A contact device (1; 1e; 1f; 1g; 1h; 1i; 1j; 1k) according to a fifty-eighth aspect includes at least one fixed terminal (31; 32), a moving contactor (8), a case (4), at least one bus bar (21; 22; 21a; 22a; 22b; 21c; 22c; 21e; 22e; 21i; 22i; 21j; 22j; 21k; 22k), and a yoke (first yoke 6, 6d, yoke 6f). The at least one fixed terminal (31; 32) holds at least one fixed contact (311; 321). The moving contactor (8) holds at least one moving contact (81; 82) and is movable between a closed position where the at least one moving contact (81; 82) is in contact with the at least one fixed contact (311; 321) and an open position where the at least one moving contact (81; 82) is separate from the at least one fixed contact (311; 321). The case (4) accommodates at least the at least one fixed contact (311; 321) and the moving contactor (8). The at least one bus bar (21; 22; 21a; 22a; 22b; 21c; 22c; 21e; 22e; 21i; 22i; 21j; 22j; 21k; 22k) is electrically connected to the at least one fixed terminal (31; 32). At least part of the yoke is positioned in a same side as the at least one fixed contact (311; 321) relative to the moving contactor (8) in the moving directions of the moving contactor (8). The at least one bus bar (21; 22; 21a; 22a; 22b; 21c; 22c; 21e; 22e; 21i; 22i; 21j; 22j; 21k; 22k) includes at least one electric path piece (213; 223; 213a; 223a; 223b; 213e; 223e; 224b; 215; 216; 225; 226; 213i; 223i; 213j; 223j; 214k; 224k) which extends along a direction of a current (I) flowing through the moving contactor (8). The at least one electric path piece (213; 223; 213a; 223a; 223b; 213e; 223e; 224b; 215; 216; 225; 226; 213i; 223i; 213j; 223j; 214k; 224k) is placed outside the case (4) to allow the moving contactor (8) to be positioned between the at least one electric path piece (213; 223; 213a; 223a; 223b; 213e; 223e; 224b; 215; 216; 225; 226; 213i; 223i; 213j; 223j; 214k; 224k) and the at least one fixed contact (311; 321) in moving directions of the moving contactor (8) with the moving contactor (8) positioned in the closed position. The at least one electric path piece (213; 223; 213a; 223a; 223b; 213e; 223e; 224b; 215; 216; 225; 226; 213i; 223i; 213j; 223j; 214k; 224k) allows the current (I) to flow therethrough in an opposite direction from the current (I) flowing through the moving contactor (8).

According to this configuration, a repulsive force is produced between the electric path piece (213; 223) and the moving contactor (8). Therefore, a force component of the produced repulsive force directed to the fixed terminal (31; 32) causes an increase in a force pressing the fixed contact (311; 321) by the moving contactor (8). Therefore, it is possible to stabilize a connection state between the moving contact (81; 82) and the fixed contact (311; 321) in a case where an abnormal current flows through the contact device (1; 1e; 1f; 1g; 1h).

Additionally, provision of the yoke allows an upward Lorentz force to act on the moving contactor (8). Therefore, it is possible to stabilize a connection state between the moving contact (81; 82) and the fixed contact (311; 321) in a case where an abnormal current flows through the contact device (1; 1e; 1f; 1g; 1h;).

In a contact device (1; 1e; 1f; 1g; 1h; 1i; 1j; 1k) according to a fifty-ninth aspect based on the fifty-eighth aspect, the at least one bus bar (21; 22; 21a; 22a; 22b; 21c; 22c; 21e; 22e; 21i; 22i; 21j; 22j; 21k; 22k) is mechanically connected to the at least one fixed terminal (31; 32).

According to this configuration, it is possible to produce a repulsive force by use of a current flowing through the device itself.

In a contact device (1; 1e; 1f; 1g; 1h) according to a sixtieth aspect based on the fifty-eighth or fifty-ninth aspect, the at least one fixed terminal (31; 32) includes a first fixed terminal (31) and a second fixed terminal (32). The at least one fixed contact (311; 321) includes a first fixed contact (311) held by the first fixed terminal (31) and a second fixed contact (321) held by the second fixed terminal (32). The at least one moving contact (81; 82) includes a first moving contact (moving contact 81) and a second moving contact (moving contact 82) which are in contact with the first fixed contact (311) and the second fixed contact (321) respectively while the moving contactor (8) is in the closed position. The at least one bus bar (21; 22; 21a; 22a; 22b; 21c; 22c; 21e; 22e; 21i; 22i; 21j; 22j; 21k; 22k) includes a first bus bar (21; 21a; 21c; 21e; 21i; 21j; 21k) electrically connected to the first fixed terminal (31) and a second bus bar (22; 22a; 22b; 22c; 22e; 22i; 22j; 22k) electrically connected to the second fixed terminal (32). The first bus bar (21; 21a; 21c; 21e21i; 21j; 21k) includes at least one first electric path piece serving as at least one corresponding one of the at least one electric path piece 213; 213a; 213e; 215; 216; 213i; 213j; 214k). The second bus bar (22; 22a; 22b; 22c; 22e; 22i; 22j; 22k) includes at least one second electric path piece serving as at least one corresponding one of the at least one electric path piece (223; 223a; 223e; 225; 226; 223i; 223j; 224k).

According to this configuration, it is possible to press, against a fixed contact (311, 321) of a fixed terminal (31, 32) electrically connected to the bus bar (21; 22; 21a; 22a; 22b; 21c; 22c; 21e; 22e), a moving contact (81, 82) corresponding thereto.

In a contact device (1; 1e; 1f; 1g; 1h; 1i; 1j; 1k) according to a sixty-first aspect based on any one of the fifty-eighth to sixty-first aspects, the yoke (first yoke 6, 6d, yoke 6f) and the moving contactor (8) are separated by a predetermined interval (L1) while the moving contactor (8) is positioned in the closed position.

According to this configuration, electric insulation between the moving contactor (8) and the yoke can be made certainly.

In a contact device (1; 1e; 1f; 1g; 1h; 1i; 1j; 1k) according to a sixty-second aspect based on any one of the fifty-eighth to sixty-first aspects, the yoke is movable along directions same as the moving directions of the moving contactor (8).

According to this configuration, it is possible to move the yoke and make an upward Lorentz force act on the moving contactor (8) with movement of the yoke.

In a contact device (1; 1e; 1f; 1g; 1h; 1i; 1j; 1k) according to a sixty-third aspect based on any one of the fifty-eighth to sixty-first aspect, the yoke is in a position fixed relative to the case (4).

According to this configuration, it is possible to move the yoke and make an upward Lorentz force act on the moving contactor (8) with movement of the yoke.

In a contact device (1; 1e; 1f; 1g; 1h; 1i; 1j; 1k) according to a sixty-fourth aspect according to any one of the fifty-eighth to sixty-third aspects, the yoke includes protrusions (61f; 62f) protruding from opposite ends in a direction perpendicular to both the direction of the current (I) flowing through the moving contactor (8) and the moving directions of the moving contactor (8), in a direction opposite from a direction of movement of the moving contactor (8) from the open position to the closed position.

According to this configuration, a magnetic flux produced as the electric path piece (213; 223; 213a; 223a; 223b; 213e; 223e; 224b; 215; 216; 225; 226; 213i; 223i; 213j; 223j; 214k; 224k) can be concentrated certainly.

A contact device (1; 1e; 1f; 1g; 1h; 1i; 1j; 1k) according to a sixty-fifth aspect based on any one of the fifty-eighth to sixty-fourth aspects further includes a second yoke (7) different from the first yoke (6; 6d) serving as the yoke. At least part of the second yoke (7) is positioned in an opposite side from the at least one fixed contact (311; 321) relative to the moving contactor (8) in the moving directions of the moving contactor (8).

According to this configuration, due to a magnetic force produced between the first yoke (6; 6d) and the second yoke (7), it is possible to stabilize a connection state between the moving contact (81; 82) and the fixed contact (311; 321) in a case where an abnormal current flows through the contact device (1; 1e; 1f; 1g; 1h; 1i; 1j; 1k).

In a contact device (1; 1e; 1f; 1g; 1h; 1i; 1j; 1k) according to a sixty-sixth aspect based on the sixty-fifth aspect, the second yoke (7) is in a position fixed relative to the moving contactor (8).

According to this configuration, it is possible to fix a position of the second yoke (7) relative to the moving contactor (8) and to stabilize a connection state between the moving contact (81; 82) and the fixed contact (311; 321) in a case where an abnormal current flows.

In a contact device (1; 1e; 1f; 1g; 1h; 1i; 1j; 1k) according to a sixty-seventh aspect based on the sixty-sixth aspect, the second yoke (7) is electrically insulated from the moving contactor (8).

According to this configuration, it is possible to stabilize a connection state between the moving contact (81; 82) and the fixed contact (311; 321) in a case where an abnormal current flows.

In a contact device (1; 1e; 1f; 1g; 1h; 1i; 1j; 1k) according to a sixty-eighth aspect according to the sixty-sixth or sixty-seventh aspect, the second yoke includes protrusions (72; 73) protruding from opposite ends in a direction perpendicular to both the direction of the current (I) flowing through the moving contactor (8) and the moving directions of the moving contactor (8), in a direction same as a direction of movement of the moving contactor (8) from the open position to the closed position.

According to this configuration, due to the protrusions (72; 73), the distance from the second yoke (7) to the first yoke (6; 6d) is decreased, and thus secure attraction can be realized by a magnetic force produced between the first yoke (6; 6d) and the second yoke (7).

A contact device (1; 1e; 1f; 1g; 1h; 1i; 1j; 1k) according to a sixty-ninth aspect based on any one of the fifty-eighth to sixty-eighth aspects further includes an arc extinction magnet (25; 26; 25g; 26g) which is placed outside the case (4) and is for stretching an arc developed between the at least one moving contact (81; 82) and the at least one fixed contact (311; 321) when the moving contactor (8) moves from the closed position to the open position.

According to this configuration, it is possible to stretch an arc produced between the fixed contact (311; 321) and the moving contact (81; 82).

A contact device (1e; 1j; 1k) according to a seventieth aspect includes at least one fixed terminal (31; 32), a moving contactor (8), a case (4), at least one bus bar (21e; 22e), and a yoke (first yoke 6, 6d). The at least one fixed terminal (31; 32) holds at least one fixed contact (311; 321). The moving contactor (8) holds at least one moving contact (81; 82) and is movable between a closed position where the at least one moving contact (81; 82) is in contact with the at least one fixed contact (311; 321) and an open position where the at least one moving contact (81; 82) is separate from the at least one fixed contact (311; 321). The case (4) accommodates at least the at least one fixed contact (311; 321) and the moving contactor (8). The at least one bus bar (21e; 22e; 21j; 22j; 21k; 22k) is electrically connected to the at least one fixed terminal (31; 32). At least part of the yoke is positioned in a same side as the at least one fixed contact (311; 321) relative to the moving contactor (8) in the moving directions of the moving contactor (8). The at least one bus bar (21e; 22e; 21j; 22j; 21k; 22k) includes at least one electric path piece (218e; 228e; 218j; 228j; 216k; 226k) which extends along a direction of a current (I) flowing through the moving contactor (8). The at least one electric path piece (218e; 228e; 218j; 228j; 216k; 226k) is placed outside the case (4) to be positioned on a same side as the at least one fixed contact (311; 321) relative to the moving contactor (8) in the moving directions of the moving contactor (8) with the moving contactor (8) positioned in the closed position. The at least one electric path piece (218e; 228e; 218j; 228j; 216k; 226k) allows the current (I) to flow therethrough in a same direction as the current (I) flowing through the moving contactor (8).

According to this configuration, an attractive force is produced between the at least one electric path piece (218e; 228e; 218j; 228j; 216k; 226k) and the moving contactor (8). Therefore, a force component of the produced force directed to the fixed terminal (31; 32) causes an increase in a force pressing the fixed contact (311; 321) by the moving contactor (8). Therefore, it is possible to stabilize a connection state between the moving contact (81; 82) and the fixed contact (311; 321) in a case where an abnormal current flows through the contact device (1e).

If the substitution of the electric path piece (218e; 228e; 218j; 228j; 216k; 226k) of the contact device (1e; 1j; 1k) according to the seventieth aspect for the electric path piece (213; 223; 213a; 223a; 223b; 213e; 223e; 224b; 215; 216; 225; 226; 213i; 223i; 213j; 213j; 214k; 224k) in the fifty-ninth to sixty-ninth aspects is possible without no contradiction, limitations of the fifty-ninth to sixty-ninth aspects may apply to the electric path piece (218e; 228e; 218j; 228j; 216k; 226k) of the contact device (1e; 1j; 1k) according to the seventieth aspect.

An electromagnetic relay (100; 100e; 100f; 100g; 100i; 100j; 100k) according to a seventy-first aspect includes: the contact device (1; 1e; 1f; 1g; 1h) according to any one of the fifty-eighth to seventieth aspects; and an electromagnet device (10) configured to move the moving contactor (8).

According to this configuration, it is possible to stabilize a connection state between the moving contact (81; 82) and the fixed contact (311; 321) in a case where an abnormal current flows through the contact device (1; 1e; 1f; 1g; 1h; 1i; 1j; 1k).

An electromagnetic relay (100; 100e; 100f; 100g; 100i; 100j; 100k) according to a seventy-second aspect includes the contact device (1; 1e; 1f; 1g; 1h; 1i; 1j; 1k) according to any one of the fifty-eighth to sixty-ninth aspects; and an electromagnet device (10) configured to move the moving contactor (8). The electromagnet device 10) includes an excitation coil (14) and a yoke (11) for forming part of a path for a magnetic flux developed at the excitation coil (14). The at least one electric path piece (213; 223; 213a; 223a; 223b; 213e; 223e; 224b; 215; 216; 225; 226; 213i; 223i; 213j; 223j; 214k; 224k) is positioned between the yoke (11) and the moving contactor (8) in the moving directions of the moving contactor (8) while the moving contactor (8) is in the closed position.

According to this configuration, it is possible to stabilize a connection state between the moving contact (81; 82) and the fixed contact (311; 321) in a case where an abnormal current flows, without affected by a magnetic flux developed at the yoke (11).

A contact device (1; 1e; 1f; 1g; 1h; 1i; 1j; 1k) according to a seventy-third aspect includes at least one fixed terminal (31; 32), a moving contactor (8), a case (4), at least one bus bar (21; 22; 21a; 22a; 22b; 21c; 22c; 21e; 22e; 21i; 22i; 21j; 22j; 21k; 22k), and at least one arc extinction magnet (25; 26; 25g; 26g). The at least one fixed terminal (31; 32) holds at least one fixed contact (311; 321). The moving contactor (8) holds at least one moving contact (81; 82) and is movable between a closed position where the at least one moving contact (81; 82) is in contact with the at least one fixed contact (311; 321) and an open position where the at least one moving contact (81; 82) is separate from the at least one fixed contact (311; 321). The case (4) accommodates at least the at least one fixed contact (311; 321) and the moving contactor (8). The at least one bus bar (21; 22; 21a; 22a; 22b; 21c; 22c; 21e; 22e; 21i; 22i; 21j; 22j; 21k; 22k) is electrically connected to the at least one fixed terminal (31; 32). The at least one arc extinction magnet (25; 26; 25g; 26g) is placed outside the case (4) and is for stretching an arc developed between the at least one moving contact (81; 82) and the at least one fixed contact (31; 32) when the moving contactor (8) moves from the closed position to the open position. The at least one bus bar (21; 22; 21a; 22a; 22b; 21c; 22c; 21e; 22e; 21i; 22i; 21j; 22j; 21k; 22k) includes at least one electric path piece (213; 223; 213a; 223a; 223b; 213e; 223e; 224b; 215; 216; 225; 226; 213i; 223i; 213j; 223j; 214k; 224k) which extends along a direction of a current (I) flowing through the moving contactor (8). The at least one electric path piece (213; 223; 213a; 223a; 223b; 213e; 223e; 224b; 215; 216; 225; 226; 213i; 223i; 213j; 223j; 214k; 224k) is placed outside the case (4) to allow the moving contactor (8) to be positioned between the at least one electric path piece (213; 223; 213a; 223a; 223b; 213e; 223e; 224b; 215; 216; 225; 226; 213i; 223i; 213j; 223j; 214k; 224k) and the at least one fixed contact (311; 321) in moving directions of the moving contactor (8) with the moving contactor (8) positioned in the closed position. The at least one electric path piece (213; 223; 213a; 223a; 223b; 213e; 223e; 224b; 215; 216; 225; 226; 213i; 223i; 213j; 223j; 214k; 224k) allows the current (I) to flow therethrough in an opposite direction from the current (I) flowing through the moving contactor (8).

According to this configuration, a repulsive force is produced between the at least one electric path piece (213; 223) and the moving contactor (8). Therefore, a force component of the produced repulsive force directed to the fixed terminal (31; 32) causes an increase in a force pressing the fixed contact (311; 321) by the moving contactor (8). Therefore, it is possible to stabilize a connection state between the moving contact (81; 82) and the fixed contact (311; 321) in a case where an abnormal current flows through the contact device (1; 1e; 1f; 1g; 1h).

Additionally, it is possible to extinguish an arc produced between the fixed contact (311; 321) and the moving contact (81; 82).

In a contact device (1; 1e; 1f; 1g; 1h; 1i; 1j; 1k) according to a seventy-fourth aspect based on the seventy-third aspect, the at least one bus bar (21; 22; 21a; 22a; 22b; 21c; 22c; 21e; 22e; 21i; 22i; 21j; 22j; 21k; 22k) is mechanically connected to the at least one fixed terminal (31; 32).

According to this configuration, it is possible to produce a repulsive force by use of a current flowing through the device itself.

In a contact device (1; 1e; 1f; 1g; 1h; 1i; 1j; 1k) according to a seventy-fifth aspect based on the seventy-third or seventy-fourth aspect, the at least one fixed terminal (31; 32) includes a first fixed terminal (31) and a second fixed terminal (32). The at least one fixed contact (31; 32) includes a first fixed contact (311) held by the first fixed terminal (31) and a second fixed contact (321) held by the second fixed terminal (32). The at least one moving contact (81; 82) includes a first moving contact (moving contact 81) and a second moving contact (moving contact 82) which are in contact with the first fixed contact (311) and the second fixed contact (321) respectively while the moving contactor (8) is in the closed position. The at least one bus bar (21; 22; 21a; 22a; 22b; 21c; 22c; 21e; 22e; 21i; 22i; 21j; 22j; 21k; 22k) includes a first bus bar (21; 21a; 21c; 21e21i; 21j; 21k) electrically connected to the first fixed terminal (31) and a second bus bar (22; 22a; 22b; 22c; 22e; 22i; 22j; 22k) electrically connected to the second fixed terminal (32). The first bus bar (21; 21a; 21c; 21e21i; 21j; 21k) includes at least one first electric path piece serving as at least one corresponding one of the at least one electric path piece 213; 213a; 213e; 215; 216; 213i; 213j; 214k). The second bus bar (22; 22a; 22b; 22c; 22e; 22i; 22j; 22k) includes at least one second electric path piece serving as at least one corresponding one of the at least one electric path piece (223; 223a; 223e; 225; 226; 223i; 223j; 224k). The at least one arc extinction magnet (25; 26; 25g; 26g) includes a first arc extinction magnet (25; 25g) and a second arc extinction magnet (26; 26g). The first arc extinction magnet (25; 25g) is for extinguishing an arc developed between the first moving contact and the fixed contact (311) of the first fixed terminal (31). The second arc extinction magnet (26; 26g) is for extinguishing an arc developed between the second moving contact and the second contact (321) of the second fixed terminal (32).

According to this configuration, it is possible to press, against a fixed contact (311, 321) of a fixed terminal (31, 32) electrically connected to the bus bar (21; 22; 21a; 22a; 22b; 21c; 22c; 21e; 22e; 21i; 22i; 21j; 22j; 21k; 22k), a moving contact (81, 82) corresponding thereto.

In a contact device (1; 1e; 1f; 1g; 1h; 1i; 1j; 1k) according to a seventy-sixth aspect based on any one of the seventy-third to seventy-fifth aspects, the at least one arc extinction magnet (25; 26; 25g; 26g) is placed on a line extending in the direction of the current (I) flowing through the moving contactor (8).

According to this configuration, a width of the moving contactor (8) can be made shorter and thus downsizing can be realized.

In a contact device (1; 1e; 1f; 1g; 1h; 1i; 1j; 1k) according to a seventy-seventh aspect based on any one of the seventy-third to seventy-fifth aspects, the at least one arc extinction magnet (25; 26; 25g; 26g) is placed to make a direction from the at least one arc extinction magnet (25; 26; 25g; 26g) to the at least one fixed contact (311; 321) different from the direction of the current (I) flowing through the moving contactor (8) when viewed in one of the moving directions of the moving contactor (8).

According to this configuration, it is possible to extinguish an arc produced between the fixed contact (311; 321) and the moving contact (81; 82).

In a contact device (1; 1e; 1f; 1g; 1h; 1i; 1j; 1k) according to a seventy-eighth aspect based on the seventy-seventh aspect, the at least one arc extinction magnet (25; 26; 25g; 26g) and the at least one electric path piece (213; 223; 213a; 223a; 223b; 213e; 223e; 224b; 215; 216; 225; 226; 213i; 223i; 213j; 223j; 214k; 224k) are arranged in this order along a direction of a current (I) flowing through the at least one fixed terminal (31; 32).

According to this configuration, it is possible to reduce probabilities of occurrence of interaction between a Lorentz force for extinction of an arc and a repulsive force between the electric path piece (213; 223; 213a; 223a; 223b; 213e; 223e; 224b; 215; 216; 225; 226; 213i; 223i; 213j; 223j; 214k; 224k) and the moving contactor (8).

In a contact device (1; 1e; 1f; 1g; 1h; 1i; 1j; 1k) according to a seventy-ninth aspect based on the seventy-seventh aspect, the at least one electric path piece (213; 223; 213a; 223a; 223b; 213e; 223e; 224b; 215; 216; 225; 226; 213i; 223i; 213j; 223j; 214k; 224k) is positioned between the at least one arc extinction magnet (25; 26; 25g; 26g) and the moving contactor (8) when viewed in one of the moving directions of the moving contactor (8).

According to this configuration, a repulsive force between the electric path piece (213; 223; 213a; 223a; 223b; 213e; 223e; 224b; 215; 216; 225; 226; 213i; 223i; 213j; 223j; 214k; 224k) and the moving contactor (8) can be made stronger.

A contact device (1; 1e; 1f; 1g; 1h; 1i; 1j; 1k) according to an eightieth aspect based on any one of the seventy-third to seventy-ninth aspects further includes a magnet yoke (23; 24; 23g; 24g; 25g; 26g) connected to the at least one arc extinction magnet (25; 26; 25g; 26g).

According to this configuration, a path for a magnetic flux produced by the arc extinction magnet (25; 26; 25g; 26g) can be made.

In a contact device (1; 1e; 1f; 1g; 1h; 1i; 1j; 1k) according to an eighty-first aspect based on the eightieth aspect, the at least one electric path piece (213; 223; 213a; 223a; 223b; 213e; 223e; 224b; 215; 216; 225; 226; 213i; 223i; 213j; 223j; 214k; 224k) is positioned between the magnet yoke (23; 24; 23g; 24g; 25g; 26g) and the case (4) when viewed in one of the moving directions of the moving contactor (8).

According to this configuration, a repulsive force between the electric path piece (213; 223; 213a; 223a; 223b; 213e; 223e; 224b; 215; 216; 225; 226; 213i; 223i; 213j; 223j; 214k; 224k) and the moving contactor (8) can be made stronger.

A contact device (1e; 1j; 1k) according to an eighty-second aspect includes at least one fixed terminal (31; 32), a moving contactor (8), a case (4), at least one bus bar (21e; 22e; 21j22j; 21k; 22k), and at least one arc extinction magnet (25; 26; 25g; 26g). The at least one fixed terminal (31; 32) holds at least one fixed contact (311; 321). The moving contactor (8) holds at least one moving contact (81; 82) and is movable between a closed position where the at least one moving contact (81; 82) is in contact with the at least one fixed contact (311; 321) and an open position where the at least one moving contact (81; 82) is separate from the at least one fixed contact (311; 321). The case (4) accommodates at least the at least one fixed contact (311; 321) and the moving contactor (81; 82). The at least one bus bar (21e; 22e) is electrically connected to the at least one fixed terminal (31; 32). The at least one arc extinction magnet is placed outside the case (4) and is for stretching an arc developed between the at least one moving contact (81; 82) and the at least one fixed contact (31; 32) when the moving contactor (8) moves from the closed position to the open position. The at least one bus bar (21e; 22e) includes at least one electric path piece (218e; 228e; 218j; 228j; 216k; 226k) which extends along a direction of a current (I) flowing through the moving contactor (8). The at least one electric path piece (218e; 228e; 218j; 228j; 216k; 226k) is placed outside the case (4) to be positioned on a same side as the at least one fixed contact (311; 321) relative to the moving contactor (8) in the moving directions of the moving contactor (8) with the moving contactor (8) positioned in the closed position. The at least one electric path piece (218e; 228e; 218j; 228j; 216k; 226k) allows the current (I) to flow therethrough in a same direction as the current (I) flowing through the moving contactor (8).

According to this configuration, an attractive force is produced between the at least one electric path piece (218e; 228e; 218j; 228j; 216k; 226k) and the moving contactor (8). Therefore, a force component of the produced force directed to the fixed terminal (31; 32) causes an increase in a force pressing the fixed contact (311; 321) by the moving contactor (8). Therefore, it is possible to stabilize a connection state between the moving contact (81; 82) and the fixed contact (311; 321) in a case where an abnormal current flows through the contact device (1e).

If the substitution of the electric path piece (218e; 228e; 218j; 228j; 216k; 226k) of the contact device (1e; 1j; 1k) according to the eighty-second aspect for the electric path piece (213; 223; 213a; 223a; 223b; 213e; 223e; 224b; 215; 216; 225; 226; 213i; 223i; 213j; 213j; 214k; 224k) in the fifty-ninth to sixty-ninth aspects is possible without no contradiction, limitations of the fifty-ninth to sixty-ninth aspects may apply to the electric path piece (218e; 228e; 218j; 228j; 216k; 226k) of the contact device (1e; 1j; 1k) according to the eighty-second aspect.

An electromagnetic relay (100; 100e; 100f; 100g; 100i; 100j; 100k) according to an eighty-third aspect includes: the contact device (1; 1e; 1f; 1g; 1h; 1i; 1j; 1k) according to any one of the seventy-third to eighty-second aspects; and an electromagnet device (10) configured to move the moving contactor (8).

According to this configuration, it is possible to stabilize a connection state between the moving contact (81; 82) and the fixed contact (311; 321) in a case where an abnormal current flows through the contact device (1; 1e; 1f; 1g; 1h; 1i; 1j; 1k).

An electromagnetic relay (100; 100e; 100f; 100g; 100i; 100j; 100k) according to an eighty-fourth aspect includes the contact device (1; 1e; 1f; 1g; 1h; 1i; 1j; 1k) according to any one of the seventy-third to eighty-first aspects; and an electromagnet device (10) configured to move the moving contactor (8). The electromagnet device (10) includes an excitation coil (14) and a yoke (11) for forming part of a path for a magnetic flux developed at the excitation coil (14). The at least one electric path piece (213; 223; 213a; 223a; 223b; 213e; 223e; 224b; 215; 216; 225; 226; 213i; 223i; 213j; 223j; 214k; 224k) is positioned between the yoke (11) and the moving contactor (8) in the moving directions of the moving contactor (8) while the moving contactor (8) is in the closed position.

According to this configuration, it is possible to stabilize a connection state between the moving contact (81; 82) and the fixed contact (311; 321) in a case where an abnormal current flows, without affected by a magnetic flux developed at the yoke (11).

### REFERENCE SIGNS LIST

1, 1e, 1f, 1g, 1h, 1i, 1j, 1k Contact Device
4 Case
6, 6d First Yoke (Yoke)
6f Yoke
7 Second Yoke
8 Moving Contactor
10 Electromagnet Device
11 Yoke
14 Excitation Coil
21, 22, 21a, 22a, 22b, 21c, 22c, 21e, 22e, 21i, 22i, 21j, 22j, 21k, 22k Bus Bar (Electrically Conductive Member)
23, 23g, 24, 24g Capsule Yoke (Yoke)
25, 25g, 26, 26g Arc Extinction Magnet
31 Fixed Terminal (First Fixed Terminal)
32 Fixed Terminal (Second Fixed Terminal)
81 Moving Contact (First Moving Contact)
82 Moving Contact (Second Moving Contact)
100, 100e, 100f, 100g, 100i, 100j, 100k Electromagnetic Relay
212e, 222e, 212j, 222j, 212k, 222k Electric Path Piece (Extension Piece, First Extension Piece)
217e, 227e, 217j, 227j, 215k, 225k Electric Path Piece (Extension Piece, Second Extension Piece)
212, 222, 212a, 222a, 222b, 212i, 222i, 214i, 224i Electric Path Piece (Extension Piece)
213, 213a, 213e, 215, 216, 213i, 213j, 214k Electric Path Piece (Reverse Electric Path Piece)
223, 223a, 223b, 223e, 224b, 225, 226, 223i, 223j, 224k Electric Path Piece (Reverse Electric Path Piece)
218e, 228e, 218j, 228j, 216k, 226k Electric Path Piece (Forward Electric Path Piece)
311, 321 Fixed Contact
I Current
L11 Distance
L12, L13, L21, L22, L23 Length
M3, M3a Housing
M21, M22, M21a, M22a Electrically Conductive Bar (Electrically Conductive Member)

1. A contact device comprising:
at least one fixed terminal including at least one fixed contact;
a moving contactor which includes at least one moving contact and is movable between a closed position where the at least one moving contact is in contact with the at least one fixed contact and an open position where the at least one moving contact is separate from the at least one fixed contact;
a case accommodating at least the at least one fixed contact and the moving contactor; and
at least one bus bar electrically connected to the at least one fixed terminal,
the at least one bus bar including at least one electric path piece selected from a group consisting of at least one reverse electric path piece and at least one forward electric path piece which extend along a direction of a current flowing through the moving contactor,
the at least one reverse electric path piece being placed outside the case to allow the moving contactor to be positioned between the at least one reverse electric path piece and the at least one fixed contact in moving directions of the moving contactor with the moving contactor positioned in the closed position,
the at least one reverse electric path piece allowing the current to flow therethrough in an opposite direction from the current flowing through the moving contactor,
the at least one forward electric path piece being placed outside the case to be positioned on a same side as the at least one fixed contact relative to the moving contactor in the moving directions of the moving contactor with the moving contactor positioned in the closed position,
the at least one forward electric path piece allowing the current to flow therethrough in a same direction as the current flowing through the moving contactor.

2. The contact device according to claim 1, wherein
the at least one bus bar includes both of the at least one reverse electric path piece and the at least one forward electric path piece, and
the at least one reverse electric path piece and the at least one forward electric path piece are connected to each other.

3. The contact device according to claim 2, wherein
the at least one reverse electric path piece and the at least one forward electric path piece are positioned on a same side relative to the moving contactor when viewed in one of the moving directions of the moving contactor.

4. The contact device according to claim 2, wherein
the moving contactor is positioned between the at least one reverse electric path piece and the at least one forward electric path piece when viewed in one of the moving directions of the moving contactor.

5. The contact device according to claim 1, wherein
the at least one fixed contact is provided to a first end of the at least one fixed terminal and the at least one bus bar is fixed to a second end of the at least one fixed terminal.

6. The contact device according to claim 1, wherein
the at least one fixed terminal includes a first fixed terminal and a second fixed terminal,
the at least one fixed contact includes a first fixed contact provided to the first fixed terminal and a second fixed contact provided to the second fixed terminal,
the at least one moving contact includes a first moving contact and a second moving contact which are in contact with the first fixed contact and the second fixed contact respectively while the moving contactor is in the closed position, and
the at least one bus bar is electrically connected to at least one fixed terminal selected from a group consisting of the first fixed terminal and the second fixed terminal.

7. The contact device according to claim 6, wherein
the at least one bus bar includes the at least one forward electric path piece, the at least one reverse electric path piece, and an interconnection piece interconnecting the at least one forward electric path piece and the at least one reverse electric path piece, and
the interconnection piece is placed outside the case and placed on one side of the case in a direction in which the first fixed contact and the second fixed contact are arranged.

8. The contact device according to claim 2, wherein
the at least one bus bar includes at least one forward electric path piece, the at least one reverse electric path piece, and an interconnection piece interconnecting the at least one forward electric path piece and the at least one reverse electric path piece, and
the at least one forward electric path piece, the at least one reverse electric path piece, and the interconnection piece are placed on a same side relative to the moving contactor when viewed in one of the moving directions of the moving contactor.

9. The contact device according to claim 6, wherein
the at least one bus bar includes a first bus bar electrically connected to the first fixed terminal and a second bus bar electrically connected to the second fixed terminal,
the first bus bar includes a first electric path piece serving as at least one corresponding one of the at least one electric path piece, and
the second bus bar includes a second electric path piece serving as at least one corresponding one of the at least one electric path piece.

10. The contact device according to claim 9, wherein
the moving contactor is placed between the first electric path piece and the second electric path piece when viewed in one of the moving directions of the moving contactor.

11. The contact device according to claim 9, wherein
the at least one bus bar includes a first portion overlapping with the first fixed contact and a second portion connected to the first portion and overlapping with the second fixed contact in a direction perpendicular to a direction in which the first fixed contact and the second fixed contact are arranged when viewed in one of the moving directions of the moving contactor.

12. The contact device according to claim 11, wherein
the at least one bus bar includes the at least one forward electric path piece.

13. The contact device according to claim 1, wherein
the at least one bus bar includes: the at least one reverse electric path piece; and a first extension piece and a second extension piece which extend along the moving directions of the moving contactor and placed outside the case,
the first extension piece and the second extension piece each include a portion in a same side as the at least one fixed contact and a portion in an opposite side from the at least one fixed contact, relative to the moving contactor in the moving directions of the moving contactor while the moving contactor is in the closed position,
the first extension piece and the second extension piece are interconnected by the at least one reverse electric path piece and placed in a same side as the at least one fixed contact relative to the at least one reverse electric path piece in the moving directions of the moving contactor, or
the first extension piece and the second extension piece are interconnected by the at least one forward electric path piece and placed in a same side as the at least one fixed contact relative to the at least one forward electric path piece in the moving directions of the moving contactor.

14. The contact device according to claim 13, wherein
at least one of the first extension piece and the second extension piece is in a same side as the at least one reverse electric path piece relative to the moving contactor when viewed in one of the moving directions of the moving contactor while the first extension piece and the second extension piece are positioned in a same side as the at least one fixed contact relative to the at least one reverse electric path piece in the moving directions of the moving contactor.

15. The contact device according to claim 1, wherein
the at least one bus bar includes two electric path pieces of a plurality of the electric path pieces, and
the moving contactor is placed between the two electric path pieces when viewed in one of the moving directions of the moving contactor.

16. The contact device according to claim 1, wherein
the case includes a non-magnetic portion made of a non-magnetic material, and
the at least one forward electric path piece or the at least one reverse electric path piece faces the non-magnetic portion.

17. The contact device according to claim 1, further comprising an arc extinction magnet for stretching an arc developed between the at least one moving contact and the at least one fixed contact when the moving contactor moves from the closed position to the open position.

18. The contact device according to claim 17, wherein
at least part of the at least one electric path piece does not overlap with the arc extinction magnet when viewed in a direction perpendicular to the moving directions of the moving contactor and the direction of the current flowing through the moving contactor.

19. The contact device according to claim 17 or 18, wherein
the arc extinction magnet is placed on a line extending in the direction of the current flowing through the moving contactor, or
the arc extinction magnet is placed to make a direction from the arc extinction magnet to the at least one fixed contact different from the direction of the current flowing through the moving contactor when viewed in one of the moving directions of the moving contactor.

20. The contact device according to claim 17, wherein
the at least one bus bar further includes an extension piece extending along the moving directions of the moving contactor, and
the extension piece is present between the arc extinction magnet and the case when viewed in one of the moving directions of the moving contactor.

21. The contact device according to claim 17, further comprising a magnet yoke magnetically coupled with the arc extinction magnet to form part of a path for a magnetic flux of the arc extinction magnet.

22. The contact device according to claim 21, wherein
the at least one electric path piece is positioned between the magnet yoke and the case when viewed in one of the moving directions of the moving contactor.

23. The contact device according to claim 21, wherein
the magnet yoke includes an extended portion extending along the direction of the current flowing through the moving contactor, and
at least part of the at least one electric path piece does not overlap with the extended portion of the magnet yoke when viewed in a direction perpendicular to the moving directions of the moving contactor and the direction of the current flowing through the moving contactor.

24. The contact device according to claim 21, wherein
the at least one bus bar further includes an extension piece extending along the moving directions of the moving contactor, and
the extension piece is present between the magnet yoke and the case when viewed in one of the moving directions of the moving contactor.

25. The contact device according to claim 1, further comprising:
a yoke at least part of which is positioned in a same side as the at least one fixed contact relative to the moving contactor in the moving directions of the moving contactor; or
a first yoke serving as the yoke, and a second yoke which is different from the first yoke and at least part of which is positioned in an opposite side from the at least one fixed contact relative to the moving contactor in the moving directions of the moving contactor.

26. An electromagnetic relay comprising:
the contact device according to claim 1; and
an electromagnet device configured to move the moving contactor,
the electromagnet device including
an excitation coil, and
a yoke for forming part of a path for a magnetic flux developed at the excitation coil,
the at least one reverse electric path piece being positioned between the yoke and the moving contactor in the moving directions of the moving contactor while the moving contactor is in the closed position when the at least one fixed contact is placed in an opposite side from the yoke relative to the moving contactor, and
the at least one forward electric path piece being positioned between the yoke and the moving contactor in the moving directions of the moving contactor while the moving contactor is in the closed position when the at least one fixed contact is placed in a same side as the yoke relative to the moving contactor.

27.-34. (canceled)
